(19) United States
(12) Patent Application Publication
(10) Pub. No.: US 2024/0005409 A1
(43) Pub. Date: Jan. 4, 2024

(54) SYSTEMS, METHODS, AND STORAGE MEDIA FOR MANAGING DIGITAL LIQUIDITY TOKENS IN A DISTRIBUTED LEDGER PLATFORM

(71) Applicant: Securrency, Inc., Annapolis, MD (US)

(72) Inventor: George Daniel Doney, Riva, MD (US)

(73) Assignee: Securrency, Inc., Annapolis, MD (US)

(21) Appl. No.: 18/369,574

(22) Filed: Sep. 18, 2023

Related U.S. Application Data
(63) Continuation-in-part of application No. 17/869,884, filed on Jul. 21, 2022.
Application No. 17/869,884 is a continuation of application No. 16/861,769, filed on Apr. 29, 2020, now Pat. No. 11,430,066.
Application No. 16/861,769 is a continuation-in-part of application No. 16/851,184, filed on Apr. 17, 2020, now abandoned.
(60) Provisional application No. 62/834,999, filed on Apr. 17, 2019.
(60) Provisional application No. 62/839,969, filed on Apr. 29, 2019.

(51) Int. Cl. G06Q 40/06; G06Q 20/36

(52) U.S. Cl. CPC G06Q 40/06; G06Q 20/367

(57) ABSTRACT

A system and methods for creating and managing distributed ledger non-fungible token data structures that represent the liquidity function for any two distinct representations of assets. The representations may be different assets or a single asset type with different characteristics including ledger, network, jurisdiction, availability, etc. The liquidity function is the mechanism to transform or exchange the asset including the pricing function, fees, and delivery mechanism. The investment performance of the liquidity token can be proportional to the demand for liquidity for the pair of assets.

### CROSS REFERENCES TO RELATED APPLICATIONS

This application is related to and claims priority from the following U.S. patents and patent applications. This application is a continuation-in-part of U.S. application Ser. No. 17/869,884, filed Jul. 21, 2022, which is a continuation of U.S. application Ser. No. 16/861,769, filed Apr. 29, 2020, which claims priority to and the benefit of U.S. Provisional Application No. 62/839,969, filed Apr. 29, 2019, and is a continuation-in-part of U.S. application Ser. No. 16/851,184, filed Apr. 17, 2020, which claims priority to and the benefit of U.S. Provisional Application No. 62/834,999, filed Apr. 17, 2019, each of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO COMPUTER PROGRAM LISTING APPENDIX

The official copy of the Computer Program Listing is submitted concurrently with the specification as a TXT formatted file via EFS-Web, with a file name of “4534025-20230918-Computer-Program-Listing-Appendix.txt”, a creation date of Sep. 18, 2023, and a size of 24 kilobytes. The Computer Program Listing filed via EFS-Web is part of the specification and is incorporated in its entirety by reference herein.

### BACKGROUND OF THE INVENTION

### 1. Field of the Invention

The present invention relates to a system for creating tokenized assets on a distributed ledger, and more specifically to systems, methods, and storage media for configuration of a system thereof.

### 2. Description of the Prior Art

It is generally known in the prior art to provide a system for managing tokenized assets on a distributed ledger.

Prior art patent documents include the following:

US Patent Publication No. 2021/0192501 for Network computing system implementing on-demand liquidity to facilitate direct cross-medium transactions by inventors McNamara et al., filed Feb. 21, 2020, and published Jun. 4, 2021, is directed to a computing system that can provide on-demand liquidity for cross-medium transactions using direct wallet-to-wallet transfers of digital currency. The system can acquire exchange rate information from multiple sources and generate a guaranteed exchange rate and trade instructions to the originating and recipient clients to execute the transaction.

US Patent Publication No. 2021/0042735 for System and method for controlling an application programming interface endpoint for transferring funds by inventor Majidi et al., filed Aug. 6, 2019 and published Feb. 11, 2021, is directed to a system and method for controlling anomalous access to tables. A call including a source token and a destination token is received from a caller. A first type of token and a first type of wallet corresponding to the source token are identified. A second type of token and a second type of wallet corresponding to the destination token are further identified. A transaction is determined based on the first type of token, the first type of wallet, the second type of token, and the second type of wallet. A response quote is sent to the caller. The response quote includes details about the transaction and a request for confirmation.

US Patent Publication No. 2022/0270080 for Authenticating physical items in a tokenization workflow by inventor Yantis et al., filed May 13, 2022, and published Aug. 25, 2022, is directed to methods for authenticating items in part of a tokenization workflow. In embodiments, the method includes receiving a photograph of, and information relating to, an item, and generating a virtual representation of the item. The item may be authenticated by making an authentication request via a portal to subject-matter authentication experts, wherein the portal displays the virtual representation of the item in the portal. An authentication report may be received from the experts, and a non-fungible digital token having a unique token identifier may be generated. The non-fungible token may be cryptographically linked to the virtual representation of the item on a cryptographic ledger and ownership data of the non-fungible token is updated to associate an account of an owner of the item with the digital token on the cryptographic ledger.

U.S. Pat. No. 11,551,191 for Network computing system executing programmatic adapters to implement asynchronous communications by inventors McNamara et al., filed Jan. 25, 2021, and issued Jan. 10, 2023, is directed to a computing system that can establish asynchronous network communications with exchanges to facilitate cross-medium transactions between originating and recipient clients. Such communications can result in filtering out errant responses that would otherwise cause an open transaction to fail.

U.S. Pat. No. 11,488,161 for Systems and methods for providing transaction provenance of off-chain transactions using distributed ledger transactions with secured representations of distributed ledger addresses of transacting parties by inventors Soundararaj an at al., filed Jul. 31, 2018, and issued Nov. 1, 2022, is directed to proving and creating on a distributed ledger a verifiable transaction record of a transaction between a user associated with user device and an agent associated with agent system, where the identities of the user and agent are hidden.

U.S. Pat. No. 11,488,147 for the Computationally efficient transfer processing and auditing apparatuses, methods and systems by inventors Sheng at al., filed Apr. 12, 2017, and issued Nov. 1, 2022, is directed to the Computationally Efficient Transfer Processing, Auditing, and Search Apparatuses, Methods and Systems (“SOCOACT”) which transforms smart contract request, crypto currency deposit request, crypto collateral deposit request, crypto currency transfer request, crypto collateral transfer request inputs via SOCOACT components into transaction confirmation outputs. Also, SOCOACT transforms transaction record inputs via SOCOACT components into matrix and list tuple outputs for computationally efficient auditing. A blockchain transaction data auditing apparatus comprises a blockchain recordation component, a matrix Conversion component, and a bloom filter component. The blockchain recordation component receives a plurality of transaction records for each of a plurality of transactions, each transaction record comprising a source address, a destination address, a transaction amount and a timestamp of a transaction; the source address comprising a source wallet address corresponding to a source digital wallet, and the destination address comprising a destination wallet address corresponding to a destination virtual currency wallet; verifies that the transaction amount is available in the source virtual currency wallet; and when the transaction amount is available, cryptographically records the transaction in a blockchain comprising a plurality of hashes of transaction records. The Bloom Filter component receives the source address and the destination address, hashes the source address using a Bloom Filter to generate a source wallet address, and hashes the destination address using the Bloom Filter to generate a destination wallet address. The Matrix Conversion component adds the source wallet address as a first row and a column entry to a stored distance matrix representing the plurality of transactions, adds the destination wallet address as a second row and column entry to the stored distance matrix representing the plurality of transactions, adds the transaction amount and the timestamp as an entry to the row corresponding to the source wallet address and the column corresponding to the destination wallet address; and generate a list representation of the matrix, where each entry in the list comprises a tuple having the source wallet address, the destination wallet address, the transaction amount and the timestamp.

U.S. Pat. No. 11,301,460 for Platform for creating and using actionable non-fungible tokens (KNFT) by inventors Rich at al., filed Jan. 23, 2020, and issued Apr. 12, 2022, is directed to a distributed computing platform and method for creating actionable digital assets and tokens incorporating influence and outreach (“KNFT”). A KNFT application server may be configured to receive, over a distributed computing network from a remote computing node, a request for a new non-fungible token wherein the KNFT comprises a unique KNFT identifier, at least one metadata element, and least one social vector. A blockchain proxy server may be operatively connected to the KNFT application server and to a distributed blockchain ledger. Social actions may comprise user comment, connection, direct message, like, or favorable rating, and a change in ownership of the KNFT may be written to the social vector by a KNFT API. The social vector may comprise social vector data from at least one prior owner, and the KNFT may further comprise a circulation trail vector that incorporates the ownership history of the KNFT.

U.S. Pat. No. 11,194,837 for Blockchain implementing cross-chain transactions by inventors Huang Tam Vo et al., filed May 1, 2018, and issued Dec. 7, 2021, is directed to an example operation may include one or more of receiving a request to execute a cross-chain transaction, identifying disparate locations of two or more different blockchains that have stored therein data for the cross-chain transaction, retrieving data from data blocks of the two or more different blockchains, respectively, based on the identified disparate locations, executing the cross-chain transaction which takes the retrieved data from the two or more different blockchains as inputs to generate a cross-chain result, and storing the cross-chain result via a data block of a distributed ledger.

U.S. Pat. No. 10,198,696 for Using a tree structure to segment and distribute records across one or more decentralized, acylic graphs of cryptographic hash pointers by inventors Struttman at al., filed Mar. 10, 2018, and issued Jan. 29, 2019, is directed to a process including: receiving with one or more processors, a first request to store a record from a computing entity; encoding, with one or more processors, the record in a first plurality of segments; arranging, with one or more processors, the first plurality of segments in respective content nodes of a first content graph, wherein at least some content nodes of the first content graph have two or more content edges of the first content graph pointing to two or more respective other content nodes of the first content graph; and storing, with one or more processors, the content nodes of the first content graph in a verification graph.

### SUMMARY OF THE INVENTION

The present invention relates to systems and methods for creating and managing tokenized assets, including tokenized asset pairs contained within a liquidity token wherein conversion of one tokenized asset of the pair into the other tokenized asset of the pair generates liquidity and revenue to a wallet associated with the liquidity token. The present invention is additionally directed to a system and method for cross-ledger transmutation of tokens.

It is an object of this invention to provide a system and method for creating and managing tokenized assets and asset pairs.

In one embodiment, the present invention includes a method for creation and management of tokenized asset pairs providing tokenized liquidity, comprising a computer platform including a processor and a memory associating a first asset token and a second asset token with an asset wallet address, wherein an asset wallet associated with the asset wallet address contains the first asset token and the second asset token, the computer platform issuing a liquidity token on a distributed ledger, wherein the liquidity token includes a unique token identifier and the asset wallet address for the asset wallet containing the first asset token and the second asset token, the computer platform wrapping the liquidity token with a token wrapper to create a wrapped liquidity token, wherein the wrapped liquidity token enables fractionalization of the liquidity token into at least two shares, the computer platform executing a pricing function, wherein the pricing function is a set of smart contracts configured to translate the value of the first asset token in terms of the value of the second asset token.

In another embodiment, the present invention includes a system for creation and management of tokenized asset pairs providing tokenized liquidity, comprising a computer platform including a processor and a memory, wherein the computer platform is implemented on a first distributed ledger, wherein the computer platform includes a first set of smart contracts configured to manage tokenized assets stored on the first distributed ledger, wherein the first set of smart contracts is configured to traverse one or more node graphs to determine a viable route between the first node of the first distributed ledger and a second node of a second distributed ledger, wherein the computer platform is configured to generate a liquidity token containing a unique token identifier and a wallet containing a first asset token associated with a first asset, and a second asset token associated with a second asset, wherein the liquidity token includes a liquidity function, wherein the liquidity function translates the value of the first asset in terms of the second asset, wherein the computer platform receives an input to transfer the liquidity token from a source wallet on the first distributed ledger to a destination wallet on the second distributed ledger, wherein the computer platform includes a second set of smart contracts configured to plan a route between a first node of the first distributed ledger and the second node of the second distributed ledger, wherein the execution of the second set of smart contracts creates a bridge between the first distributed ledger and the second distributed ledger, wherein the computer platform is configured to transfer the liquidity token from the source wallet of the first distributed ledger to the destination wallet of the second distributed ledger via the bridge.

In yet another embodiment, the present invention includes a method of managing tokenized asset pairs providing tokenized liquidity, the method comprising a computer platform including a processor and a memory associating a first asset token and a second asset token with an asset wallet address, wherein the asset wallet address contains the first asset token and the second asset token, the computer platform issuing a liquidity token on a distributed ledger, wherein the liquidity token includes a unique token identifier and the asset wallet address containing the first asset token and the second asset token, the computer platform associating the liquidity token with a first wallet address on the distributed ledger, the computer platform deploying an elastic securitization algorithm including a set of smart contracts configured to execute a fund management strategy associated with the liquidity token, wherein the elastic securitization algorithm includes a set of smart contracts configured to exchange capital generated by a liquidity function of the liquidity token to convert miscellaneous assets in an asset pool into a first asset type associated with the first asset token and/or a second asset type associated with the second asset token and issue additional asset tokens, and the liquidity function executing a set of smart contracts configured to translate the value of the first asset type in terms of the second asset type and transfer the first asset token and/or the second asset token to a second wallet.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of a computer architecture for creating, configuring, and managing tokenized assets.

FIG. 2 is an illustration of a data record of an asset token.

FIG. 3 illustrates a process flow of asset token sales and purchases.

FIG. 4 illustrates a process flow of asset ownership transfer functions.

FIG. 5 illustrates a process flow, and related data structures, for asset valuation functions.

FIG. 6 is an illustration of a data record of a fund asset token.

FIG. 7 is a schematic illustration of a wallet containing a fungible share of an asset token.

FIG. 8 is a schematic diagram of a data model for nesting of assets to support fractional ownership.

FIG. 9 a schematic diagram of a fund management environment displaying the implementation of a fund strategy.

FIG. 10 is a process flow diagram of a method for configuring a computing platform to process a fund structure.

FIG. 11 is a process flow diagram of a method for providing communication between dissimilar networks.

FIG. 12 is a schematic illustration of a computer architecture for providing communications between dissimilar networks.

FIG. 13A is a schematic illustration of a node graph.

FIG. 13B is a schematic illustration of bridge metadata.

FIG. 14 is schematic diagram of a chain of sub-transactions for accomplishing a cross-ledger mutation.

FIG. 15 is a schematic diagram of a simple cross-ledger value transfer.

FIG. 16 is a schematic diagram of a chained transaction including multiple sub-transactions.

FIG. 17A is a schematic diagram of a transaction chain building process.

FIG. 17B is a schematic diagram of a transaction chain building process.

FIG. 17C is a schematic diagram of a transaction chain building process.

FIG. 18 is a schematic diagram of the execution of multiple transaction chains.

FIG. 19A illustrates a first half of a state diagram for chained transfers.

FIG. 19B illustrates a second half of a state diagram for chained transfers.

FIG. 20 is a schematic diagram of a hypothecation transfer and associated bridge operations.

FIG. 21 is a schematic diagram of a settlement transfer and associated bridge operations.

FIG. 22 is a schematic diagram of an asset exchange from a first asset type to a second asset type.

FIG. 23 is a schematic diagram of the basic elements of a system supporting liquidity between a pair of assets .

FIG. 24 illustrates a pricing function of a pricing engine.

FIG. 25 is a schematic diagram of a data structure defining an asset token.

FIG. 26 is a schematic diagram of a set of functions for providing liquidity to a wrapped liquidity token.

FIG. 27 is a schematic diagram of a system of the present invention.

### DETAILED DESCRIPTION

The present invention is generally directed to systems and methods for creating and managing tokenized assets, including tokenized asset pairs contained within a liquidity token wherein conversion of one tokenized asset of the pair into the other tokenized asset of the pair generates liquidity and revenue to a wallet associated with the liquidity token. The present invention is additionally directed to a system and method for cross-ledger transmutation of tokens.

In one embodiment, the present invention includes a method for creation and management of tokenized asset pairs providing tokenized liquidity, comprising a computer platform including a processor and a memory associating a first asset token and a second asset token with an asset wallet address, wherein an asset wallet associated with the asset wallet address contains the first asset token and the second asset token, the computer platform issuing a liquidity token on a distributed ledger, wherein the liquidity token includes a unique token identifier and the asset wallet address for the asset wallet containing the first asset token and the second asset token, the computer platform wrapping the liquidity token with a token wrapper to create a wrapped liquidity token, wherein the wrapped liquidity token enables fractionalization of the liquidity token into at least two shares, the computer platform executing a pricing function, wherein the pricing function is a set of smart contracts configured to translate the value of the first asset token in terms of the value of the second asset token.

In another embodiment, the present invention includes a system for creation and management of tokenized asset pairs providing tokenized liquidity, comprising a computer platform including a processor and a memory, wherein the computer platform is implemented on a first distributed ledger, wherein the computer platform includes a first set of smart contracts configured to manage tokenized assets stored on the first distributed ledger, wherein the first set of smart contracts is configured to traverse one or more node graphs to determine a viable route between the first node of the first distributed ledger and a second node of a second distributed ledger, wherein the computer platform is configured to generate a liquidity token containing a unique token identifier and a wallet containing a first asset token associated with a first asset, and a second asset token associated with a second asset, wherein the liquidity token includes a liquidity function, wherein the liquidity function translates the value of the first asset in terms of the second asset, wherein the computer platform receives an input to transfer the liquidity token from a source wallet on the first distributed ledger to a destination wallet on the second distributed ledger, wherein the computer platform includes a second set of smart contracts configured to plan a route between a first node of the first distributed ledger and the second node of the second distributed ledger, wherein the execution of the second set of smart contracts creates a bridge between the first distributed ledger and the second distributed ledger, wherein the computer platform is configured to transfer the liquidity token from the source wallet of the first distributed ledger to the destination wallet of the second distributed ledger via the bridge.

In yet another embodiment, the present invention includes a method of managing tokenized asset pairs providing tokenized liquidity, the method comprising a computer platform including a processor and a memory associating a first asset token and a second asset token with an asset wallet address, wherein the asset wallet address contains the first asset token and the second asset token, the computer platform issuing a liquidity token on a distributed ledger, wherein the liquidity token includes a unique token identifier and the asset wallet address containing the first asset token and the second asset token, the computer platform associating the liquidity token with a first wallet address on the distributed ledger, the computer platform deploying an elastic securitization algorithm including a set of smart contracts configured to execute a fund management strategy associated with the liquidity token, wherein the elastic securitization algorithm includes a set of smart contracts configured to exchange capital generated by a liquidity function of the liquidity token to convert miscellaneous assets in an asset pool into a first asset type associated with the first asset token and/or a second asset type associated with the second asset token and issue additional asset tokens, and the liquidity function executing a set of smart contracts configured to translate the value of the first asset type in terms of the second asset type and transfer the first asset token and/or the second asset token to a second wallet.

None of the prior art discloses tokenizing a pair of assets, and further incorporating both assets in a single wallet, tokenizing the wallet, and wrapping the tokenized wallet to enable fractionalized ownership of asset pairs. Additionally, none of the prior art discloses a smart contract waterfall process allowing for elastic securitization of tokenized assets. Further, none of the prior art discloses a dynamic pricing function that incorporates imbalance between source and destination reserve accounts, current market conditions and activity, external pricing, and asset par value for determining an amount of a first tokenized asset in terms of a second tokenized asset.

In economics “liquidity” refers to the degree to which an asset is operable to be bought, sold, or otherwise converted in the market without affecting the asset's price. Liquidity also describes the efficiency with which the value of one asset is operable to be transferred to another without loss. At its core, liquidity focuses on the likelihood that a market includes both a provider of an asset and a consumer seeking to acquire the asset with a simultaneous desire to transact (i.e., a “dual coincidence of wants”). In the absence of such a dual coincidence, the seller (or buyer) must aggressively adjust price to find a willing party to engage in the desired transaction. The extent to which the price must be adjusted against the price in which an individual engaging in the reverse transaction would pay reflects the efficiency of the market. A market which requires a significant price shift to support the desired transaction is inefficient and is therefore described as having limited liquidity. Markets are said to have efficient liquidity and pricing if for any given transaction the difference in the price for an equivalent purchase or sale of the value is similar. Many markets are not liquid and do not have efficient pricing. Furthermore, entering these markets is expensive and arduous, as investors are required to pay a premium to join.

The present invention provides for enhancement and automation of the management of liquidity within an ecosystem via the use of Distributed Ledger Technology (DLT) and tokenization. Distributed Ledger Technology (DLT), such as blockchain, has been implemented to transfer value across decentralized computer networks, with fungible and non-fungible assets represented by, and encapsulated in, digital tokens. Transactions are recorded to the ledger based on confirmation accomplished through a consensus mechanism. DLT has the potential to increase market efficiencies. However, adapting many market activities to a decentralized network without central trusted intermediaries has raised many technical obstacles. For example, without a centralized market maker, liquidity may be lost.

The present invention includes digital “liquidity tokens” that define connections between composable asset classes and capital markets. The term “liquidity token” as used herein refers to a non-fungible token that holds two or more tokens as inventory and supports the conversion of one asset represented by one token to another asset represented by the other token. Further, the present invention includes a novel technology platform to create efficient networked trading systems by efficiently maximizing liquidity. The resulting system smooths the mismatch in markets of buy and sell participation, by ensuring that: 1) there is always a market price; 2) a buy or sell move into or out of a market is always possible, however small; 3) price moves reflect the demand for liquidity itself; 4) moves into and out of a market incur minimum friction; 5) attempts to manipulate a market result in a loss of value; 6) information mismatches result in minimum value leakage from the system; and, 7) liquidity providers have an opportunity to benefit from the demand for liquidity in a market.

Holders of liquidity tokens receive value (e.g., dividends, equity growth) based on the demand for liquidity in a particular market. The tokens, themselves, represent an ownership stake in a market-making function between value pairs. The greater the demand for liquidity, the larger the revenue. An increase in revenue, in turn attracts more capital to the token. An internal balancing function maintains equilibrium between asset flow and market demand. Through an ecosystem of liquidity tokens (each representing the demand for liquidity of a specific pair), capital will flow to balance the demand for liquidity among all asset classes in the ecosystem.

Implementations provide a technology platform that leverages composable tokenized assets to deliver and manage market liquidity. By isolating liquidity functions at their core, the invention establishes a foundational infrastructure for liquidity services that are applicable across financial services.

Referring now to the drawings in general, the illustrations are for the purpose of describing one or more preferred embodiments of the invention and are not intended to limit the invention thereto.

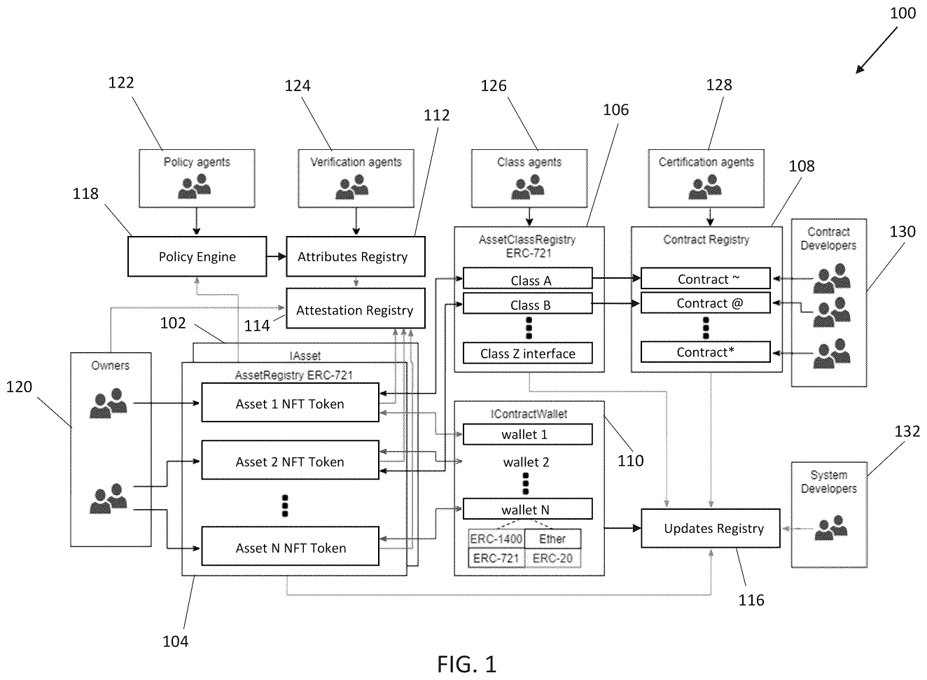

FIG. 1 is a schematic illustration of a computer architecture 100 for tokenizing and managing assets according to one embodiment of the present invention. The architecture 100 includes one or more computing platforms that are configured to communicate with one or more remote computing platforms according to a client/server architecture, peer-to-peer architecture and/or other architectures. The platforms are operable to be configured by machine-readable instructions which include one or more instruction modules. In one embodiment, the instruction modules include computer program modules stored in non-transient memory.

An investment fund, such as an ETF, is used herein as an example of an asset that is operable to be managed by the present invention. However, one of ordinary skill in the art will appreciate that the present invention is not limited to use with investments funds, as the architecture, platforms, modules, and transactions are applicable to a range of assets. To create and launch an ETF fund according to one embodiment of the present invention, issuers follow a multistep process including: (1) tokenizing the fund assets using the predefined specification of IAsset module 102 (i.e., “IAssetToken” specification); (2) tokenizing the fund itself using the predefined specification of IAsset module 102 (i.e., “IAssetFund” specification); (3) attach tokenized assets to the fund using an AddAssetRequest function; and, optionally, (4) attach a non-fungible token to a fungible token using an interface of the IAsset module 102 (i.e., IAssetManagementFungible interface) to support fractional ownership and simplified transactions. The term “IAsset tokens” and “tokens” as used herein refers to the tokens created according to the multistep process of the present invention. All of these specifications, interfaces, process steps and data structures facilitate fund management in decentralized systems and are described in detail herein. Examples of source code implementing the various functions and interfaces of the present invention are included in the Computer Program Listing Appendix, which is incorporated by reference in its entirety.

Any physical or digital asset of value is operable to be tokenized according to the present invention, including but not limited to equities (including common stock, preferred stock, contributed surplus, additional paid-in capital, and treasury stock), bonds (including but not limited to treasury bonds, government-sponsored enterprise (GSE) bonds, investment-grade bonds, high-yield bonds, foreign bonds, mortgage-backed bonds and municipal bonds), real estate, precious metals, motor vehicles, antiques, intellectual property assets, tokens (including tokens issued using the system of the present invention and tokens generated by other systems), and copyright to original works of authorship including literary works, musical works, dramatic works, pantomimes, choreographic works, pictorial works, graphic works, sculptural works, sound recordings, computer programs, and architectural works. The term “tokenize” as used herein refers to the issuance of a unique record on a distributed ledger reflecting the asset's ownership, coupled with supporting essential asset management functions needed to support scalable operations, such as fund operations. The IAsset interface module 102, supports specific functions that enable an asset to present consistent data and valuation information, participate in funds and other asset management structures, implement asset specific logic, and/or encapsulate other tokens representing value instruments that are not created with native asset management capabilities.

Once assets have been tokenized using an IAssetToken interface of IAsset module 102 the next step in developing a fund (e.g., an ETF self-reporting fund) is the issuance of a fund token using the IAssetFund interface structure of IAsset module 102. This structure extends the IAssetToken structure and functions with the IAssetManagement interfaces. Fund tokens are issued via the IAssetRegistry interface of Asset Class registry module 106 (as with other tokens) but are assigned a type parameter equal to “Fund” by assigning the value for this class from the Asset class Registry module 106. One of ordinary skill in the art will appreciate that a fund is an asset that is operable to contain other assets. The same functions available for an individual asset apply to a fund. However, the basic logic of an IAsset token is extended for a token of a fund in order to provide the functions needed to manage the assets contained within the fund.

Asset registry module 104 includes a smart contract, AssetRegistry, that issues and tracks tokens representing assets. These tokens implement interfaces to manage relationships between assets and expose basic asset functions, such as valuation functions. Assets are assigned a class that is tracked in AssetClassRegistry module 106. The term “class” as used herein, is well known in the field of object oriented programming and refers to a “blueprint” for creating objects, providing initial values for state, and implementations of behavior. An asset class definition contains the methods and variables specific to the type of asset, including member variables or attributes and member functions or methods. An asset class assignment (i.e., associating an asset with an asset class definition) advantageously enables the token to expose, display, and/or execute the properties and functions specific to that class.

ContractRegistry module 108 enables Contract Developers 130 to publish new interfaces and implementations to enhance or extend the behavior of all assets in a class (e.g., upgrade the interface). The IContractWallet module 110 implements and manages smart contract-based cryptographic wallets that are attached to individual token representing assets, classes, or other elements providing wallet functionality via that asset. Attributes Registry module 112 stores an attribute or attributes of the token. The Attestation Registry module 114 stores the attributes of a token which execute behavioral functions which have been verified by a verification agent for the purposes of regulatory policy enforcement. Details on the Attestation Registry and Attribute Registry are be found in U.S. patent application Ser. No. 17/677,605 incorporated herein by reference in its entirety. The Updates Registry module 116 provides an interface for updating wallet and smart contracts and/or implementing new smart contracts for wallets and/or tokens. The Policy Engine module 118 verifies regulatory compliance and controls the flow of data through the architecture.

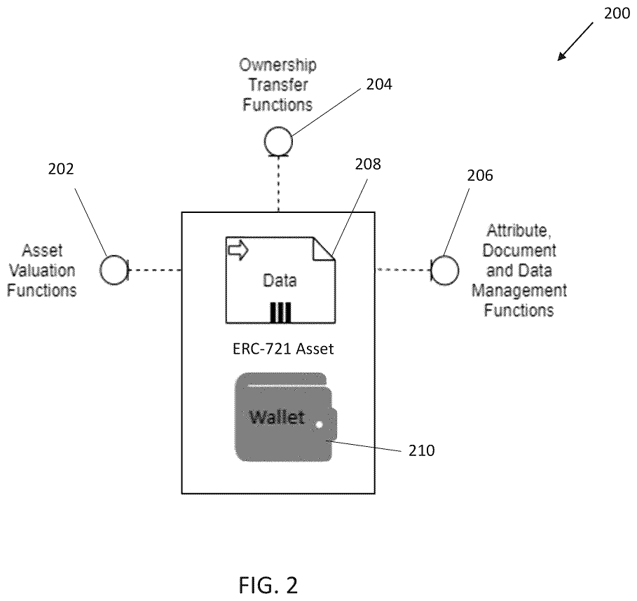

On issuance of a token, an AssetRegistry smart contract of Asset Registry module 104 assigns an asset class to the token and deploys a new smart contract implementing the IContractWallet interface to thereby associate a wallet with the token. As a result, each created token will have a unique wallet address (as shown in FIG. 2) linked to the token by its identifier and implements properties and functions of an assigned asset class. The Asset Registry module 104 operates the IWalletContract interface and enforces policy for actions regarding the wallet. In one embodiment, the policy will only allow the owner of the token to execute actions via the wallet contract. In one embodiment, the wallet supports functionality for transfer or receipt of tokens. In one embodiment, the wallet supports functionality for transfer or receipt of cryptocurrency such as Ether (ETH). In one embodiment, the wallets of the present invention support tokens compatible with ERC-20, ERC-721, ERC-1400, and other standard interface tokens.

In one embodiment, Asset Registry 104 implements an Ethereum Request for Comment standard interface to enable the issuance of non-fungible tokens. (See, e.g., https://eips.ethereum.org/erc, accessed Apr. 6, 2023, which is incorporated by reference in its entirety). In one embodiment, Asset Registry 104 implements an ERC-721 interface (See, e.g., https://eips.ethereum.org/EIPS/eip-721, accessed Apr. 6, 2023, which is incorporated by reference in its entirety), ERC-20 interface, an ERC-777 interface, an ERC-1155 interface, an ERC-223 interface, an ERC-827 interface, an ERC-1337 interface, or an ERC-4626 interface. In one embodiment, the Asset Registry 104 implements a standard protocol for issuing tokens according to the distributed ledger which implements the computer architecture of the present invention. Additionally, Asset Registry 104 implements the novel interfaces described herein that facilitate functions for asset management in decentralized environments such as distributed ledgers.

The smart contracts implemented by IContractWallet module 110 operate wallets and support upgradability via the UpdatesRegistry module 116. In one embodiment, all system components are operable to be upgraded via the UpdatesRegistry module 116. This structure allows registration of new wallet smart contracts implementing changed or upgraded behavior. In one embodiment, the token owner or other designee chooses to assign a new wallet contract to the token to implement the upgraded functions. In one embodiment, the token owner or other designee rejects the assignment of a new wallet contract to the token to implement the upgraded functions. ContractRegistry module 108 stores smart contract interfaces that provide customized functions for an AssetClass, which is stored in the AssetClass registry module 106, or Asset instance, which is stored in the Asset Registry module 104. In one embodiment, each token is assigned a class which provides access to the attributes, functions and implementation logic of the class. In one embodiment, developers submit new Smart Contracts with custom implementations to ContractRegistry module 108 for owners to select in order to expose the custom logic for their asset. In one embodiment, the Asset or Asset Class owner or designee selects an implementation from the interface registry which is then implemented to the selected token.

In one embodiment, a smart contract is deployed on a distributed ledger that implements Asset Registry module 104 to enable issuance of non-fungible tokens representing individual assets. One of ordinary skill in the art will understand the process and technique of deploying a smart contract on a computer architecture as described herein.

Token Owner modules 120 are associated with systems of parties who exercise control over assets (represented by, for example, non-fungible tokens) in Asset Registry 104. In one embodiment, the Token Owner module 120 exercises direct control over the platform via the wallet and or wallets. In one embodiment, the Token Owner module 120 exercises indirect control over the platform via the wallet and or wallets through rights allocated via fungible or non-fungible tokens that have control authority over the asset.

Policy Agent modules 122 are associated with systems of parties with the authority to publish policy that govern token behavior. In one embodiment, the Token Owner designates a published policy to govern specific actions performed on or through the token. In one embodiment, the process of policy enforcement is that of U.S. application Ser. No. 17/083,622, filed Oct. 29, 2020 and incorporated herein by reference in its entirety. Verification Agent modules 124 are associated with systems of parties that create attributes. The term “attributes” as used herein refers to characteristics or properties of objects in the system. Verification Agents have the ability to attest to attribute values associated with objects. For example, a legal firm may serve as the Verification Agent that a fund asset is a 1940 Act fund for the purposes of regulatory policy enforcement. Class Agent modules 126 are associated with systems of parties who exercise control over Asset Class tokens. Using this control, the Class Agents selects attributes and interfaces that apply to all asset tokens that are associated with the class. Certification Agent modules 128 are associated with systems of parties responsible for certification that the smart contract codes published by contract developers via the Contract Developer modules 130 are secure, operable (i.e., free from defects), and perform the function as described. Contract Developer modules 130 are associated with systems of parties that develop smart contract code used by asset tokens to perform functions associated with the asset class. These functions are operable to be added, upgraded, or removed by a Class Agent upon certification of the function by a Certification Agent. System Developer modules 132 are associated with systems of parties authorized to publish updates to core elements of the system (e.g., the Asset Registry module 104 or Contract Wallet module 110).

In one embodiment, the modules disclosed herein are implemented within a single processing unit. In one embodiment, the modules disclosed herein are implemented within multiple processing units. In one embodiment, one or more of the modules disclosed herein are implemented remotely from the other modules. In one embodiment, the modules disclosed herein require certification to access the module (e.g., a certification code, a token containing a certification code, etc). The description of the functionality provided by the different modules herein is for illustrative purposes, and is not intended to be limiting, as any of modules may provide more or less functionality than is described. In one embodiment, the modules disclosed herein provide decreased functionality than is described. In one embodiment, the modules disclosed herein are condensed into less than the number of modules described. In one embodiment, one or more modules are eliminated. Some or all of the functionality of eliminated models is operable to be provided by other modules.

FIG. 2 is a schematic illustration of a data record of a token 200 and the functions for asset management implemented by the Asset Registry 104 (depicted in FIG. 1) according to one embodiment of the present invention. The functions include asset valuation functions 202, ownership transfer functions 204 and data management functions 206. These interfaces and associated data structures described in detail herein permit the creation of composite tokens. The term “composite tokens” as used herein refers to tokens that contain or are linked to other tokens in an operably recursive structure. These novel composite structures permits tokenization of a fund (i.e., a composite asset that contains other assets) over a decentralized computer architecture.

Consistent with the ERC-721 token specification, Asset Registry module 104 facilitates the issuance of non-fungible tokens, with each token representing a unique asset. For each issued token, data 208 is recorded in the Asset Registry module. The data 208 includes but is not limited to the unique identifier for the asset token; the asset class from Asset Class Registry module 106; the asset name and description; the address of the token's wallet 210; and other data as desired for the asset. The token data record 200 stored by Asset Registry module 104 defines the non-fungible token. The term “token data record” as used herein refers to the token and related data structures. In one embodiment, the token is assigned additional attributes and values using the methods disclosed in U.S. published patent application Ser. No. 16/143,058, which is incorporated herein by reference in its entirety. In one embodiment, the digital tokens implement the IAsset interface of IAsset interface module 102, exposing a set of functions, such as functions 202, 204, and 206, that facilitate asset management over a decentralized computing platform.

A token 200 is associated with a cryptographic wallet 210. In one embodiment, the present invention implements an interface specification and data structure enabling a smart contract and/or a discrete token to own and/or otherwise be associated with a cryptographic wallet. This structure advantageously enables a token to own other tokens, add or remove other tokens from its ownership, and to conduct transactions with other entities by interacting with wallets 211 corresponding to other tokens or entities. In one embodiment, a composite token is a token that owns a corresponding wallet containing other tokens, thereby representing a token-in-token structure.

Non-fungible tokens in the Asset Registry are assigned a wallet 210 (FIG. 2) on issuance by the asset registry 104 by implementing the IAssetRegistry IssueAsset function using an IAssetWalletFactory interface, an exemplary sample of code for which is detailed in the Computer Program Listing Appendix. This interface issues a smart contract implementing an IContractWallet interface which is stored in Contract Registry 108 in association with the unique token ID. An example of code implementing this interface can be found in the Computer Program Listing Appendix.

In one embodiment, the interfaces of the wallet contract are executed using the IAssetWallet wrapper. In one embodiment, the IAssetWallet wrapper is a set of functions conforming to the IAssetWallet interface specification published in the Computer Program Listing Appendix that are available via the AssetRegistry smart contract for use by the owner of the IAsset token or other permission structures as implemented in the smart contract logic. In one embodiment, the permission structures require the authorization and signature of the owner of the asset token prior to execution of the designated function (e.g., a smart contract selected via the Asset Registry 104). In one embodiment, if the party attempting to execute the designated function is not authorized to execute the function, the proposed operation (e.g., “send tokens”) will not be permitted and thus will not occur. In one embodiment, the IAssetWallet exposes its wallet address via the GetWallet function of the attached code. This address is used as an origin or destination for transactions in the same way as any wallet on the distributed ledger.

Linking a wallet to a token in this structure enables useful effects such as: full traceability of the actions performed on behalf of the asset corresponding to the token, the ability to automate actions through an asset management smart contract that trades based on a strategy, the ability to conduct transactions with an asset's wallet as if transacting with an entity, the ability to insert robust policies (e.g., compliance policies) into asset operations including operations via the asset wallet.

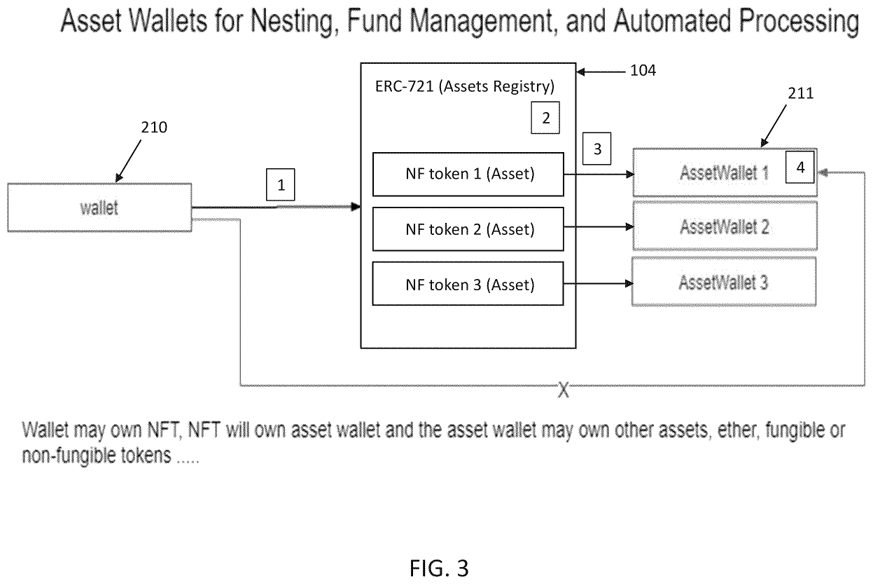

FIG. 3 is a schematic illustration of the asset token sale and purchase process according to one embodiment of the present invention. A token is associated with a cryptographic wallet 210. In one embodiment, the present invention implements an interface specification and data structure enabling a smart contract and/or a discrete token to own and/or otherwise be associated with a cryptographic wallet. This structure advantageously enables a token to own other tokens, add or remove other tokens from its ownership, and to conduct transactions with other entities by interacting with wallets 211 corresponding to other tokens or entities. The “token-in-token” structure, in which wallets corresponding to tokens own other tokens, enables the creation of tokenized composite assets. One example of a composite asset is a fund (i.e., a financial asset that contains other assets). When issued as an IAsset token supporting the IAssetManagement interfaces, the token supports asset management transactions enabling the execution of a fund management strategy. In one embodiment, the fund management strategy is a series of smart contracts. In one embodiment, the fund management strategy is executed automatically via a smart contract based algorithm on a distributed ledger. In one embodiment, the fund management strategy is executed manually by a fund manager implementing a smart contract on a distributed ledger. Using this model, composite assets are operable to be tokenized and thus contain, add, or remove assets like cryptocurrencies, other asset tokens (simple or composite), or tokenized shares of assets.

In one embodiment, the token-in-token structure is used to “wrap” third party tokens that do not support asset management with the IAsset token interface, to be managed in fund structures as individual assets. The term “wrapping” refers to issuing a unique token identifier for a third party token to create an IAsset token for use via the system of the present invention. In one embodiment, wrapping a third party token is accomplished through a simple transfer to the IAsset token's wallet. This advantageously allows any token or smart contract to be wrapped and processed as an asset exposing a consistent structure for automated asset management and fund operation according to the present invention. With these technical elements in place, it is possible to quickly launch complex, self-processing funds. For example, in an ETF structure, one or more non-fungible tokens representing individual assets are issued via the Asset Registry module 104 using the IAssetRegistry.IssueAsset function (see example code in the Computer Program Listing Appendix). Each token implements the IAsset interface which extends the basic ERC-721 specification with ownership transfer functions implemented via the IAssetTransferable interfaces to support asset management, enhance transparency, and support purchase and sale of the asset in a marketplace.

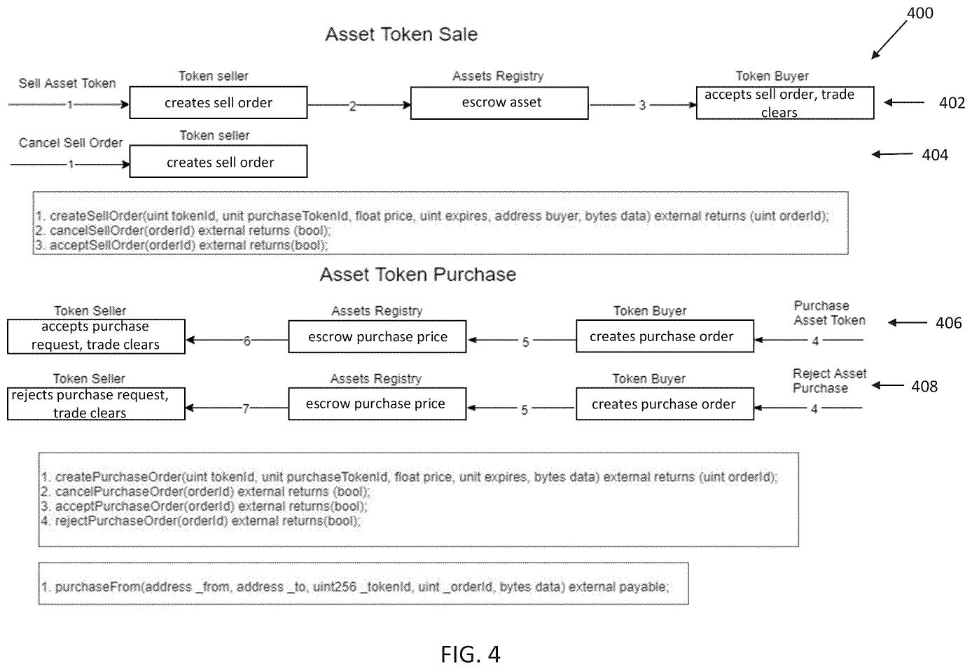

FIG. 4 is a schematic illustration of the process flows 400 of asset ownerships transfer functions according to one embodiment of the present invention. As noted above, tokens are operable to implement a protocol standard interface (e.g., ERC-721) for the distributed ledger which implements the system of the present invention. In one embodiment, the protocol standard interface includes conventional ownership and transfer functions defined in the specification of the interface. In one embodiment, the tokens implement the compliance aware framework disclosed in U.S. patent application Ser. No. 16/143,058, which is incorporated herein by reference in its entirety. The present invention advantageously extends this framework with functions to enable systematic asset purchase, sale and linking.

As shown at 402 in FIG. 4, a sell order for a token is created with the createSellOrder function that operates on a data structure. In one embodiment, createSellOrder function includes parameters for uint tokenid. unit purchase Tokenid, float price, uint expires, address buyer, and/or bytes data and returns an external return of a uint orderid, otherwise referred to as an order id herein. A cancelSellOrder function operates on the order id and returns a Boolean. In one embodiment, the token buyer accepts the sell order and the cancelSellOrder function returns FALSE. In one embodiment, if the cancelSellOrder function returns FALSE, an acceptSellOrder function is executed. As shown at 404, if the sell order has been cancelled, the cancelSellOrder function returns TRUE and the order process is terminated without a sale.

For a token purchase, as shown at 406, a createPurchaseOrder function is executed on a data structure. In one embodiment, the createPurchaseOrder function includes parameters for uint tokenid, unit purchaseTokenid, float price, unit expires, and/or bytes data and returns a uint orderid, otherwise referred to as an order id herein. A cancelPurchaseOrder function is executed on the parameter of orderid and returns a Boolean. If the return is FALSE, the purchase is accepted and the acceptPurchaseOrder function is executed on the orderid parameter to clear the purchase . Alternatively, as shown at 408, if the return is TRUE, the purchase is rejected and the rej ectPurchaseOrder function is executed on the orderid parameter. In one embodiment, the sell order is executed by making a payment to the Asset Registry wallet including the orderid in the payload by executing the purchaseFrom function on a data structure. In one embodiment, the purchaseFrom function includes the parameters address _irom, address _to, uint256 _tokenld, uint _orderld, and/or bytes data.

As noted above, transactions between tokens are accomplished by virtue of the wallets associated with the respective tokens. In one embodiment, a token's wallet address is obtained via the IAssetWallet.GetWallet interface which is implemented by executing the code in the Computer Program Listing Appendix. In one embodiment, distribution logic is initiated internally by the asset. In one embodiment, distribution logic is initiated externally using the interface.

An important aspect of transparency in financial markets is the ability of investors and prospective investors to view metadata, documents, and supporting data feeds for an asset. This information provides investors the means to develop their own sense for fair market price as well as providing a mechanism to assess the performance of intermediaries, like the asset manager, tasked with the responsibility to assess price in the market. The collation of such information according to systems of the prior art is static and based heavily upon theorizing market performance. The present invention includes a comprehensive data structure to advantageously enable pragmatic, real-time reporting of asset due diligence to provide scalable transparency; a function missing from the RMBS portfolios and other complex assets of the prior art.

Transparency requires the ability to create, maintain, and inspect asset properties or attributes. Since asset types vary widely, it follows that asset attributes vary broadly. To support data analysis across a broad range of assets, a consistent framework is required to manage any property of any asset as attested by any authorized party. In one embodiment, the present invention includes the Attribute Management (ERC 1616) specification (https://eips.ethereum.org/EIPS/eip-1616, last accessed Apr. 10, 2023 and incorporated herein by reference in its entirety) as a basic mechanism to manage asset properties. One of ordinary skill in the art will appreciate the structure of the ERC 1616 standard and how the functions therein enable asset management. Further, one of ordinary skill in the art will appreciate that while the Attribute Management (ERC 1616) specification, while considered stagnant, is sufficient to illustrate the functionality of the basic mechanism for managing asset properties. In one embodiment, the present invention extends this specification via the Compliance Aware Token framework disclosed in U.S. patent application Ser. No. 16/143,058, which is incorporated herein by reference in its entirety, to include scalable trust attestations and policy enforcement based on these attributes.

Additionally, asset due diligence often requires document and data management. Distributed ledgers provide an immutable record for supporting documentation and data as well as an accessible framework to access this data. In one embodiment, the present invention includes the Document Management (e.g., ERC 1643) specification (https://github.com/ethereum/EIPs/issues/1643 last accessed Apr. 10, 2023 and incorporated herein by reference in its entirety). In one embodiment, the present invention includes a data structure to tokenize supporting datasets via a non-fungible token that describes the schema and other characteristics of supporting data using a non-fungible token. This specification supports advanced data authorization techniques, including the use of authorization tokens to provide distribution control and auditing of sensitive data. In one embodiment, policy-based data access and management are achieved using techniques taught in the decentralized access control of U.S. patent application Ser. No. 16/143,058, which is incorporated herein by reference in its entirety.

One of ordinary skill in the art will appreciate that liquidity tokens are yield producing assets. Participants who deposit assets into the liquidity token receive passive income from the deposit as one asset type is converted to another. This makes the liquidity tokens of the present invention “securities” as defined by the Howey test created by the Supreme Court of the United States (SCOTUS) for determining whether certain transactions qualify as investment contracts. Parties who issue these liquidity tokens and derive benefit from them are required to make documents and other data available to participants to meet securities disclosure requirements. The document management specification (e.g., ERC 1643) provides a convenient, decentralized model to make these documents available via the token. In one embodiment, additional parameters that govern the behavior of the liquidity token (e.g., pricing information, yield parameters) are posted by an authorized party to control operations of the token and to provide transparency to participants on the behaviors of the asset.

In traditional asset management, the assessment and publication of asset value for a managed asset was the fiduciary responsibility of an asset manager. This provides investors with a record of the value of an asset based on the information available to the manager. The information available to the manager, while more relevant, timely, and covering a wider range of considerations, still requires careful consideration, calculating, and strategizing in order to manage the asset and any associated fund before publishing the value of the asset. This process is time consuming and results in valuations that are not reflective of the true value of the asset. The present invention advantageously enables the real time calculation of valuation and publication thereof to avoid the dangers of inconsistent value and valuations, as described herein with regard to the GFC of 2008. This is accomplished in part by the process flow for asset valuation functions described herein. These functions provide a consistent mechanism for publication of asset valuations and access to the published valuations. A common interface for valuation is provided to simplify the integration of analysis tools and facilitate valuation of dissimilar assets, thus further facilitating the formation of diversified funds. Asset tokens expose valuation interfaces to enable investors to see current assessments of the asset's value. A range of known accounting techniques are used to assess asset value. In one embodiment, the technique used will be specified in the valueType attribute field for the asset. In one embodiment, asset tokens have internal logic to support the value assessments. In one embodiment, the Asset Valuation function is implemented by executing the code example in the Computer Program Listing Appendix.

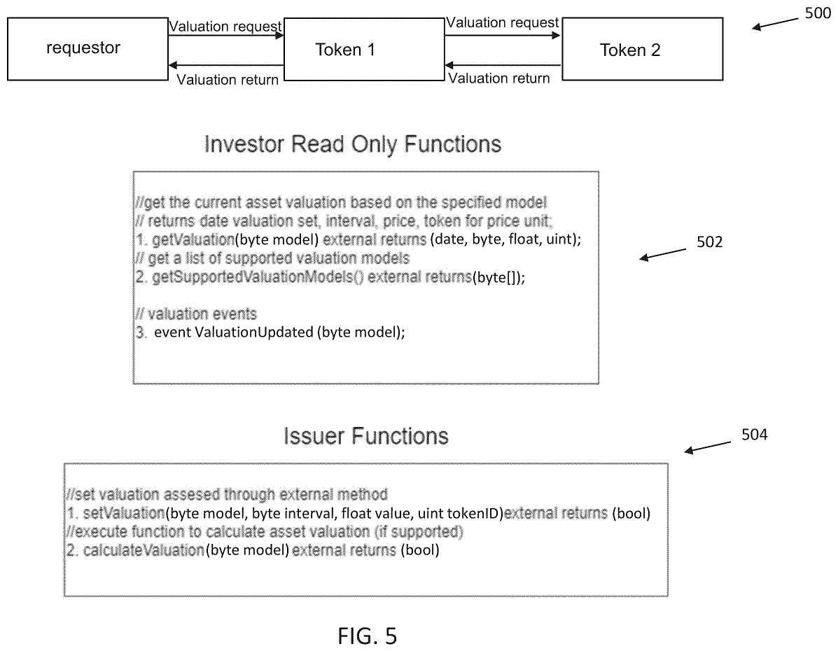

FIG. 5 is a schematic illustration of a process flow 500, and related data structures, for asset valuation functions according to one embodiment of the present invention. As shown in FIG. 5, a requestor makes a getValuation request to a token and that token returns a valuation of the token. In one embodiment, the request includes the valuation model to be applied. In one embodiment, a getSupportedValuationModels request is made to ascertain which valuation models are supported by a token. The logic to request and generate asset valuation varies across implementations and asset classes. The data structures of the requests are shown by data set 502. Significantly, in the case of composite assets, Token 1 is operable to own child tokens and/or serve as a “wrapper” for Token 2 as described herein. In such a case, Token 1 will have to query Token 2 in a similar manner for valuation prior to responding to the requestor. As shown at data set 504, when tokens are issued, a valuation is set through token issuer functions.

In one embodiment of the present invention, valuations are operable to be published as attestations (i.e., attribute values assigned with full attribution by a validated party) by the asset owner, manager, or other authorized parties. In one embodiment, the valuation data is generated by one or more smart contract codes in Asset Registry module 104 (FIG. 1). In one embodiment, the valuation data is generated by one or more smart contract codes assigned to the class in Asset Class Registry module106 (FIG. 1). This logic uses real time attributes of the asset to assess value and is operable to connect to third-party entity that enable connection to external resources (i.e., resources not located on the distributed ledger). These third-party entities are referred to herein as “oracles” and are advantageous for reaching external sources of data such as exchange pricing. For example, for an asset token representing a loan, the PAR valuation is the outstanding principal of the loan, an attribute of a loan token that is stored in Attribute Registry module 112 of FIG. 1. As repayments are processed by the loan, the value assigned to this attribute is changed by the loan processing smart contract resulting in a different value for the attribute. In one embodiment, the Attribute Registry module 112 is that of U.S. patent application Ser. No. 16/143,058, incorporated herein by reference in its entirety.

In one implementation, a request (e.g., GetValuation) for the valuation type “PAR” is configured via the AssetRegistry smart contract implementation to point to the “PAR” Value attribute in Attribute Registry module 112 (FIG. 1). This attribute contains the current principal, that is outstanding balance for the loan which is returned in response to the request, known as the “par” of the loan. In some embodiments, valuation results require complex, real-time analysis of data in order to generate a valuation, as in the case of calculating the net asset value (NAV). The loan's NAV calculation is determined based on discounted cash flows and payment behavior of the loan recipient. Specifically, a valuation request for the valuation type “NAV” utilizes the smart contract code assigned to the AttributeClass “Loan” via Contract Registry module 108 (FIG. 1) to calculate the Net Present Value of the loan based on current interest rates, the interest rate of the loan, and the payment history of the borrower based on cash flows that is observed in the Asset Wallet.

As another example, a request for the valuation type “MARKET” value leverages an oracle to obtain data from external sources (i.e., sources not located on the distributed ledger). In one embodiment, the Attribute Registry module 112 includes instructions to obtain the most recent value. In the case of obtaining the market value, the value obtained by the Attribute Registry module 112 is the current exchange price for the asset. One of ordinary skill in the art will appreciate that while these examples are provided for clarity, the present invention is not limited thereto. The means to assign a method to obtain this data, where the method is configured for each asset, provides a novel platform for providing assets that contain within their data structure the means to calculate and publish their valuation (i.e., “self-reporting assets”). The present invention advantageously eliminates the dependency of an auditing or reporting system on specific implementations of the source of valuation data, such as those that are only available to the asset manager. This eliminates complex system integration required to generate valuations for complex assets (e.g., funds) for which valuation depends on a wide range of sources. Thus, the present invention advantageously provides investors with the means to obtain valuation data for their asset in real-time or near real-time, and the accuracy of the valuation is significantly increased in comparison to the valuation conducted by the asset manager of traditional valuation techniques. The resulting increase of transparency prevents the inconsistency between actual asset value and calculated asset value. The effects of such inconsistency are potentially devastating, as was demonstrated in the 2008 Global Financial Crisis.

While disclosed implementations expose a common interface for valuation, as noted above, different techniques are used to calculate the valuation for the range of asset types that will be supported. In one embodiment, unique smart contract logic to calculate valuation for an asset type is referenced via a known proxy technique. For example, many assets support a PAR value, that is, its face value. Most managed assets have a Net Asset Value (NAV) calculated based on the market price, liquidity, discounted cash flows, or other assessed value of its contents. If an asset trades regularly, it will have a market price and value. The PAR, NAV, and market values may be different for the same asset. For example, a loan has a PAR value based on the outstanding principal, a NAV based on the discounted cash flows and probability of default, and a market value if it is readily traded or has recently been purchased. Differences in these values provide insight into changing market perception of asset performance, rating entities, or trust in the asset manager's value assessments.

In one embodiment, the values and differences in the values are determined algorithmically using the process flow for asset valuation functions as disclosed herein. In one embodiment, the algorithm for asset valuation runs in real time, via a smart contract, to determine the price of an asset.

In one embodiment, asset values are assessed once. In one embodiment, asset values are assessed periodically. In one embodiment, asset values are assessed in continuous near-real time. In one embodiment, the frequency of assessment is determined by the selection of a specific smart contract code for valuation assessment. The data format of the valuation provides information to know how stale a value assessment is, and for what interval it is expected to remain valid. In one embodiment, the present system provides a link to a standardized feed of valuation history. In this way, a user is able to view the historical performance of the asset. In one embodiment, a link is provided instead of direct access to the data since the storage, search, and indexing functions needed for historical analysis may be different than the functions of the platform (a distributed ledger in this implementation) where the asset token is stored.

While the disclosed implementations improve data communication and thus close the gap between information available to the manager and the investor, flow of data is controlled by the architecture to create a decision gap by design. In one embodiment, data flow is controlled at policy engine 118 of FIG. 1. The control of data flow is advantageous for several reasons, such as preventing undesirable information from being published, ensuring information is published in accordance with regulatory compliance, and to otherwise protect investment technique. For example, limitations of data flow relating to certain information may be desirable or in the interest of the investor (e.g., an asset manager withholds certain information from general availability to prevent a broker or trader making trades just before a large non-publicized order to gain an economic advantage). In one embodiment, the token owner is operable to decide to make a tradeoff between performance and transparency. The asset manager is then driven to disclose asset value and performance based on market demand balanced against the need for confidentiality.

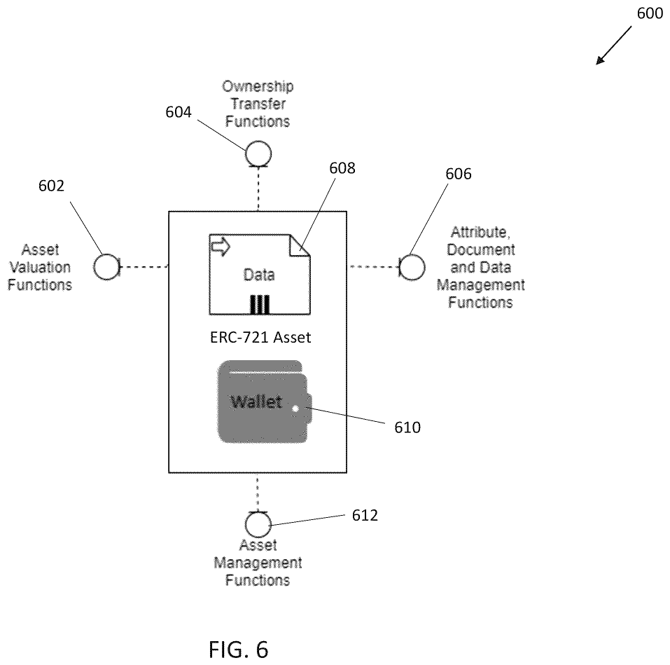

FIG. 6 is a schematic illustration of a data record of a fund asset token 600 according to one embodiment of the present invention. The data record of a fund token is similar to that of a data record of a token that is not a composite token as exemplified by FIG. 2. A token 600 is associated with a cryptographic wallet 210. For each issued token, data 608 is recorded in the Asset Registry module. The data 608 includes but is not limited to the unique identifier for the asset token; the asset class from Asset Class Registry module 106; the asset name and description; the address of the token's wallet 610; and other data as desired for the asset. The functions of fund token 600 include asset valuation functions 602, ownership transfer functions 604, and data management functions 606, and asset management functions 612. Since asset management functions are implemented via the IAssetManagement interface of Asset Registry module 102, assigned processing smart contract, and utilize the tokens wallet, all transactions are operable to be recorded on a distributed ledger and are immutable. This provides transparency to simplify recordkeeping, auditing, and reporting. Asset management interfaces provide a consistent transaction infrastructure streamlining the development of logic specific to each asset class or fund management strategy. This facilitates the deployment of management strategies for new asset types executed via internal logic that is operable to be replaced, extended, or upgraded without changing the core token structure and interface footprint. Further, the asset management interfaces and deployed management strategies support a wide range of asset types via common asset management functions.

More specifically, the fund token specification of fund token 600 extends the basic asset interfaces permitting authorized entities to enumerate all assets in the fund using the IFundManagement.GetAssets interface. Enumerating assets in the fund, each supporting the IAsset interface enables the viewer to drill into available information for contained assets. For example, the following fund management functions and related data structures are supported.
addAssetRequest(uint tokened, uint purchaseTokenid, float price, uint expires, bytes data) external returns (uintorderid);
cancelAddAssetRequest(ordered) external returns (bool);
removeAssetRequest(uint tokened, uint purchaseTokenid, float price, uintexpires, address buyer, bytes date) external returns (uint orderid);
cancelRemoveAsstRequest(ordered) external returns (bool);
getAssets( ) external return (uint[ ]); //returns an array of addresses of attached non-fungible tokens
event AssetAdded(uint tokened);a
event AssetRemoved(uint tokened)

An example of each function is included in the Computer Program Listing Appendix. Once a fund token has been issued, assets are operable to be transferred to the fund. In one embodiment, a fund includes zero assets. The fund is a token corresponding to a wallet, with no asset contained within the token wallet. In one embodiment, the fund includes multiple assets. One of ordinary skill in the art will appreciate that the architecture of the present invention allows for scalability in such a way that there is no theoretical upper limit to the number of assets a fund is operable to include. Assets are purchased or liquidated from the fund using the token's Asset Management Functions, AddAssetRequest & RemoveAssetRequest. As with any token transaction, the asset management actions are recorded on the distributed ledger. These functions are exposed as interfaces by the Asset Registry and utilize the IAsset token wallet and the Asset Ownership Transfer functions to execute asset transactions in a manner similar to that described herein with respect to token 200 of FIG. 2.

In one embodiment, a non-fungible fund token 600 is wrapped with a fungible token, such as token 200, using the IAssetManagementFungible interfaces. The term “wrapped with” as used herein refers to the coupling of a first token to a second token by issuing a second token to correspond to the first token. For example, a token that is not supported by the system of the present invention is operable to be issued a token according to the present invention such that the unsupported token is operable to be represented on the platform of the present invention. This advantageously facilitates trading and other transactions with a range of other distributed ledgers and platforms. Any asset token is operable to be wrapped with a fungible token implementing the IAssetManagementFungible interface to facilitate fractional ownership of the asset and reuse logic for corporate functions built for non-fungible tokens, such as dividend distributions to shareholders, shareholder voting, corporate communications and more. Tokens implementing IAssetManagementFungible structure include new smart contract interfaces (AddAssetRequest, RemoveAssetRequest) that extend the standard implemented by the token (e.g., ERC-20). These interfaces enable the fungible token issuer to add or remove one or more asset tokens to/from the fungible token shell by transferring the non-fungible asset token using the defined functions in the IAssetManagementFungible interface.

The fungible token implementation also includes an interface (IAssetManagementFungible.GetAsset) to permit authorized parties to inspect the asset or assets that underlie the shares represented by the fungible token. The valuation functions exposed by the non-fungible token, which is coupled with the fungible token, permit the shareholder (i.e., the owner of the fungible token) to easily calculate their percentage ownership of the underlying assets. For example, if the NAV for an underlying asset is $1,000,000 and a wallet holds 100 of 1000 total shares (10%) in circulation of the that asset, then the total NAV of the fungible tokens in that wallet representing 100 shares is $100,000.

By separating the fungible token from the logic captured in the non-fungible token specific to the asset and its management, invention facilitates maximum reuse of asset specific code and simplifies the development and verification of asset specific code. Additionally, separating the fungible token from the logic captured in the non-fungible token specific to the asset preserves asset structure to facilitate merger or acquisition approaches where asset acquisition is desired instead of share acquisition for tax, governance, or liability reasons. Asset acquisition is a common technique in finance and, in the absence of the data model and architectures of the disclosed implementation, would not be a pragmatic task. In standard implementations, a single fungible token (e.g., ERC 20) is used to represent both an asset and its ownership rights. To purchase full ownership of an asset (e.g., to take a public company private) according to these standard implementations, the purchaser would have to purchase every share in circulation. If any investor held out with any small number of shares (i.e., tokens representing shares), the transfer of full ownership of the asset would not be possible. With large share distributions of public companies, this type of purchase is not practical.

Using the data model and architectures of the present invention, the fungible ownership rights (i.e., shares) of an asset is separated from the non-fungible asset itself, creating a fungible token and a non-fungible token. These tokens are then linked such that they are associated, but not contained within the same fungible token as in the case of the prior art. In this way, a share acquisition of a company is executable such that a share and the non-fungible asset itself are operable to be acquired at the same time if they are linked. Additionally, an asset sale is easily executable via the present invention by delinking the non-fungible token representing the asset from the fungible tokens representing the shares of the asset. The non-fungible asset is then transferred to the wallet of the buyer, and the proceeds of the sale are distributed to the wallets of the fungible tokens representing share ownership. One of ordinary skill in the art will appreciate that the separation of fungible shares from nonfungible assets by a non-fungible token including one or more fungible tokens as share classes is operable to be implemented in other common models in finance, such as assets that have more than one share class, each share class representing different rights with respect to the core asset. The linked token approach facilitates the transfer of assets to and from exchange traded funds enabling asset liquidity when separated from a parent fund, but convenient management when purchased by a fund for securitization.

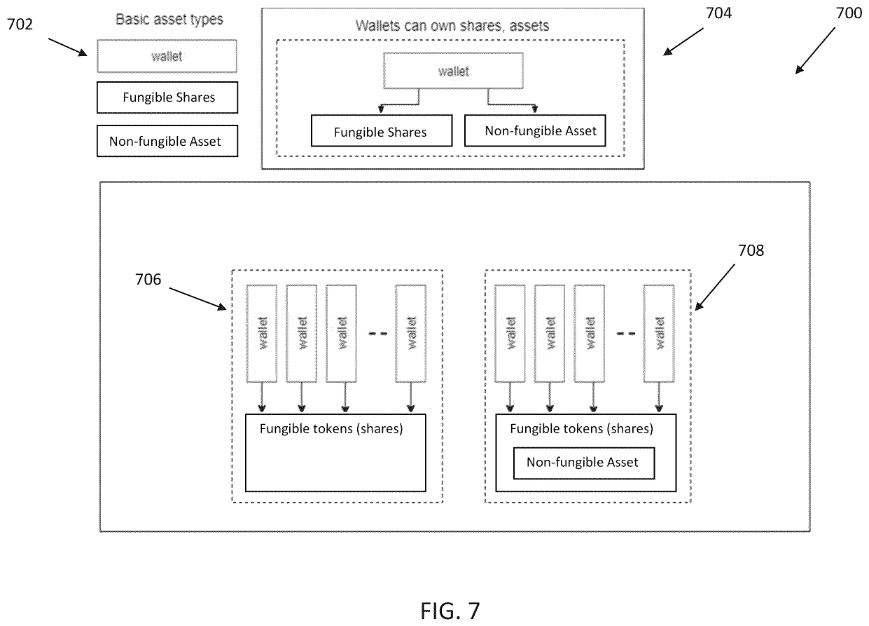

FIG. 7 is a schematic illustration of a data model 700 for wrapping a non-fungible asset token with a fungible token according to one embodiment of the present invention. This enables, for example, fractional ownership of a fund represented by a fund token. “Fractional ownership” as used herein refers to the situation in which a fungible asset is subdivided between multiple wallets, allowing for multiple owners of a single asset. The fraction of the subdivided fungible asset is referred to herein as a “fungible share”. As shown at 702, the basic token types are “wallet”, “fungible share” and “non-fungible asset”. As shown at 704, wallets associated with tokens are able to own other tokens representing fungible shares and/or non-fungible assets through the mechanisms described herein. This simplifies the structure and smart contract code of the asset non-fungible token since it is operable to utilize the dividend distribution and corporate governance function of the non-fungible token wrapper. Shares in a fund are represented by a fungible token. In one embodiment, shares are owned by one or more wallets or by assets as shown at 706. A smart contract linked to the fungible token exposes ownership and management functions for fungible assets in a fund, as shown at 708. The functions, which are also shown in the Computer Program Listing Appendix, include one or more of the following:
addAssetRequest(uint tokenid, uint purchaseTokenid, float price, uint expires, bytes data) external returns (uint orderid);
cancelAddAssetRequest(orderid) external returns (bool);
removeAssetRequest(uint Tokenid, uint purchaseTokenid, float price, uint expires, address buyer, bytes data) external returns (uint orderid);
cancelRernoveAssetRequest(orderid) external returns (bool);
getAsset( ) external return (uint); //Returns address of attached non-fungible token
event AssetAdded(uint tokenid);
event AssetRemoved(uint Tokenid);

In one exemplary embodiment, the asset is a self-processing loan that pays the wallet that owns the asset as loan repayments are received. The wallet is owned by the fungible token smart contract and loan repayments are distributed proportionally to the owners of the fungible token. The parent-child token structure further facilitates reuse of established transaction logic and exchange functions in fungible tokens while permitting specialization in asset specific functions, in this case, loan processing. As noted above, a fund is operable to have zero assets, as the fund is defined by the fungible token and the linked management smart contract.

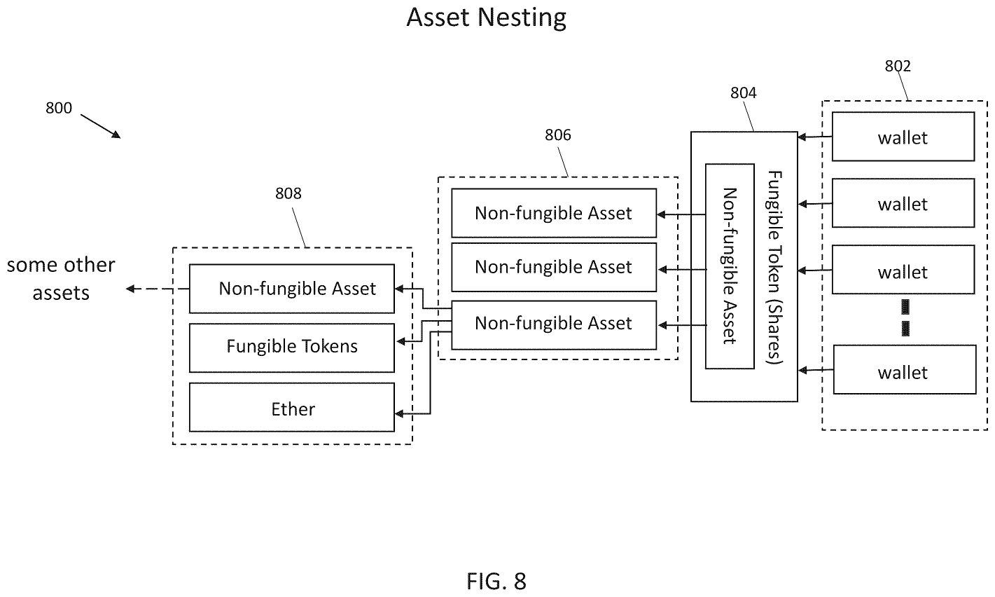

FIG. 8 is a schematic diagram of the data model for nesting of assets according to one embodiment of the present invention. An IAssetFund token is operable to contain any of the following: assets, asset tokens for other funds, fungible shares of other assets, or shares of fund assets. Nesting facilitates a fund of funds structure and large-scale portfolio diversification techniques. The token wallets 802 own fungible tokens shares 804 of a nonfungible asset. The non-fungible assets 806 are operable to own non-fungible tokens (e.g., a fund), fungible tokens, and other assets, (e.g., the cryptocurrency Ether), as shown at 808. The wallet structure and architecture described above with respect to FIGS. 1, 2, and 6 permit this recursive ownership structure to be represented by a data model that is operable to be used in connection with a decentralized system.

In the same way that IAssetFund extends the IAsset structure to implement Fund management functions, the IAsset structure may be extended for other asset types to permit token polymorphism. One of ordinary skill in the art will appreciate that “token polymorphism” as used herein refers to the use of a single interface for tokens of a variety of asset types. For example, in one embodiment, the present invention issues IAssetLoan tokens (i.e., IAsset tokens with a class type Loan from Asset Class Registry module 106 of FIG. 1). This class may implement self-processing loans (i.e., loans that process payments internally). Custom smart contracts for payment processing are assigned to loans by their owner using the AssignWaterfallProcess interface. This practice of enabling functions to be superseded by a derived class through inheritance is known as overloading. Overloading using the interface structure permits the execution of different loan processing strategies within the same fund.

By inheriting the IAsset structure, an IAssetLoan token receives payment to its wallet in any accepted currency, process the payment including an update to any outstanding principal, process fees, and pass the proceeds to its owner. All transactions and payments are operable to be inspected on the ledger, providing transparency and data needed for asset valuation. In one embodiment, using the IAssetFund Asset Management Functions, the IAssetLoan token is attached to a fund token to create a securitized fund. The loan token may be one of many IAssetLoan tokens. Loan payments are processed automatically by each loan with proceeds passed to the parent fund where they undergo further distribution towards management fees, dividend distributions, and other fund functions as managed by the IAssetFund token. This structure creates a fully transparent, self-processing securitized loan pool that is operable to scale indefinitely.

Self-processing, self-reporting loan assets in a self-processing, self-reporting fund provides transparency not present in the massive securitized loan (e.g., RMBS) funds that were at the root of the Global Financial Crisis. Similar techniques to those used to create self-processing, self-reporting loan assets are operable to be used to create funds of any type of asset, thereby providing investors access to a diverse set of new investment opportunities. Further, the data model and architecture described herein simplifies the management of funds using advanced, complex strategies.

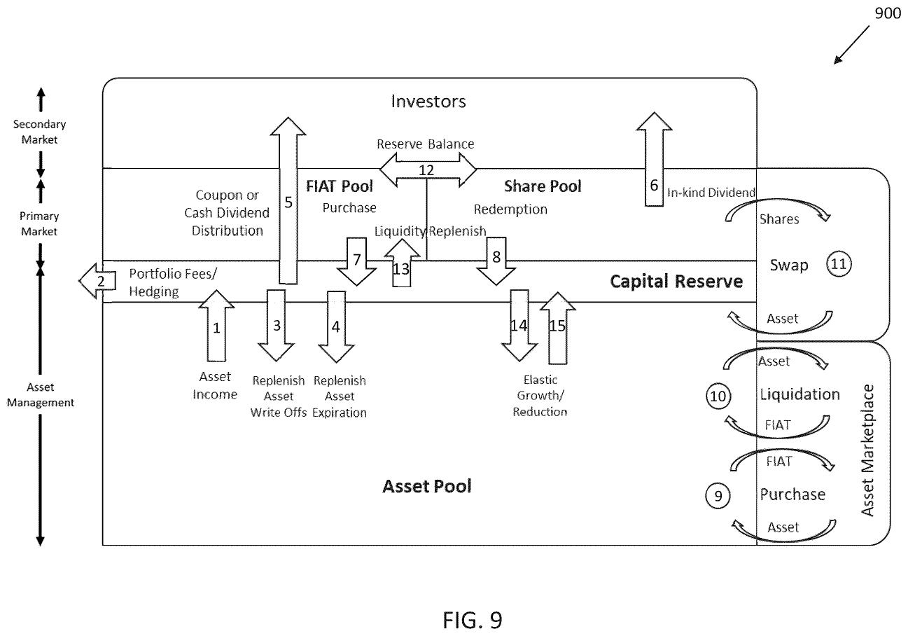

FIG. 9 is a schematic diagram of a fund management environment 900 displaying the implementation of a fund strategy according to one embodiment of the present invention. The fund management environment 900 includes common transactions for asset management in the primary and secondary market. Fund management environment 900 supports each of the operations through the use of the IAsset and IAssetFund interfaces disclosed herein. Each transaction of FIG. 9 is described below.

Process Asset Income to the Capital Reserve (1): The fund management strategy is initiated by the addition of income to the asset pool by an income generating asset. Examples of income generating assets include but are not limited to leases, bonds, debt instruments, and dividend paying shares. The income earning assets in the Asset Pool then process income. In one embodiment, income is processed using internal automated methods. In one embodiment, income is processed using external models accessed via the oracles of the present invention. These earnings are processed via the asset wallet for distribution providing full traceability of asset performance. When the fund token owner executes a ProcessWaterfall request via its IAsset interface, a ProcessWaterfall request is called for each of the IAssets owned by the fund. As a result of this request, the fund's assets transfer earnings to the Capital Reserve (IAsset wallet) of the fund. The fund executes internal waterfall logic to process these earnings. In one embodiment, the waterfall logic is a plugin smart contract, thus supporting innovative or repeatable fund management strategies. On completion of processing, funds are transferred to the wallet associated with a token's owner as defined by the token's processing logic (which may result in the execution of further distribution logic by the token's owner).

Process Portfollio Hedging/Management Fees (2): Fund waterfalls include payment of asset management fees. In one embodiment, fund waterfalls involve other internal services for fund operations such as hedging and insurance. These fees are paid out of the Capital Reserve (i.e., the asset wallet) using wallet transfer logic and may be executed via the waterfall logic smart contract. To maintain a consistent par value of the fund, these payments must be replenished by asset income or other sources.

Process Replenish Write Offs/Turnover (3): Assets are operable to be written off in a given period. This means the residual value of the asset is deemed to be zero. Write offs result from defaulted loans or underperforming assets. To maintain constant par value, write offs must be replenished using assets from the Capital Reserve as part of the processing waterfall. Sufficient balance is retained in the Capital Reserve to support “at risk” income streams (i.e. overdue loans or underperforming assets that may default in upcoming periods).

Process Replenish Asset Expiration (4): For certain types of funds, such as those consisting of expiring, illiquid assets, asset residual values are reduced as income is processed from the asset. For example, a payment on a mortgage that reduces the principal of the loan results in a reduction in the earning potential of the asset, (i.e., its residual value). To maintain a consistent earning potential of the fund, the residual should be replaced through the purchase of assets with similar or better earning potential. Realized earning potential results in a reduction of the residual value of the asset pool while increasing cash in the funds Capital Reserve, as income is collected by the income generating asset and collected in the Capital Reserve. Asset purchases using Capital Reserve assets uses the IAsset CreatePurchaseOrder function. Realizing income from contained asset distributions to the fund typically increases the overall NAV of the portfolio proportional to the asset's income stream risk, as the Capital reserve balance is increased by an amount that exceeds that reduced from the NAV of the asset pool. Portfolios consisting of rapidly expiring assets (e.g., trade finance) will see significant expiration in a given period, as the value of the asset reaches zero at an increased rate in comparison to other asset types. The higher the expiration percentage, the greater the elasticity ratio of the fund (elasticity of the fund relative to the elasticity of underlying assets).

Traditional securitization models are unable to process transactions with high-elasticity due to the transient nature of high turnover trades that are characteristic of the high-elasticity market. Without the model introduced by the present invention, liquidity for complex or transient markets is limited, resulting in a high cost of operations. The present invention introduces repeatability for multiple asset types and automation of asset trading that creates a system that is practical for use even in high-elasticity markets, such as trade finance. Further, the model of the present invention is well suited to conditions of short run, highly transient agreements (e.g., trade finance loans) because the model is built on the bundling of a large number of assets, referred to herein as “securitization”. Using the model of the present invention, even non-liquid assets return liquid capital to the pool as they expire (i.e., as the loan is repaid). With a large number of assets contained within the pool, the individual assets within the pool expire regularly, producing a natural source of liquidity without the need for individual asset liquidation.

Process Coupon or Dividend Distributions (5): In one embodiment, funds offer coupon income or cash dividends to the wallet associated with an owner and/or a shareholder. The term “cash” as used herein refers to any asset (fiat, crypto, or other asset types) but is typically liquid, readily traded for shares of the fund, and in the same asset type as the asset income. In one embodiment, the cash asset is operable to be traded in a pair. In one embodiment, Coupon Distributions are paid before other fund payments and Dividend Distributions are made from the proceeds that remain after other waterfall responsibilities are met. To ensure fund stability, Coupon Distributions are less than the overall expected income from fund assets. In one embodiment, asset income volatility or uncertainty determines the Coupon Distribution payout amount. Distributions are made via the ProcessWaterfall method. A token with built in dividend distribution function (e.g., an ERC-1726 compliant token) such as the Compliance Aware Tokens (CAT) described in U.S. patent application Ser. No. 17/083,622 incorporated herein by reference in its entirety, contain shareholder distribution functions. By attaching the asset token to the fungible token, distributions to the wallets associated with the shareholders of the fund are operable to be processed automatically and at scale. Many funds do not offer Coupon Distributions or Dividend Payments, creating a static income processing system that is not as readily adaptable as the system of the present invention. In these cases, asset income increases the par value of the fund.

Process In-kind Share Dividend (6): In one embodiment, funds are able to pay distributions using shares of the fund rather than cash dividends. This strategy is used for some funds for tax purposes or to enhance liquidity. Funds from the Capital Reserve are used to purchase the shares to be distributed. In one embodiment, these shares are purchased from a liquid secondary market. In one embodiment, these shares are purchased from a liquidity reserve pool in the primary market at the funds NAV. In one embodiment, these shares are created by issuing share tokens consistent with the funds NAV. The flexibility of the share purchase, redemption, and distribution model enables the IAssetFund structure to support any existing fund management strategy including ETFs, mutual funds, or closed-end funds. This also supports fund revenue optimization strategies for tax or liquidity benefits.

Process Primary Market Purchase (7): The IAssetFund token may be attached to a fungible token to facilitate fractional ownership. Investors may purchase or sell fund shares in the primary market using the SharePurchaseRequest and SharePurchaseSwapRequest methods supported by the fungible token interface. For open-ended funds, that is, funds where the share count may change based on market demand for the underlying asset, shares are issued or redeemed to support the request. Based on the fund's operating model, shares are delivered to the purchasing party in exchange for assets or cash-in-lieu (CIL) of assets. SharePurchaseRequest is a CIL transaction. For this type of transaction, shares are sold at the fund's strike price, (i.e., the price equivalent to the NAV of the fund divided by the total number of shares). The SharePurchaseRequest is made, the NAV is assigned, and the purchaser must fulfill the orderby supplying the “cash” assets required. The IAssetFund token receives the cash and must purchase or assign the underlying from an asset marketplace or using the IAsset CreatePurchaseRequest function. SharePurchaseSwapRequest is used for transactions where the assets used for share purchase are consistent with the investment thesis or index (ratio of shares to underlying assets in the fund) of the fund.

Process Primary Market Redemption (8): This transaction is the opposite of the Primary Market Purchase transaction. Shares of the fungible token are sold to the fund in exchange for cash (ShareRedeemRequest), or assets from the underlying fund (ShareRedeemSwapRequest). Depending on the cash in the Capital Reserve, it may be necessary to liquidate assets from the IAssetFund token using CreateSellRequest.

In one embodiment, the present invention includes the establishment of a liquidity reservoir as a part of the fungible token to enable elastic securitization. The liquidity reservoir is a smart contract that prices Primary Market transactions and/or Secondary Market limit orders based on the net inflow or outflow of capital to the fund. The liquidity reservoir maintains a pool of shares and cash sufficient to fulfill the orders. Price is adjusted around NAV based on the deviation of the reserve pool balance from the desired balance as set by the fund manager. For example, a significant inflow of capital via an imbalance of SharePurchaseRequests will increase the cash pool in the reservoir while decreasing the available share pool. A pricing algorithm (smart contract plugin based on fund manager strategy) increases share price in the reserve pool increasing the likelihood of a redemption while decreasing the demand for new purchases. The algorithms react to adjust the price of liquidity in the face of changes in investor demand to return the reservoir to balance.

Process Asset Purchase (9): In some portfolios, portfolio managers purchase assets using cash from the Capital Reserve. These purchases use the IAsset CreatePurchaseRequest. For example, assets that expire are replaced with cash from the Capital Reserve replenished by asset income. NAV assessments and hedging strategies are the principal responsibility of a portfolio manager, as these decisions reflect overall portfolio alpha. One of ordinary skill in the art will appreciate that the portfolio alpha is the comparison between the performance of a portfolio (i.e., the amount of income generated) compared to the benchmark index for the associated assets of the portfolio.

Process Asset Liquidation (10): If the Reserve Balance falls below the Liquidation Threshold, actions are triggered requiring portfolio managers to sell assets to restore portfolio liquidity requirements. These triggers may be enacted via smart contracts and are executed through the IAsset CreateSellRequest.

Process Swap (11): In other portfolios, assets enter the portfolio via swaps, i.e. exchanges of income earning shares for rights to asset earning potential. Some portfolios may use both techniques to acquire assets. The use of a swap vice cash purchases are preferred as this introduces additional liquidity into the portfolio.

Reserve Balance (12): In one embodiment, the reserve pool of the present invention comprises a fiat pool and a share pool. The Reserve Balance is the balance between the portion of the reserve pool comprising the fiat pool and the portion of the reserve pool comprising the share pool. The fund manager is responsible for setting and maintaining the Reserve Balance.

Process Replenish Reservoir (13): In one embodiment, in an elastic securitization model (i.e., an income processing waterfall) applied to a fund of income producing assets, cash distributions are used to restore liquidity in the Reservoir if reservoir cash levels are low based on a sustained exodus of shareholders. The amount of reservoir liquidity to be restored in this step is determined algorithmically as a function of Reservoir Balance, Capital Reserve, and market conditions. If significant liquidity restoration is required, resources may be unavailable to replenish expiring assets resulting in a reduction of the par value of the portfolio. If income levels fall below the liquidation threshold, this triggers the asset liquidation step as described below.

Process Elastic Portfolio Growth (14): A sustained price above the NAV resulting from a sustained imbalance of purchase orders creates a cash imbalance in the Reservoir. If this price exceeds the NAV by a threshold, the assets is operable to be transferred to the Capital Reserve to purchase more assets into the fund driving the growth of the overall NAV of the fund. Using this model, the NAV of the fund grows elastically without the use of Authorized Participants or the issuance of new shares.

Process Elastic Portfolio Reduction (15): The removal of liquidity by investors results in a net outflow of value from the cash pool. A sustained imbalance resulting in pricing below NAV signals a need to liquidate assets from the fund to provide the cash needed to restore the cash pool. Sustained portfolio underperformance will result in controlled liquidation of assets under management and subsequential. In one embodiment, the present invention is operable to limit the access of a module associated with a fund manager based on the performance of assets under his or her control. While technically closed fund, the elastic fluctuation in par value based on investor demand and asset performance provides desirable characteristics of an open fund.

Elastic securitization is a process that allows the growth and reduction in the size of a fund containing illiquid assets. The process addresses a market need to provide fund structures to facilitate exchange trading of illiquid assets providing a liquidity buffer between liquid assets trading on an exchange and illiquid assets in the underlying fund addressing the concerns implicated by implicated by 17 CFR 270.22e-4, also known as SEC Rule 22e-4, which requires funds, including ETFs, to establish liquidity risk management programs and prevents funds comprising more than 15 percent of illiquid investments from purchasing additional illiquid investments.

The flexibility of the linked IAssetFund and IAsset structure provides a mechanism to execute common and advanced fund management strategies. The structure makes it possible to automate common asset management functions and inject innovative fund management strategies while providing transparency, simplified auditing, and rapid reporting. Linking fungible tokens to the non-fungible IAssetFund token provides new utility for fund shares. Shares may be: held for income (dividends) or growth; transferred as payment; held in escrow as collateral; monetized through exchange in authorized secondary markets for USD, BTC, EUR, or other securities; and/or used to participate in fund governance through proxy voting.

The disclosed implementations enable fund assets to be purchased or redeemed from the asset pool using fund shares via a swap mechanism. This creates a “backing” model enabling assets to be added or removed from the fund using token issuance and destruction (i.e., creating a token with a limited time-to-live or voiding/removing a token). One embodiment of the present invention includes a liquidity pool to manage the net inflow and outflow of capital into the fund. A liquidity algorithm is applied to set share price to help manage redemptions and facilitate the formation of a secondary market for the fund's shares. This model is repeatable and is applicable to any fund structure, including but not limited to Lending, Debt Instruments, Receivables, Structured Settlements, Factoring, Trade Finance, Insurance, and Leases.

As one example of an automated fund structure according to one embodiment of the present invention, a closed-end Lending Pool fund is created by leveraging a fund smart contract. The pool is funded from existing assets, warehoused loans, rehypothecation, or capital formation. At first, the pool contains only the capital (fiat or crypto) needed for lending. Using the fund smart contract format, the Pool exposes a NAV and PAR value for the pool (i.e., the sum of the NAV and PAR value of all assets in the pool) and publishes a list of assets and supporting documents in real time. All fund transactions are recorded on an immutable ledger. In one embodiment, the pool has a Portfolio Manager. In one embodiment, the pool has an Asset Manager. In one embodiment, the pool deploys smart contracts for applying additional services (e.g., hedging, asset insurance). Loans are originated by authorized agents and funds disbursed through an automated process. On origination, loans are added as assets to the fund. Using the disclosed implementations, all assets (available lending capital, receivables, and other assets) are displayed to authorized parties in real time.

Loans originate from the pool as smart contracts extending the IAsset Smart contract. This facilitates securitization, fund operations, and compliant transfers. As IAsset objects, they publish supporting documentation, transaction history, and real time asset NAV & PAR value to authorized viewers. Loan Tokens leverage the IAsset structure to publish loan characteristics to enable independent analysis and valuation. Loan tokens are operable to be wrapped in Ethereum Request for Comment standard tokens to govern transfers. (See, e.g., https://eips.ethereum.org/erc, accessed Apr. 6, 2023, which is incorporated by reference in its entirety). In one embodiment, Loans tokens are operable to be wrapped in ERC-20 and/or ERC-721 tokens.

Incorporated in the loan token is valuation and payment processing logic. Payments are made via simple transfers from the asset token to an address (e.g., an address specified in a QR code) specific to the loan. Using the present invention, a wallet is operable to transfer money to a second wallet associated with a loan token in order to pay off a loan. Payments are processed and proceeds are transferred to the wallet of the loan token owner. In one embodiment, the wallet of the loan token owner is a fund. In one embodiment, the PAR value and NAV for each loan are updated in real time with each payment. Transaction history for each loan is recorded on an immutable ledger and available for analysis by authorized users.

Pool Payment processing is automated and transparent. In one embodiment, proceeds from repayment of individual loan assets in the fund are transferred to the Risk Pool for further processing. The Risk Pool processing logic leverages a customizable smart contract to automate redemptions, loan write-offs, Pool capital replenishment, management fees, dividend payments, and coupon payments via a transparent and verifiable waterfall. Dividend and coupon payments and other distributions are transferred automatically to fund owners using fund logic embodied in a smart contract.

In one embodiment, assets may be sold from or purchased into the portfolio in order to increase liquidity. Supported asset transactions include purchase and sale of the asset via loan markets, as well as redemptions and swaps using fund tokens. Other transactions include collections and write-offs. In one embodiment, dividend payments are made in cryptocurrency, fiat, or in-kind pool tokens. Tokens are issued through a primary market offering, auction, and/or through a tokenization of existing interests. The wallets associated with shareholders receive coupon & dividend distributions proportional to share ownership automatically. The result is dividend paying tokens. Asset backed security tokens are revolutionary financial instruments. The tokens are: (1) held to receive a dividend; (2) transferred as payment; (3) held in escrow as collateral; and/or (4) monetized through exchange in authorized secondary markets for fiat currency, cryptocurrency, or other securities.

Using elastic securitization mechanisms, growth in demand for tokens results in an influx of capital (in a model similar to growth in demand for a mutual fund). Additional capital results in expansion of lending pool PAR value providing more assets for lending and enabling indefinite growth. Similarly, capital exodus caused by underperformance or other factors results in a controlled drawdown of portfolio NAV as assets are moved and/or liquidated. This model is repeatable and is used to meet nearly any securitization need, including but not limited to lending, debt instruments, receivables, structured settlements, factoring, trade finance, insurance, and leases.

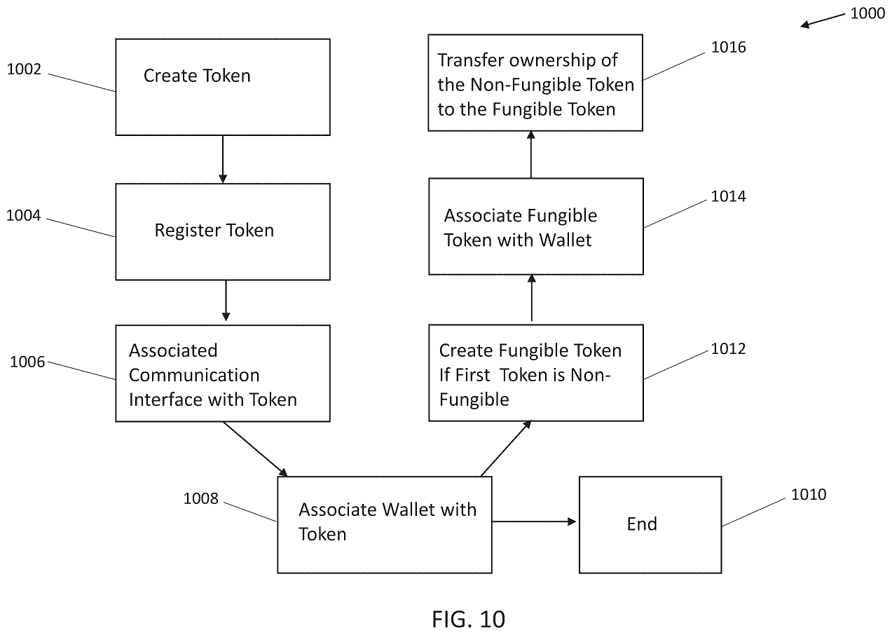

FIG. 10 is a process flow diagram of a method 1000 for configuring a data storage and retrieval system for managing data relating to tokenized assets according to one embodiment of the present invention. At 1002 a digital token is created in accordance with a class definition, the token including a unique token identifier. At 1004, the digital token is registered in association with an asset as a unique record in a memory device of an asset registry. At 1006, a communication interface is associated with the digital token in accordance with the class definition. In one embodiment, the communication interface is compliant with a communication specification implemented by the asset registry and which is configured to expose a set of predefined functions. The predefined functions include asset ownership transfer functions, asset valuation publication functions, asset attribute determination functions and asset specific processing logic.

At 1008, a cryptographic wallet is associated with the digital token. The wallet is configured to conduct token functions that are recorded in the asset registry. For a fungible token, the process is operable to end at 1010 after association with a wallet. If the digital token is non-fungible, a fungible digital token is created at 1012. At 1014, a cryptographic wallet is associated with the fungible digital token. The wallet is configured to conduct token functions. At 1016 ownership of the non-fungible digital token is transferred to the fungible digital token in order to wrap the non-fungible digital token with the fungible digital token and thereby enable fractional ownership of the asset represented by the non-fungible token including functions associated with shared ownership such as multi-party dividend distributions, corporate governance, and share trading.

The above tokens are used to transfer value within a DLT network and across multiple DLT networks or other transfer networks, as tokens of a first platform are operable to be wrapped by a token of a second platform to ensure compatibility with that platform. In one embodiment, the present invention is implemented on a distributed ledger. In one embodiment, one or more modules of the present invention are implemented off-chain. In one embodiment, the present invention is a hybrid system with one or more modules configured to operate on-chain and one or more modules configured to operate off-chain.

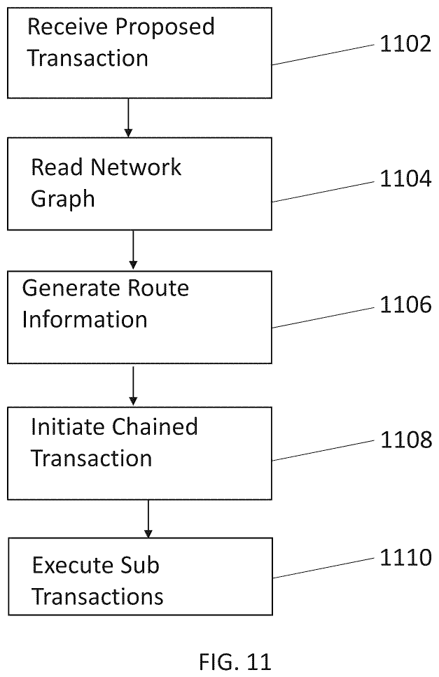

FIG. 11 is a process flow diagram of a method for providing communication between heterogenous DLT systems in order to conduct a transformation transaction according to one embodiment of the present invention. At 1102, information is received describing a desired/requested cross-ledger transaction that spans at least two dissimilar networks, such as two different DLT networks. At 1104, a multi-network graph structure is read. In one embodiment, the graph structure is created by crawling nodes corresponding to bridges that span networks. Each node in the graph structure has an associated set of attribute variables stored as node metadata. The attribute variables include units of value (i.e., tokens) native to the corresponding network, identification of smart contracts implementing the tokens, wallets or accounts used for bridging, value sources available to the user, and application programming interfaces (API) and network interfaces to other networks. One of ordinary skill in the art of multi-network graphing will appreciate that the term bridging as used herein refers to the insertion of a connection (i.e., an edge) to connect two previously unconnected nodes of two separate graphs (i.e., a graph of a first DLT and a graph of a second DLT). At 1106, transaction routing information is generated for effecting the transaction by traversing the graph structure in accordance with a node traversing algorithm and detecting bridge nodes that facilitate the desired transaction. At 1108, a transfer path is selected by the source based on preferences using the transaction routing information and the transfer is initiated. In one embodiment, the desired transfer path includes a chained set of sub-transactions that ensures proper execution of the requested cross-ledger transaction. At 1110 sub-transactions are executed using the specified interfaces to achieve the cross-network transaction.

Sub-transactions are executed on heterogeneous networks using an ontology mapping that converts syntax-independent execution instructions to specific instructions recognized by the underlying transfer network. That is to say, the ontology mapping technique identifies the syntax-independent instructions from a first DLT network and converts the instructions into instructions that are recognized and executable by the second DLT. The term “finance ontology” as used herein also refers to this mapping technique. The finance ontology enables the system of the present invention to represent basic financial actions (e.g., a value transfer from one account to another) in a generic language used for business logic that does not depend on the implementation details of supported networks and systems. For example, the syntax and implementation of a transfer of value from one wallet to another on the Stelar network vs the Ethereum network vs PayPal are very different, but the high level result is the same. The finance ontology requests the transaction in a language understood by both networks, which is then translated to the syntax required for execution on a specific system or network. In one embodiment, the overarching transaction and all sub-transactions are recorded on a ledger. In one embodiment, the overarching transaction and all sub-transactions are recorded on an independent ledger that is distinct from the ledgers involved in sub-transactions. In one embodiment, the independent ledger utilizes zero knowledge proofs to provide immutability while maintaining transaction privacy. In one embodiment, the chains of sub-transactions include transactions in the source network, the destination network, and other networks that serve to as connections between the source network and destination network.

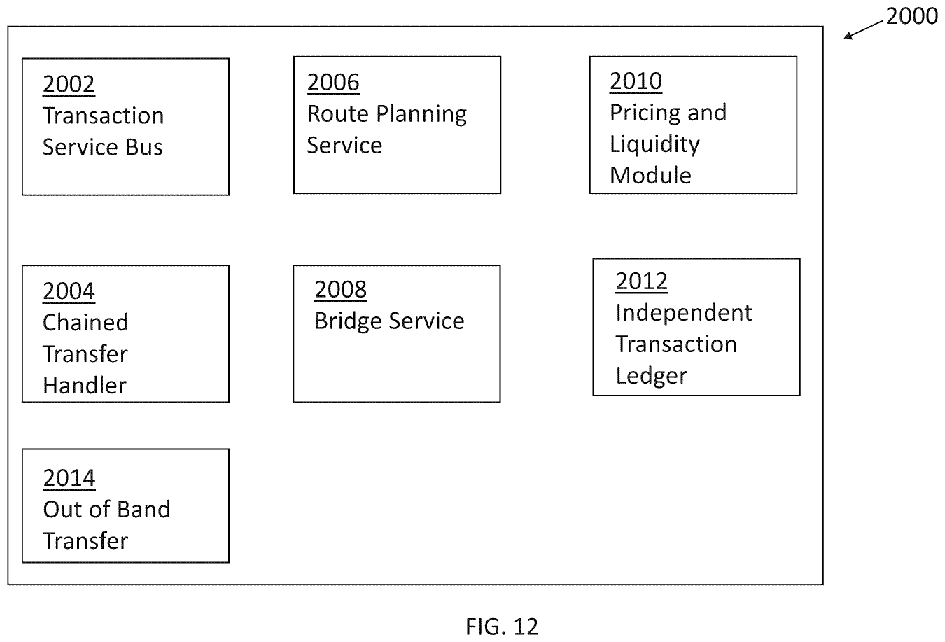

FIG. 12 is a schematic illustration of a computer architecture for interfacing heterogenous DLT systems and other transformation transfers according to one embodiment of the present invention. The architecture 2000 consists of Transaction Service Bus module 2002, Chained Transfer Handler module 2004, Planning Service module 2006, Bridge Service module 2008, Pricing and Liquidity module 2010, Independent Transaction Ledger module 2012, and Out-Of-Band Transfer/Replenishment module 2014. Each module of architecture 2000 is configured to communicate with the others as necessary through a networked computing environment.

In one embodiment, the modules described herein are implemented as computer executable code within a single computer processing unit. In one embodiment, the modules described herein are implemented as computer executable code within multiple computer processing units. In one embodiment, one or more of the modules are operable to be implemented remotely from the other modules in a distributed architecture. The description below of the functionality provided by the different modules is for illustrative purposes, and is not intended to be limiting, as any of modules may provide more or less functionality than is described. For example, one or more of the modules is operable to be removed and some or all of the functionality of the module is provided by another module described herein with respect to FIG. 12.

Automated execution of transformation transaction, such as an inter-network (cross-ledger) transaction, is accomplished in response to receiving a transaction data structure specifying the details of a proposed cross-ledger transaction, such as a value transfer (i.e., transfer of a token). In one embodiment, the data structure includes transaction details (e.g., source, destination, amount, currency) and is created by a party with the authority to initiate the transfer. For example, in one embodiment, the transaction data structure appears as (TransactionType=Transfer, TransactionCurrency=Ether, Source=[wallet 1 address], Destination=[wallet 2 address]).

Transaction Service Bus module 2002 parses the transaction data structure and determines, based on the graph, one or more viable paths (including expected pricing, fees, and transaction times) for traversing multiple networks to execute the specified transaction. The path is determined by Route Planning Service module 2006 based upon a model of the networks and includes a transaction chain consisting of multiple sub-transactions, each sub-transaction having a source and a destination. If asset transformation is required on a path, Pricing and Liquidity module 2010 specifies the ratio between the source and destination assets required for a bridge traversal based on bridge metadata. Chained Transfer Handler module 2004 executes the sub-transactions as a sequence of network transfers, confirmations, and bridge traversals as specified by Bridge Service module 2008 to ultimately affect the value transfer of the specified transformation transaction. Out-of-band Transfer module 2014 is used to include non-network transfers (i.e., manual transfers). Out-of-band Transfer 2014 module is used to rebalance account resources, as needed, based on the consumption of liquidity in the sub-transactions. Transaction records are recorded by Independent Transaction Ledger module 2012. Disclosed implementations are operable to leverage the compliance framework described U.S. patent application Ser. No. 16/143,058 (incorporated herein by reference in its entirety) to safeguard cross-ledger transactions and conduct compliance verification on dissimilar networks.

The model of the networks referred to herein is created by Route Planning Service module 2006 utilizing a multi-agent system that crawls various networks expected to participate in a cross-ledger transaction and bridge nodes to identify a viable path for the transfer of value between the source and destination. In one embodiment, the inter-network topology is stored as a graph structure of nodes. The node attribute variables are described in greater detail below and include descriptions of value units (tokens) native to the particular network, traversal methods, accounts used for bridging, fees and pricing methods, and/or associated API's and network interfaces for the purposes of communication with external sources.

The Out-Of-Band Transfer module 2104 provides out-of-band (OOB) processing in cases where value transfer path legs cannot be fully automated within the system. Interfaces are provided to enable third parties to signal and provide data to the system to facilitate processing execution. For example, a fund imbalance accumulates in the case in which bridges only support a one-way flow of funds across networks, and OOB transactions are required to restore balance. Managing OOB time lags and proper prepositioning of funds in the outbound account is a logistical problem with firmly established mathematical models for control. Price Discovery is facilitated through the operation of the Price and Liquidity module 2010 (FIG. 12). This module adjusts price through market functions to maintain a balance between inbound and outbound account levels.

In one embodiment, external markets are used to replenish liquidity. Dark pool owners (i.e., those who contribute assets to a privately organized forum or exchange) receive income from fees linked to pool usage. The Price and Liquidity module 2010 is designed to manage liquidity between ecosystems, currencies, and asset exchanges. The Price and Liquidity module 2010 applies market making algorithms to manage liquidity. Additionally, the Price and Liquidity module 2010 manages the cost of transfer based on the balance of resources on both sides of the dark pool (i.e., a privately organized forum or exchange). This drives up the cost of sustained mismatch in the flow of capital. For example, a sustained imbalance in resource flow between A and B will result in an increase in price to move from A->B and decrease in price to move from B->A. The bigger the mismatch, the greater the revenue of the model. In one embodiment, a wallet is operable to “invest” in mismatch to bring liquidity where needed.

In one embodiment, Liquidity Dark Pools are used to facilitate transfers between or within ecosystems when currency exchanges are involved. The chained flow is repeated across many providers and includes the exchange of available currency to provide a path for any flow of value. In one embodiment, the chained flow uses external liquidity. In one embodiment, currency exchange occurs via Price and Liquidity module 2010 depicted in the architecture 2000 of FIG. 12. The process is repeatable and uses counterparty exchange accounts to maximize liquidity.

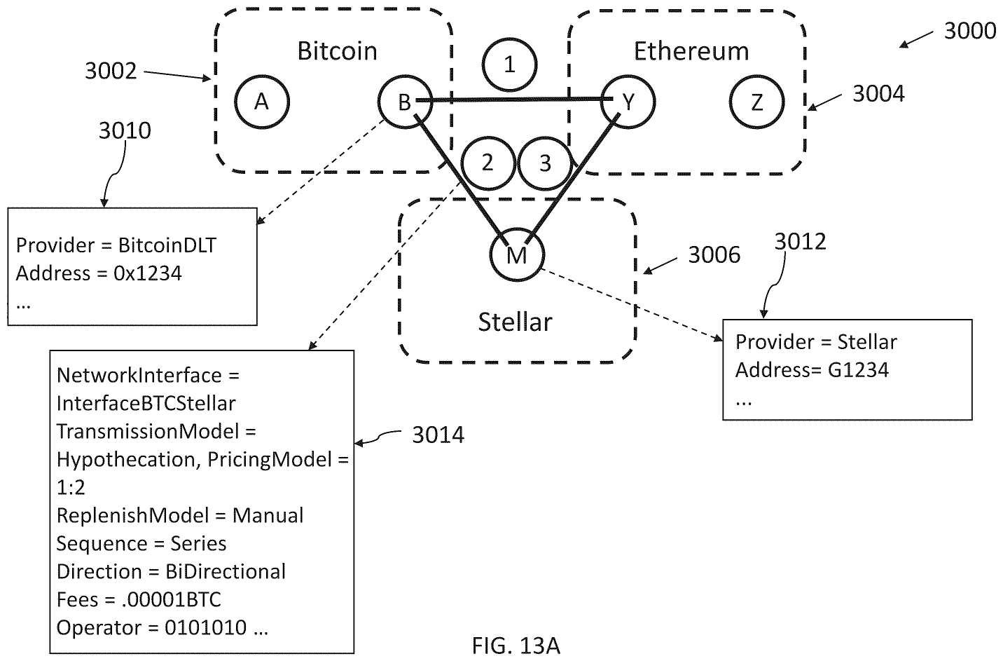

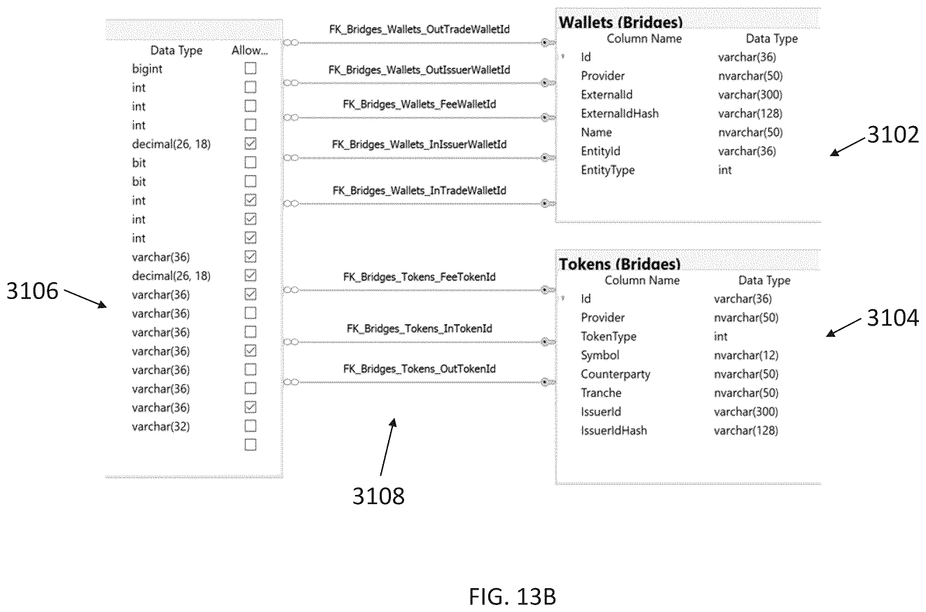

FIG. 13A is a schematic illustration of a simple node graph structure 3000 of an inter-network topology according to one embodiment of the present invention. Network 3002 is a first network (e.g., the BITCOIN blockchain), network 3004 is a second network (e.g., an Ethereum protocol blockchain) and network 3006 is a third network (e.g., a Stellar protocol blockchain). While FIG. 13A depicts only three dissimilar networks, the present invention is not limited in the number or type of dissimilar networks traversed and/or connected. In one embodiment, the simple graph structure 3000 is traversed by the Route Planning Service module 2006.

Each network depicted in FIG. 13A has a bridge node, each node representing one side of a bridge that provides communication between networks. Node B is a bridge node in network 3002, node M is a bridge node in network 3006, and Node Y is a bridge node in network 3004. Each bridge node corresponds to an account/wallet in the corresponding DLT network. A pair of bridge nodes define a bridge between the two nodes. For example, nodes B and M define a bridge between DLT network 3002 and DLT network 3006. Each bridge node has a corresponding metadata record indicating the above-noted set of attribute variables. Further, bridge characteristic data is stored as bridge metadata. Each pair of bridge nodes connected with a line in FIG. 13A, and the associated metadata (i.e., node metadata and bridge characteristic metadata) defines a bridge. While FIG. 13A depicts only three bridge nodes, there are any number of nodes and bridge nodes in the graphs of the networks of the present invention.

In one exemplary embodiment, metadata record 3010 is stored in association with node B, metadata record 3012 is stored in association with node M and bridge characteristic metadata record 3014 is stored to define the connection between node B and node M. Therefore, a bridge is defined by metadata record 3010, metadata record 3012, and metadata record 3014 (referred to collectively as “bridge metadata” and further illustrated by FIG. 13B). While metadata records 3010, 3012, and 3014 are illustrated as three distinct records, the data therein is operable to be combined into a single record of bridge metadata and/or divided over additional records based on the architecture of graph 3000. In one embodiment, the present invention uses a standard schema for specifying the metadata. Bridges serve as connection paths between dissimilar networks. The graph allows transaction paths to locate and use bridges in cross-ledger transaction chains and/or intra-ledger transactions as described herein. The metadata records 3010, 3012, and 3014 are discussed in greater detail below in connection with bridge functions.

FIG. 13A also illustrates the selection of paths and transaction chains by the Route Planning Service. The graph 3000 has three DLT networks 3002, 3004, and 3006, each having at least one node. Transactions may occur within a network (e.g., A->B, Y->Z). However, in order to cross between networks (e.g., transact between nodes that are in different DLT networks) a bridge must be used. Without bridges, no path exists for transfer between networks (e.g., node A of DLT network 3002 and node Z of DLT network 3004. To link the networks, bridging accounts B, M, and Y are created. Bridges are then created to link these accounts. Using Bridge 1, a route between, for example A and Z, exists (A->B˜1˜Y->Z). A second route exists by linking through a third-party network (A->B˜2˜M˜3˜Y->Z). A route planner of Route Planning Service module 2006 traverses the network graph and generates these routes as potential routes. In one embodiment, a user decides the best transfer path from the identified options based on preferences and other attributes. In one embodiment, an automated service decides the best transfer path from the identified options based on preferences and other attributes through the use of artificial intelligence as described herein.

FIG. 13B is a schematic illustration of bridge metadata according to one embodiment of the present invention. Schema 3100 includes wallet attributes 3102 which are stored in the graph as node metadata, token attributes 3104 which are stored in the graph as node metadata, data type attributes 3106 which are stored in the graph as bridge characteristic metadata, and interfaces 3108 which include pricing models and other logic and which are stored in the graph as bridge characteristic metadata.

The data in graph 3000 is stored by the Bridge Service module 2008 and traversed by the Route Planning Service module 2006. Transaction Service Bus module 2002 provides optimized transaction routing information, including sub-transactions required to effect the transformation transaction. When presented with the routes, the source account initiates a chained transaction, based on the graph and user preferences such as one or more of transaction time, conversion rates, and fee load. Chained Transfer Handler module 2004 manages transaction execution including the proposed sub-transactions to ensure proper transfer execution or rollback through ultimate delivery. The term “rollback” as used herein refers to the erasure of data modifications made from the start of the transaction or to a save point.

Transaction Service Bus module 2002 implements a finance ontology that serves as (1) a syntax-independent model of value transfers, (2) a catalog of transfer messaging terms and associated items, and (3) a translation schema to convert heterogeneous implementations of the various networks to the syntax-independent model. Chained Transfer Handler module 2004, executes sub-transactions on heterogeneous networks via the Transaction Service Bus module 2002 which translates the proposed sub-transactions from the syntax-independent instructions to the network specific implementation.

The finance ontology is an abstraction layer that provides a common language for financial transactions. The ontology defines interfaces for the services, functions, and objects encountered in financial systems. The ontology additionally provides an interoperability layer to isolate the differences in dissimilar networks (e.g., networks 3002, 3004, and 3006) to provide a flexible modular system where individual components are loosely coupled. The ontology makes it possible to combine individual financial services to create complex financial systems even if individual services are not designed to work together. Since payment chaining is designed to connect any transfer network to any other transfer network, the common service definition reduces the complexity of the interconnecting N systems from N factorial (N!) to N. Thus, the ontology is designed to make large integrations tractable. Standard functions and interfaces of the technology are discussed in detail herein.

However, developing a common abstraction for each underlying provider for the sake of tractability may reduce the expressivity (that is, special features that are exposed by unique providers) of individual providers. The disclosed framework has two mechanisms to ensure that expressivity is not lost for tractability. First, in one embodiment, “wrappers” expose features that are unique to a specific provider/network or to a subclass of providers/networks. In this case, dependent clients are able to interface directly with the wrapper to leverage these unique features. However, this creates a direct dependency between the client and service implementation that tightly couples the client to the service implementation limiting modularity and scalability. In one embodiment, an implementer determines if the tradeoff to gain unique functionality is worth the increased dependency on a specific provider/network. In one embodiment, the present invention is operable to limit the use of wrappers to expose features that are unique to a specific provider in order to prevent dependency on the specific provider. Rather, the system utilizes only a common abstraction for each underlying provider. Additionally, the ontology includes a data structure that enables additional data with a locally defined specification to be carried in a general purpose interface. The core data structures include an OtherData field that has a specification that includes type and data information enabling parsers to inspect the data and parse it if the format is recognized. This structure enables point to point communications between systems. In one embodiment, this point to point communication requires additional data to be carried in structures used by all parts of the system. As a result, coordinating functions, like those exhibited in the Chained Transfer Handler, are configured to perform functions at global scope without sacrificing the unique features of specific transfer providers.

As noted above, Bridge Server module 2008 provides logical interfaces (i.e., bridges) between the various DLT networks and relays transactions and value between them. Bridges accommodate token types representing both similar and dissimilar assets and units of value. Bridge server module 2008 implements the bridges to create a logical cross-ledger connection based on the model and node metadata. Essentially a bridge is a data structure that defines the transfer behavior. Bridge Server module 2008 reads the metadata records (e.g., metadata records 3010, 3012, and 3014 as depicted FIG. 13A). The Bridge Server module 2008 then determines bridge type, assigns one or more Vostro wallets, assigns one or more Nostro wallets, identifies fees, determines pricing models, assigns out-of-band replenish as necessary, and identifies and attaches transformation logic in the manner set forth below. An entity or system process with appropriate permissions to operate via both networks spanned by a bridge is known as a bridge operator and is indicated in the metadata record 3014. Bridging accounts are created or assigned to link the source and destination networks. In one embodiment, the source account in a bridge is a custody account. In one embodiment, the source account is active for two way bridge support. In one embodiment, the destination account is active for two way bridge support. In one embodiment, the destination account requires a linked issuer for certain types of transfers.

Various classes of bridges are operable to be created and stored by Bridge Service module 2008. These classes include but are not limited to price discovery (e.g., pegs, floats, exchanges), accounting (e.g., translation, indenture), and transfer (e.g., in-band, out-of-band). These classes provide common interconnectivity patterns facilitating repeatable processes to execute and record the movement of value between networks. A contained bridge class is composed of options in areas such as price discovery, accounting, and transfer (e.g., in-band and out-of-band combinations), as specified by the metadata model. Dissimilar networks are connected together using bridges and thus bridges facilitate the flow of value between networks as specified by the metadata. In one embodiment, bridges are configured to extract a toll for the service of connecting networks and facilitating value flow. Bridges create connections between networks or units of value that receive and relay value transfers across different transmission networks by controlling transmission mode, pricing, synchronicity, and fees. Examples of transmission mode, pricing, synchronicity, and fees include but are not limited to the following:
Transmission mode: hypothecation (by reference), settlement (by value), linkage, or trade—transformation (changing, splitting the assets)
Pricing: exchange, algorithmic, pegging
Synchronicity: Synchronous or asynchronous (with hedging & risk management)
Fee: capital supply logistics, and liquidity management

Each Bridge includes an inbound account, referred to herein as a Vostro account, and an outbound account, referred to herein a Nostro account. In one embodiment, the inbound and outbound account are associated with nodes of dissimilar networks (e.g., nodes B and M of FIG. 13A). The accounts are owned by the bridge operator with “system” permissions to be operated as part of a transaction chain. These accounts are provided as configuration parameters in the bridge metadata during the creation of the bridge. The value units supported by the inbound and outbound accounts define the connections supported by the bridge. Supported connections are necessary for transfer routing. For example using the illustration of FIG. 13A, where a transaction originates in the Bitcoin Ledger (DLT network 3002) and crosses into the Stellar Network (DLT Network 3006), the inbound (Vostro) account of the bridge (indicated by B) becomes the destination account for the initial sub payment in the transaction chain. This account does not need to be an “Active” account (i.e., an account containing authority to operate) unless “rollback” capability is required. The outbound (Nostro) account of the bridge (indicated by M in FIG. 13A) is used to send value down the chain or to the final destination. The Nostro account is Active, meaning the processing thread has the authority to initiate a transaction from the account. In one embodiment, tor transactions with prepositioned value, known as Dark Pool Transactions, sufficient value must be present in the inbound bridge account prior to initiating the chained transaction. In one embodiment, bridges are loaded from Bridge Server module 2008 into a list used by Chained Transfer Handler module for route planning and payment execution. The class used to execute the bridge is determined by the configuration of the route model.

In one embodiment, the list of possible routes from one wallet type to another wallet given the desired destination value unit is determined by evaluating the supported tokens, indicated in bridge metadata, for inbound and outbound wallets. Route Planning Service module 2006 uses this list when mapping paths from source to destination. For example, graph 3000 of FIG. 13A illustrates two possible routes between DLT network 3002 and DLT network 3006. The first route is indicated by 2 and the second route is indicated by the combination of 1 and 3.

In addition to bridge configuration details, operational attributes of bridge classes are determined by dependency injected details and are stored as bridge metadata. Variations in bridge operations according to one embodiment of the present invention are divided into 6 attributes defined in the metadata: Transmission Model, Pricing Model, Replenish Model, Sequence, Direction, and Fees. The Transmission Model defines how ledgers are linked together via bridging wallets. Potential types of Transmission Models implemented by the system of the present invention include but are not limited to: Hypothecation (Deposit), Settlement (Withdrawal), and Transfer (NostroVostro), Transmute (ledger change), and Transform. The model to be used is determined based on the desired transfer mode, bridge operator's ability to perform issue/burn operations, the availability of custody wallets, and other business requirements.

The Pricing Model defines the ratio of the number of destination ledger tokens sent for every source token received by the bridge. Pricing Models include but are not limited to a Link (1:1), a Peg (fixed ratio), Algorithmic Pricing (dependency injected plugin), or External Pricing (taken from a third party source such as an exchange). The Replenish Model defines the mechanism used to refill the outbound wallet when excessive unbalanced flow takes place and resources must be repositioned. Replenish Models include but are not limited to None, Manual, Transfer, and Exchange. Bridges have a Sequence (Series/Parallel) and Direction (Unidirectional/Bidirectional) indicating how they are operable to be executed.

In one embodiment, in the case of multi-ledger issuances, bridges implement cross-ledger transmutation (e.g., when the official record of ownership is on a separate ledger than the one being used for transfer, or the official record is the sum of ownership records on affected ledgers). Transmutation permits tokens to be issued on multiple ledgers and/or provides a means by which tokens issued on one ledger “flow” to another. The term “transmutation” as used herein refers to the creation of one unit of value corresponding with the destruction of another. In one embodiment, this is accomplished using a summing mechanism that exists on specific ledgers. As tokens move from ledger to ledger, the total number of tokens in circulation remains constant while the ownership record moves from ledger to ledger. This type of bridge couples a withdrawal and deposit function. By removing tokens from one ledger at the same time tokens are introduced into circulation in another, the total number of tokens on both ends of the transaction remains constant.

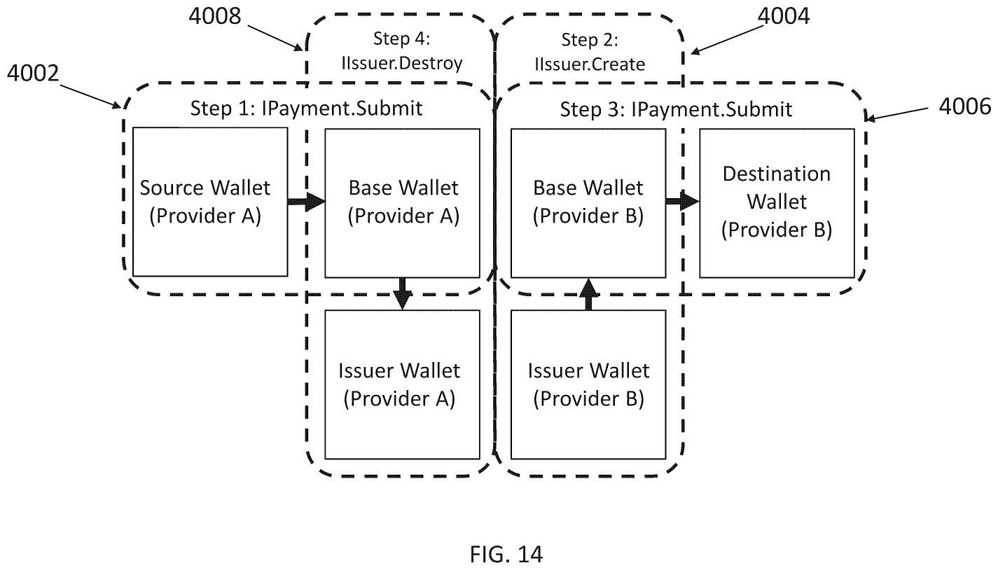

FIG. 14 is a schematic diagram of a chain of sub-transactions for accomplishing cross-ledger transmutation according to one embodiment of the present invention. At 4002, a value is sent from Source Wallet to Base Wallet using Provider A. This wallet is the Bridge Inbound Wallet. At 4004, tokens are issued from Provider B Issuer Wallet and sent to the Base Wallet on Provider B (Bridge Outbound Wallet based on Bridge attributes). At 4006, base wallet on Provider B sends value to Destination Wallet on Provider B. At 4008, on transaction completion, equivalent number of tokens are destroyed from Provider A Base Wallet. In one embodiment, the Chained Transfer Handler module 2004 includes a mechanism to detect and attribute transactions on the source and destination ledger, as well as a mechanism to create tokens on Provider B and burn (i.e., destroy) tokens from the Base Wallet on Provider A. In one embodiment, access to these authorities is indicated by bridge metadata. In one embodiment, the chain of sub-transactions for cross-ledger transmutation issues and burns tokens directly through the issuer wallet of the provider. The process of cross-ledger transmutation is disclosed in further detail in U.S. Pat. No. 11,038,718, incorporated herein by reference in its entirety.

In one embodiment, tokens exiting a ledger are sent to a source ledger base wallet of the source ledger from which funds are being transferred. An equivalent number of tokens are issued into circulation on the destination ledger from the wallet, account, or smart contract of an issuer to the outbound wallet on the destination ledger for delivery to the destination wallet. On successful delivery, the IIssuer.Destroy function is deployed on the source ledger to remove the tokens from circulation. In one embodiment, a cold wallet is operable to issue a number of tokens into circulation. The term “cold wallets” as used herein refers to a wallet used only to move tokens into and out of circulation on a distributed ledger. In one embodiment, transferring funds to a source ledger base wallet is an escrow transaction, where a hold is placed on the tokens without moving them.

It may be further desirable to convert the rights represented in tokens from one form to another (i.e., transform the rights). For example, it may be desirable to convert the loan rights represented in a convertible note into an equity position. In one embodiment, the present invention is operable to convert the rights represented in tokens from one form to another. This is accomplished, in one embodiment, through a fixed ratio transform (e.g. 1 share debt=1 share equity or 10 shares debt=1 share equity) using the transmutation function described herein. However, it may be useful to split rights in a common share into separate tokens that function differently with one representing voting rights and the other representing beneficial ownership of income or equity proceeds. In one embodiment, the present invention is configured to split rights in a common share into separate tokens that function differently. In this case, a custom transaction transform bridge is required. In one embodiment, for each type of token delivered to the inbound wallet, one type of share is produced and delivered to the destination. In one embodiment, for each type of token delivered to the inbound wallet, more than one type of share is produced and delivered to the destination. The basic sequence of a Transform transaction is the same as a Transmute transaction. In addition, the bridge must execute instructions to issue two or more types of instruments on the outbound transaction and must deliver each instrument to the desired destination wallet in a transform transaction. Further, the transform transaction is operable to be bilateral, allowing the reverse transaction to be conducted to combine rights into a new composite right (e.g. combine voting and beneficial ownership into a common share). In one embodiment, a transform bridge is an inter-ledger bridge. In one embodiment, a transform bridge is an intra-ledger bridge and therefore need not span multiple networks.

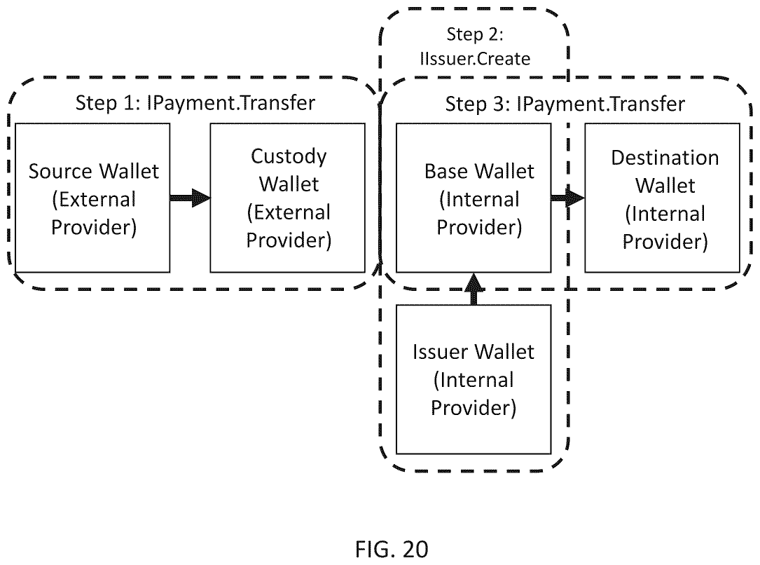

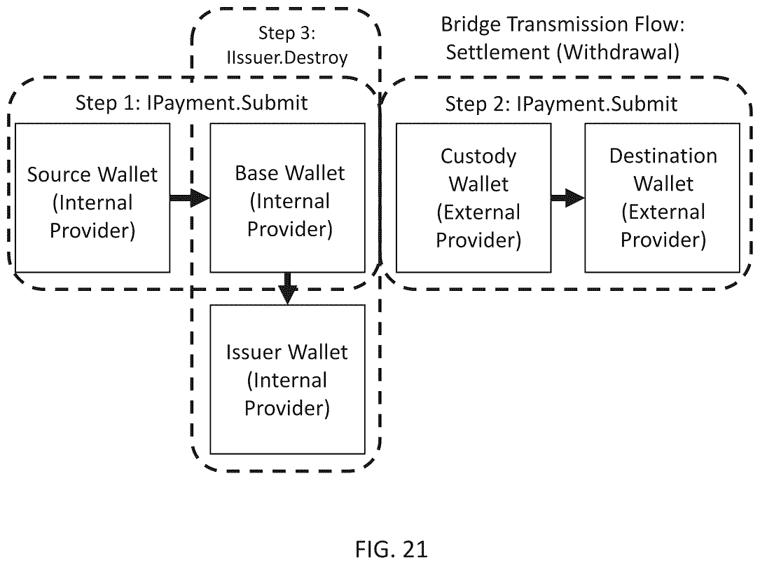

Exchange Bridges are a special kind of bridge where Price Discovery or Movement of funds involves an in-line or out-of-band (OOB) exchange. In this case, the amount of funds required for the source transaction depends on the current Total Volume Price of the equivalent trade on an exchange, where the Total Volume Price is an integral listed in the order book of the fund. Funds are then replenished in-line or out-of-band (OOB) in batch. In one embodiment, the inbound transfer is made to an exchange account for in-line transactions. In one embodiment, the Nostro account resides in the exchange. In one embodiment, the Nostro account uses the same provider as the Vostro account if exchange is not available via the Provider network but different currencies are supported. Other types of bridges are discussed below with respect to FIGS. 20 and 21.

The present invention includes Transaction Service Bus module 2002, which is an interface architecture that includes libraries that map and serve interfaces and data structures for DLT and traditional value transfer networks (e.g., Ethereum, PayPal, SWIFT) and value transfer models. As noted herein, the interface or interfaces required by a bridge are specified in the Bridge metadata. These interfaces expose the functions required to execute procedures used for transformation transactions. The wrappers of the Transaction Service Bus module 2002 implement a hub and spoke model for integration, through which dependent services, like Chained Transfer Handler module 2004, only need to integrate with the required interface once to orchestrate transactions across wrapped transfer networks.

In one embodiment, Transaction Service Bus module 2002 is implemented as an abstraction layer that provides a common interface for intra-ledger transactions. To participate in a cross-ledger transaction as either the source or destination ledger, a transaction provider is wrapped in a transaction wrapper. The wrapper is an executable (i.e., an executable file, code, or program) that integrates with the underlying transfer provider to execute transactions and react to activity in the network. The wrapper exposes common interfaces as defined in the finance ontology. These interfaces decouple business and transaction logic associated with chaining from the specific implementation details of a transaction provider and permit broad reuse of transaction patterns.

Transaction providers/networks vary broadly in implementation and integration patterns. For example, blockchain networks require a client that interacts with the nodes while many payment networks expose APIs. APIs are implemented using Representational State Transfer (REST), Simple Object Access Protocol (SOAP), Remote Procedural Call (RPC), and other patterns. Corporate accounting systems that run on relational databases have no specific pattern for integration. In one embodiment, the Transaction Service Bus module library is integrated with a transaction provider to provide a common pattern for interacting with the underlying service.

In one embodiment, Transaction Service Bus module libraries connecting to each provider are injected into the chained Transfer handler module 2004 using an abstract factory pattern. The abstract factory pattern is a known mechanism for encapsulating a group of individual factories that have a common theme without specifying their concrete classes. For example, client software is able to create a concrete implementation of the abstract factory and then use the generic interface of the factory to create the concrete objects that are part of the theme. Factory patterns separate the details of implementation of a set of objects from their general usage.

Interfaces that define the connections between the Transaction Service Bus and a service provider are found in the finance ontology. As a provider is initialized, it publishes its support for service interfaces and functions to a calling service of the mapping ontology. This enables the calling service to identify the services and methods that are supported by the transaction provider. Using this information, the calling service determines the eligibility of a provider to support a transaction type. Any provider participating in a chained transaction supports the IPaymentService abstraction. A short list of frequently used services from the Finance Ontology are described below.
IPaymentService: executes all transfers of value. Functions include estimating costs for a transaction, executing the payment, validating its completion, and obtaining a list of payments from the source
IWalletReaderService: identifies account balances (the amount of value available at a particular wallet address) and is used to obtain details about the wallet (e.g., supported currencies, date created)
IWalletValidatorService: determines if a wallet is eligible for transactions, including ownership by the entity claiming it.
The IPayment service and IIssuer service are layered over any payment system and execute transfers via that provider. Example pseudo code and related data structures for the interfaces are found immediately below.

```
public interface IIssuerService
{
  /// <summary>
  /// Issues an amount of new tokens to a designated wallet.
  /// </summary>
  Task<ITransaction> IssueAsync (IWalletIssuerActive wallet, IAmount
amount);
  /// <summary>
  /// Destroys an amount of new tokens from a designated wallet.
  /// </summary>
  Task<ITransaction> DestroyAsync (IWalletIssuerActive wallet, IAmount
amount);
  /// <summary>
  /// Freezes a token.
  /// </summary>
  Task<ITransaction> FreezeAsync (IWalletIssuerActive wallet, IToken
token);
  /// <summary>
  /// Retrieves token details.
  /// </summary>
  Task<ITokenDetail> GetTokenDetails (IWalletActive wallet, IToken token);
}
public interface IPaymentService
{
  /// <summary>
  /// Calculates available routes to deliver amount to designated wallet.
  /// </summary>
Task<List<IPaymentOption>> PrepareAsync (IWalletActive wallet, IWallet
destinationwallet, IAmount amount, IFilter filter = null);
  /// <summary>
  /// Executes payment using IPaymentOption path using authority of
active wallet
  /// </summary>
Task<ITransaction> SubmitAsync (IWalletActive wallet, IPaymentOption payment);
  /// <summary>
  /// Cancels ongoing payment transaction using authority of active
wallet
  /// </summary>
  /// <remarks>
  /// Not all providers will support this action
  /// </remarks>
  Task<ITransaction> CancelAsync (IWalletActive wallet, string uuid);
  Event Complete (ITransaction trans);
}
```

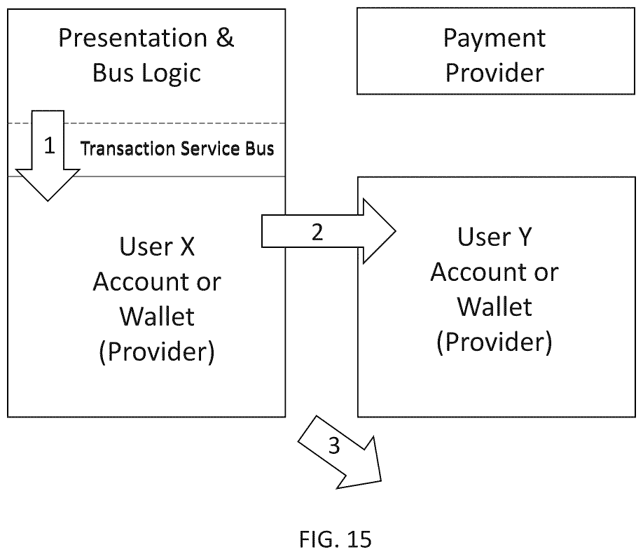

To understand the application of the Transaction Service Bus module 2002 to complex cross-ledger transfers, it is helpful to first explore how simple payment systems work in the context of the Transaction Service Bus module 2002. FIG. 15 is a schematic diagram of a simple cross-ledger transfer using the Transaction Service Bus according to one embodiment of the present invention. User X (i.e., the sender) would like to send value to User Y (i.e., the recipient) on the same ledger (for example, a PayPal transfer). First, the sender will propose a transfer by specifying the function (IPaymentService.Prepare) the recipient (by address) and the currency/amount to be sent (usually denoted in the amount the recipient expects to receive). The system will check the validity of the proposed payment and will respond with one or more options regarding the amount which must be sent to achieve the desired delivery. In one embodiment, the validity of the proposed payment depends on fees/gas assessment, policy compliance, the validity of the recipient, and/or sufficient funds to execute the payment. If the transfer terms are acceptable for an option, the sender will initiate the transfer at Step 1 by executing a PaymentService. Submit smart contract or series of smart contracts with a signed transaction (e.g., login). The system validates the transfer at Step 2, where the objects sends a signal that the IPaymentService smart contract or series of contracts has been initiated (e.g., IPaymentServiceinitiated) and moves value by adjusting account balances (i.e., reducing source and increasing destination balances. The Transaction Service Bus also extracts a transfer fee at Step 3. One of ordinary skill in the art will appreciate that the extraction of a transfer fee means the value transferred from the wallet of a first user does not match the value added to the wallet of a second user, as transaction fees are extracted from the value transferred. On completion of the transaction, a signal is sent to the user account associated with an initiating wallet and/or to an administrative account associated with the one or more providers to verify the transfer has been completed (e.g., event IPaymentService.Completed). The new balances are reflected in the source and destination wallets.

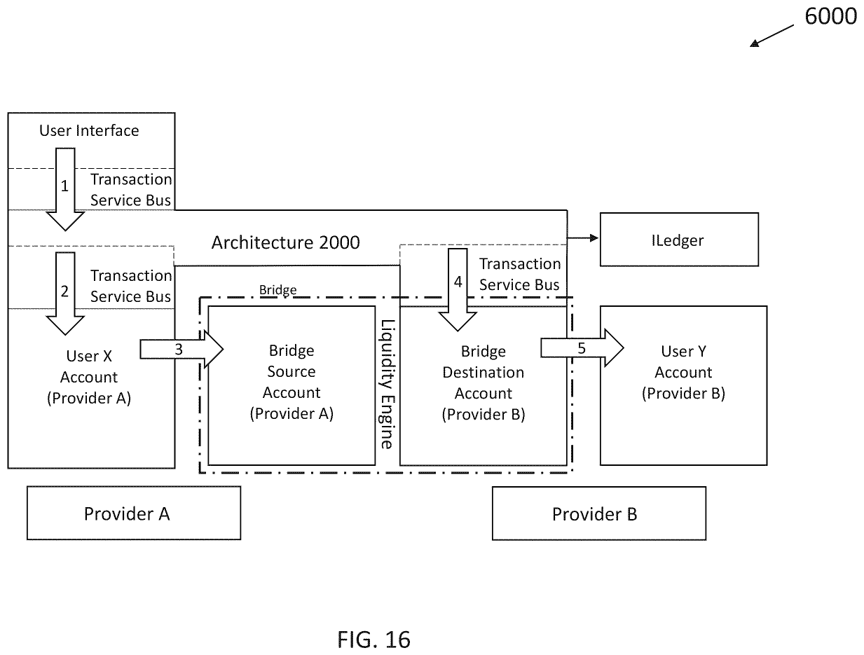

In one embodiment of the present invention, a chained transaction is initiated using these same functions in combination with novel elements of the disclosed implementations. FIG. 16 is a schematic diagram of a chained transaction (including multiple sub-transactions to be accomplished in a specified order) according to one embodiment of the present invention. In one embodiment, a chained transaction (including multiple sub-transactions to be accomplished in a specified order) uses the architecture 2000 of FIG. 12 to accomplish the transaction. Individual ledger transfers in the chain use methods consistent with a simple payment with coordinating activities managed by Chained Transfer Handler module 2004 of FIG. 12.

As shown in FIG. 16, the sender proposes a transfer by deploying an IPaymentService.Prepare smart contract using the interface of the Transaction Service Bus of Architecture 2000. The Architecture 2000 is depicted and described in detail herein with respect to FIG. 12. In the example 6000 of FIG. 16, user X desires to transfer value from an account on Provider A to user Y′s Account on Provider B. At step 1, the Route Planning Service module looks for available paths by traversing the node graph (such as graph 3000 of FIG. 13A) to identify Bridges that provide a viable path between the source and destination networks. This determination is made based on the bridge metadata. Further, the Route Planning Service module obtains fees for each leg of the transfer.

Various techniques, including but not limited to artificial intelligence, are used to narrow the list of available options or to prioritize the possible paths. One of ordinary skill in the art will appreciate that there may be no paths available to connect two node graphs via bridge nodes in certain instances. In other instances, there may be many paths available for facilitate the transfer. In one embodiment, the Route Planning Service module identifies no available path for connecting the graphs. In one embodiment, the Route Planning Service module identifies a single available path for connecting the graphs. In one embodiment, the Route Planning Service module identifies multiple available paths for connecting the graphs. In one embodiment, the paths include all necessary interfaces of the Transaction Service Bus and business logic derived from the bridge metadata.

In one embodiment, the sender selects the desired path and initiates the desired transfer (IPaymentService.Submit). In one embodiment, an automated algorithm selects the desired path and initiates the desired transfer. In one embodiment, an automated algorithm selects the desired path and the sender initiates the desired transfer. In one embodiment, the Chained Transfer Handler module of Architecture 2000 writes the transaction to a ledger of Independent Transaction Ledger of Architecture 2000 to ensure auditability and recoverability in the result of system failure. In one embodiment, this record is obfuscated using Zero Knowledge Proof techniques to provide immutability without compromising transaction privacy. The Chained Transfer Handler module of Architecture 2000 also publishes an event (e.g., IPaymentService.Initiated) to signal the transfer. At step 2, the Chained Transfer Handler module conveys the signing authority of a user account to execute a child transfer on the source ledger. In one embodiment, the IPaymentService. Submit function is used to convey the signing authority. At step 3, the transfer is initiated using the planned route, which includes traversal of dissimilar networks via one or more Bridges. On initiation of the sub transfer, an event (e.g., IPaymentService.Initiated) is emitted as the transfer is linked to the parent transaction in the external transaction ledger. On completion of the transfer to the source bridge account, an event (e.g., IPaymentService.Completed) is emitted throughout the architecture to mark the completion of the transfer. In one embodiment, the receipt of a transmitted and/or emitted event signals the handler to initiate the next part of the transaction. A transfer is then initiated via the bridge using the IBridgeService.Submit function. On completion of the bridge transfer, the event ifiridgeService.Completed is emitted. Sub sequentially in near-real-time, the Chained Transfer Handler module initiates the transfer on the outbound ledger using IPaymentService.Submit at Step 4 to deliver to the value to the destination account or another leg in the chain depending on the route. An event is emitted upon the initiation of this transaction. In one embodiment, the emitted event is IPaymentService.Initiated. This transaction is linked to the parent transaction in the external transaction ledger of Independent Transaction Ledger module 2012. The value is delivered to the destination account and an event IPaymentService.Completed is emitted at Step 5. As the last step in the chained sequence, an event is thrown signaling the completion of all transactions. All sub-transactions are recorded to the ledger of Independent Transaction ledger 2012. One of ordinary skill in the art will appreciate that the events, smart contracts, and smart contract series disclosed herein (e.g., IPaymentService.Completed) do not serve to limit the application to only those events, smart contracts, and smart contract series specifically disclosed herein.

In one embodiment, a chained transfer is initiated from an external system, skipping Step 1 and Step 2 of the example 6000 of FIG. 16. These steps are operable to be circumvented by delivering value directly to a bridge source account with instructions for delivery to the destination. On receipt, the bridge account issues a transfer upon determination of an event (e.g., IPaymentService.Completed). The Chained Transfer Handler module reads the event and determines if there is a legitimate payment route. If a route is available, the chain is initiated with the funds held in escrow at the bridge source account. In one embodiment, if the transfer succeeds, these funds are released. In one embodiment, if the transfer fails, the funds are returned to the source. In one embodiment, if the source ledger supports smart contracts, the initiating transaction leverages on-chain escrow methods to ensure atomicity of the transaction.

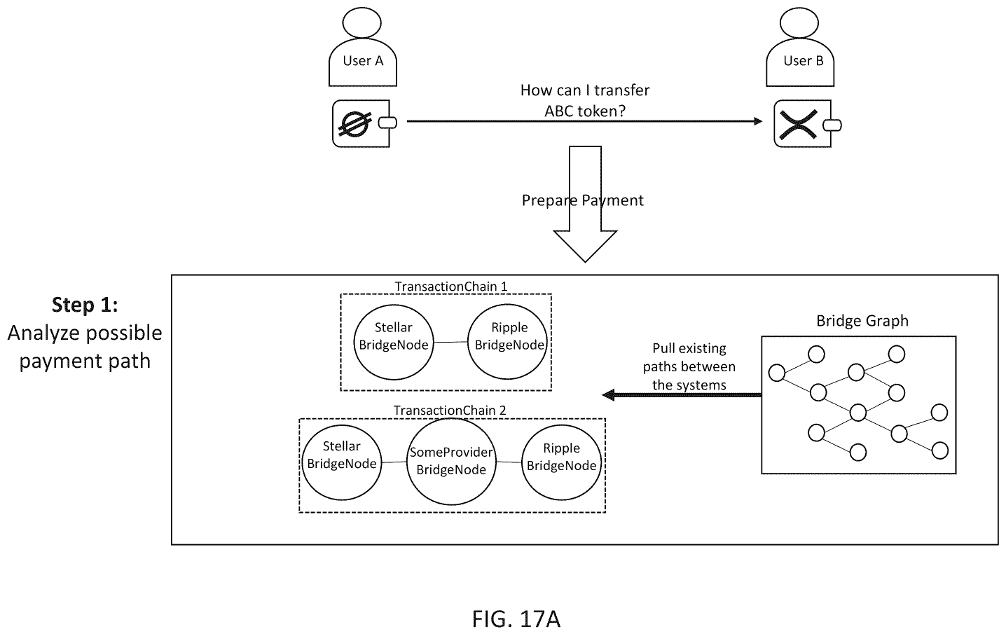

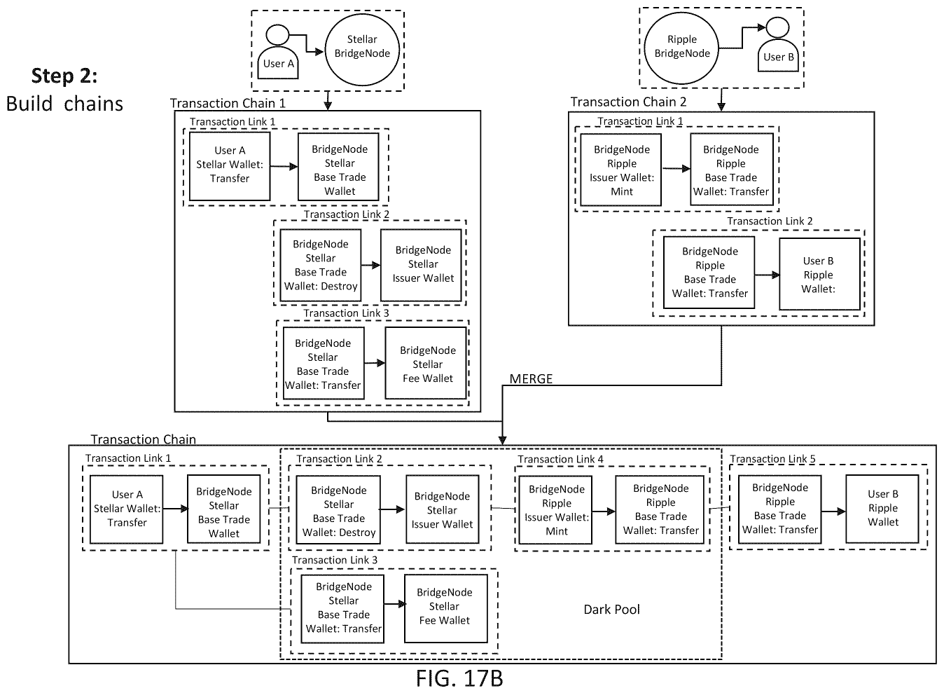

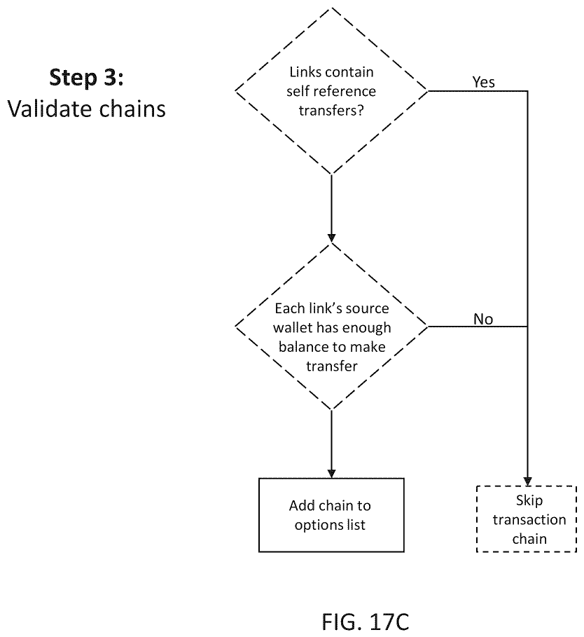

FIGS. 17A-17C illustrate the steps of a transaction chain building process according to one embodiment of the present invention. In one embodiment, the illustrated process is accomplished by the architecture 2000 of FIG. 12 and modules depicted therein. A Route Planning Service module of the architecture is used to identify optimal transmission paths across network nodes based on the transaction specified in a transaction data structure. In one embodiment, the Route Planning Service module of the architecture is used in combination with transaction wrappers. In this example, the specified transaction is “transfer ABC token from User A node on Stellar DLT Systems to User B node on Ripple DLT System”. In one embodiment, a set of all available options, such as price, and expected delivery time are specified by the transaction data structure. At Step 1, as depicted in FIG. 17A, the Route Planning Service module evaluates all possible routes and available bridges to execute the transfer by traversing the graph of all nodes and bridges. Possible transaction paths are analyzed by reading bridge metadata for the relevant networks. Further, the Route Planning Service module builds a bridge graph that represents all connections between the source ledger (e.g., Steller) and the destination ledger (e.g., Ripple) providers and tokens. In one embodiment, the bridge graph includes all relevant bridge metadata of the Bridges for the identified connections.

In one embodiment, the Route Planning Service module applies a Breadth First Search (BFS) algorithm to find all paths and return a list of BridgeNodeChains (i.e., a list of possible paths for accomplishing the transaction). One of ordinary skill in the art will appreciate that a Breadth First Search (BFS) algorithm is a known graph traversal algorithm that traverses a graph layer-wise from a selected node. It is used herein to traverse and identify possible paths from the node of a source ledger to the node of a destination ledger. In this example, two possible paths are identified: TransactionChain 1 and TransactionChain 2.

At Step 2, as depicted in FIG. 17B, the Route Planning Service module constructs the ultimate transaction path, based on the list of possible paths as well as the transactional requirements and conditions. In one example of a transaction requirement, where the chain must deliver 1 ABC token to destination wallet and the sum of associated transmission fees equal 0.1 ABC token, the Source must transfer 1.1 ABC tokens. In one embodiment, the ultimate transaction path is constructed to consider various preferences and attributes, such as transaction fees, time for transaction confirmation, and the like.

In one embodiment, the ability to move value from one network or ledger to another involves many potential paths and mechanisms. In one embodiment, the ability to move value from one network or ledger to another has no viable path at all. When a user requests payment delivery, a set of all available options, their price, and expected delivery time is generated in substantially real time. At Step 2 of FIG. 17B, the Route Planning Service module gathers all possible routes by evaluating all available bridges that provide a path from a source node to a destination node.

When all abstract paths have been calculated, the Route Planning Service 2006 module builds one or more transaction chains based on the paths. In one embodiment, chains are built beginning at the destination (i.e., a node, graph, or wallet of the destination network). When starting from destination and connection to the source, the Route Planning Service module begins with destination conditions as the fixed point. In one embodiment, chains are built beginning at the source (i.e., a node, graph, or wallet of the source network). When starting with the source node as the fixed parameter, the Route Planning Service module determines the value the destination node will receive if the transfer begins with 1 ABC. The Route Planning Service module 2006 starts building transaction links from the source and accumulates all fees and exchanges through the path. For example, if all fees equal 0.1 ABC token, the receiver will get 0.9 ABC token in the end. Route Planning Service module 2006 then builds an abstract path to the real chain based on, for example, the following rules:

| Case | Description | Transaction Chain |
|---|---|---|
| Bridge node -> | based on Bridge node configuration, the builder may | Link 1: Bridge Issuer wallet → |
| Bridge node | return either zero link or several. | Bridge Base Trade |
| | If bridge node currencies are different, and bridge node | wallet (hidden for user) |
| | contains issuer wallet, transaction builder adds 2 links: | Link 2: Bridge Base Trade |
| | issue token 1 from issuer to base trade, exchange | wallet → Bridge Issuer |
| | token, destroy token 2 to issuer. | wallet (hidden for user) |
| Bridge node -> | based on Bridge node configuration, the builder may | Link 1: Bridge Base Trade |
| Destination | return either one link or several. | wallet → Destination wallet |
| wallet | The first link is a transfer from Bridge Base trade | Link 2: Bridge Issuer wallet → |
| | wallet to destination wallet. | Bridge Base Trade |
| | If Bridge node contains Issuer wallet, transaction chain | wallet (hidden for user) |
| | builder adds a link issue tokens. This link goes as a | Link3: Bridge Base Trade |
| | Dark Pool and hidden for user | wallet → Bridge Fee wallet |
| | If Bridge node contains Fee account, transaction chain | (hidden for user) |
| | builder adds a link with transfer fee from bridge base | |
| | trade account to the fee account. This link goes as a | |
| | Dark Pool and hidden for user | |
| Source wallet -> | based on Bridge node configuration, the builder may | Link 1: Source wallet → |
| Bridge node | return either one link or several. | Bridge Base Trade wallet |
| | The first link is a transfer from user to Bridge Base | Link2: Bridge Base Trade |
| | trade wallet. | wallet → Bridge Issuer |
| | If Bridge node contains Issuer wallet, transaction chain | wallet (hidden for user) |
| | builder adds a link to the chain to destroy tokens. This | Link3: Bridge Base Trade |
| | link goes as a Dark Pool and hidden for user | wallet → Bridge Fee wallet |
| | If Bridge node contains Fee account, transaction chain | (hidden for user) |
| | builder adds a link with transfer fee from base trade | |
| | account to the fee account. This link goes as a Dark | |
| | Pool and hidden for user | |
| Source wallet -> | this is a case (empty bridge node chain) when the | Source wallet → Destination |
| Destination | transfer goes within one ledger, so this transfer doesn’t | wallet |
| wallet | require bridges. Adds single link in a chain. | |

As used herein, “builder” refers to the Route Planning Service module or a subcomponent thereof responsible for construction of transaction paths from one node to another node. Upon construction of the transaction chains, the Route Planning Service module then selects all path chains and merges them into the single final transaction chain by removing duplicate links, as shown in FIG. 17B, wherein the Transaction Chain includes TransactionLink 1, TransactionLink 2, TransactionLink 3, TransactionLink 4, and TransactionLink 5. At Step 3, depicted in FIG. 17C, a Transaction Validation Service validation module validates that the transaction paths are viable (i.e., able to be executed). In one embodiment, a transaction path is validated as viable by checking whether each link source wallet in a path has sufficient balance to submit the transaction. In one embodiment, a transaction path is validated as viable by checking for self-referencing chains (i.e., a chain wherein the same node occurs more than once). Each viable transaction chain will have an estimated delivery time. In one embodiment, each viable transaction chain involves fees and/or exchanges. In one embodiment, the price of a proposed transfer and the delivery time are calculated. In one embodiment, the price of a proposed transfer and the delivery time are displayed to a user device implementing the architecture 2000 of FIG. 12 (which includes the Route Planning Service as described with respect to FIGS. 17A-17C) prior to authorization of a transfer action. In one embodiment, a Policy Engine verifies regulatory compliance at each transfer node. An example of a policy engine is found in U.S. patent application Ser. No. 16/143,058, incorporated herein by reference in its entirety.

During a transfer in the chain of sub-transactions, it is possible that a network failure occurs, or an allowed transfer is cancelled prior to completion. In this case, the use of a rollback is advantageous. A rollback allows the transaction to be saved at a point (i.e., the start point or an intermediate save point). In the case of network failure or cancellation, the transaction is saved at the save point, even if data is lost from the save point to the location of the data at the time of the failure or cancellation. In cases where intermediate fees are charged or exchanges are performed between the save point and the location of the data at the time of the failure or cancellation, it may not be possible to reverse the transaction without a loss in value. For this reason, a user device implementing the architecture 2000 of FIG. 12 is operable to execute a command to restart the transfer from the source, rollback the transfer to a save point in the chain, or abandon the transaction by claiming the value in its current state.

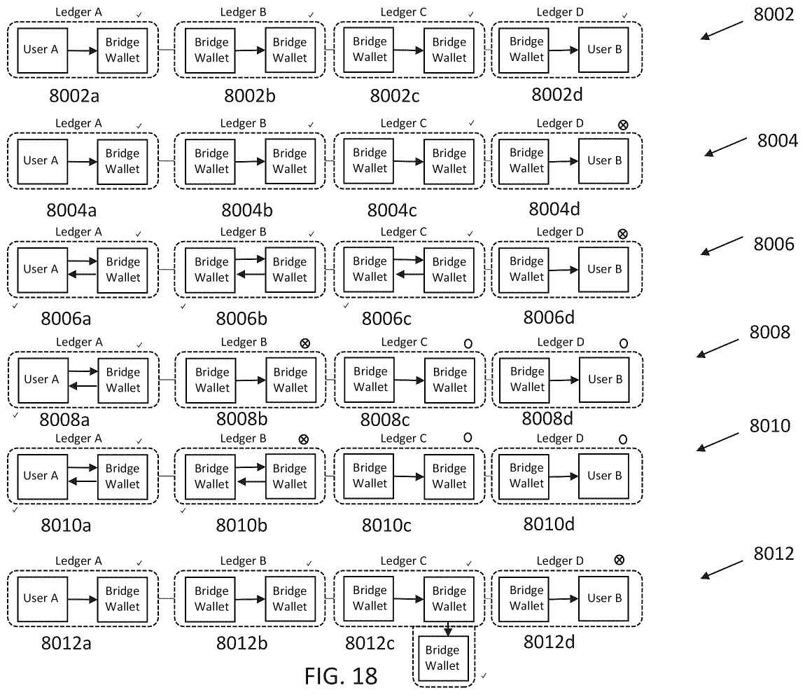

FIG. 18 is a schematic diagram of several transaction chains and sub-transactions therein according to one embodiment of the present invention. Transaction chain 8002 illustrates a chained transaction including sub-transactions 8002a, 8002b, 8002c, and 8002d, in a desired transfer transaction. Transaction chain 8004 includes sub-transactions 8004a, 8004b, 8004c, and 8004d. Transaction chain 8006 includes sub-transactions 8006a, 8006b, 8006c, and 8006d. Transaction chain 8008 includes sub-transactions 8008a, 8008b, 8008c, and 8008d. Transaction chain 8010 includes sub-transactions 8010a, 8010b, 8010c, and 8010d. Transaction chain 8012 includes sub-transactions 8012a, 8012b, 8012c, and 8012d.

All four sub-transactions in Transaction chain 8002 are successful, resulting in a transfer between User A and User B. However, cancellation or failure of any one of the subs-transactions of the transaction chain results in an unsuccessful transfer between User A and User B, as in the case of transaction chain 8004, wherein sub-transaction 8004d has failed. In one embodiment, the system of the present invention automatically conducts a restart to deliver the value in the event of a transaction failure or cancellation. In one embodiment, the chain automatically initiates a rollback transaction in the event of a transaction failure or cancellation. In one embodiment, the system halts and await user input in the event of a transaction failure or cancellation. Determination of automatic delivery, awaiting user input, or execution of a rollback depends at least in part on the configuration of the chain. Rollback transactions are only possible if each bridge used in a route are two-way bridges capable of supporting transactions in both directions. In one embodiment, all bridges formed by the Route Planning Service are bilateral bridges.

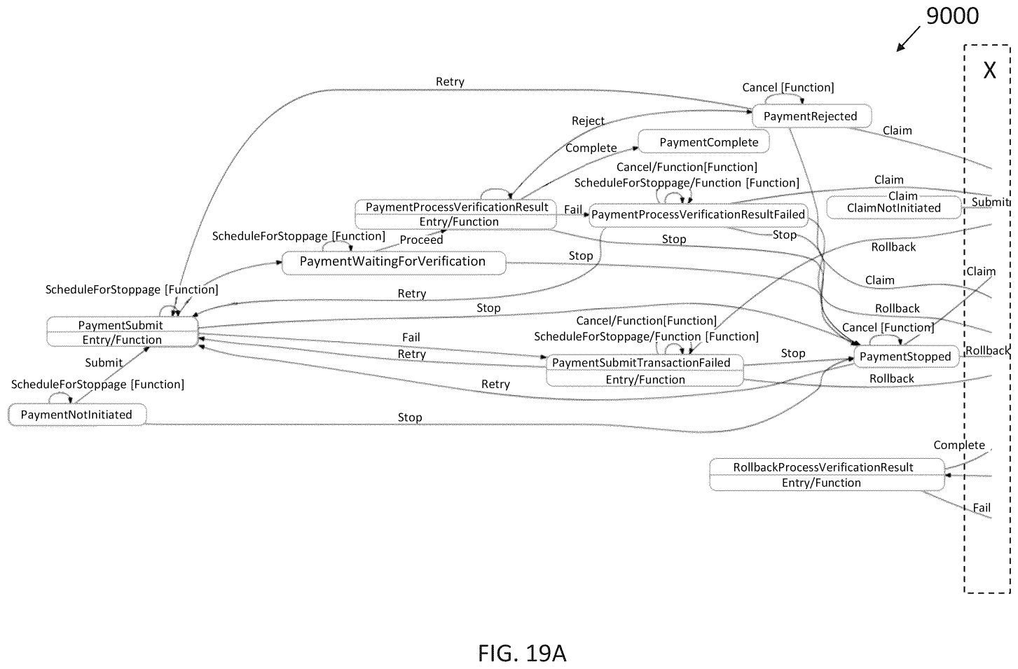

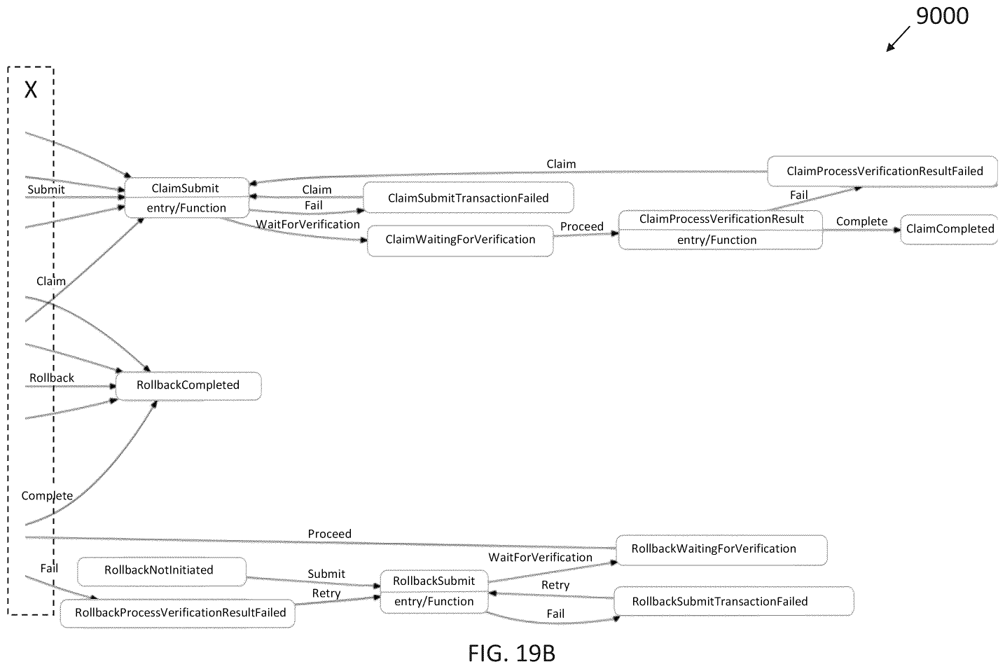

Transaction chain 8006 illustrates a rollback transaction upon failure of sub-transaction 8006d. As a result of the failure, sub-transactions 8006a, 8006b, and 8006c are reversed by accomplishing a reverse sub-transaction for each of these sub-transactions. As previously mentioned, rollback transactions are only possible through the use of bilateral bridges. Such bilateral bridges allow the transaction to occur in the reverse direct in addition to the forward direct, thus allowing the reversal of sub-transactions 8006a, 8006b, and 8006c. Transaction chain 8008 and transaction chain 8010 depict chains wherein a transaction is cancelled while the transaction is taking place (i.e., “en route”). In transaction chain 8008, sub-transaction 8008b has been cancelled prior to execution and thus sub-transaction 8008a has been reversed. Alternatively, at 8010, sub-transaction 8010b has been cancelled after execution of the sub-transaction, and sub-transactions 8010a and 8010b are both reversed. Alternatively, if a user has the means to receive value via an intermediate ledger, the value may be claimed directly from a halted transaction as shown at 8012. In one embodiment, the wallet associated with the transaction initiator reclaims the value directly from a halted transaction. In one embodiment, the wallet associated with the transaction recipient claims the value directly from a halted transaction. All sub-transactions, including reversal transactions, are recorded on independent transaction ledger module 2012. FIGS. 19A and B, in combination, illustrate an example of state diagram 9000 for chained transfers.

Each viable route will have an estimated delivery time. In one embodiment, each viable route involves fees and/or exchanges. The price of a proposed transfer is calculated and transmitted to a device associated with the source of the transfer to enable transfer initiation action. Chained Transfer Handler module 2004 orchestrates cross-ledger payments by providing ledger interoperability, route planning, price and fee discovery, transaction management, transaction state, and logging. Additionally, the Chained Transfer Handler module 2004 ensures high reliability end-to-end transfer across networks by: (1) publishing the proposed end-to-end transaction and all sub-transactions to a ledger (such as Independent Transaction Ledger 2012), with zero knowledge proofs for traceability and reliability; (2) sequencing transfers using an interoperability framework that leverages transfer capabilities in each network the transaction traverses; and (3) ensuring each transaction is executed successfully to deliver value or rolled back to preserve value. Chained Transfer Handler module 2004 is designed to provide and/or manage Atomicity, Consistency, Isolation, and Durability (ACID) properties. One of ordinary skill in the art will appreciate that ACID properties used as guiding principles in computer software ensure reliability of transactions.

Isolation, the third ACID property, is provided via the common IPaymentService plugin which isolates each individual ledger transaction as a component in a larger flow. This plugin framework provides a common model for processing transactions across dissimilar ledgers. Transaction management provides durability, the fourth ACID property, of chained payments. Chained Transfer Handler module 2004 manages each step of a complex payment sequence to ensure it is executed, even in the event of a power outage or payment network failure. In one embodiment, the Chained Transfer Handler module handles transactions in parallel. In one embodiment, the Chained Transfer Handler module handles transactions in series. Additionally, the Chained Transfer Handler module executes payment and bridging transactions.

In one embodiment, the present invention provides plugins for atomicity. However, due to irreversibility of certain transactions (e.g., transactions requiring fees), long delivery timeframes, and frequently changing market conditions that characterize certain chained payments, atomicity, the first ACID quality, cannot be guaranteed. To provide for slippage (i.e., changes in exchange rates or fees from the initiation of a transaction until its completion), the Chained Transfer Handler module 2004 freezes a transaction in the event of a significant change to receive authorization from a user device to allow the transaction to continue. In one embodiment, the user device communicates an order to rollback the transaction. In one embodiment, the user device communicates an order to claim the value in its existing form. . In one embodiment, the user device communicates an order to restart the transaction to proceed to completion. In one embodiment, the user device receives authorization accepting a set of changed terms associated with the transaction.

Since chained transactions may involve more than one ledger, none of the individual ledgers involved will contain end-to-end traceability of the transaction. To ensure consistency, the second ACID property, an overarching ledger is maintained by Independent Transaction Ledger module 2012 of the architecture (depicted in FIG. 12) to track the overall transaction as well as links to each of the sub-transactions. Chained transfers may occur in series or parallel depending on bridge configuration. Parallel payments are faster in comparison to in series payment. However, parallel mayments may require rollback locks and hedging due to risks in time latency of inbound deliveries. Series deliveries are slower than parallel payment, and require significant use of slippage management and locking of outbound funds to support delays in inbound transactions.

In one embodiment, the verification of the completion of the initiating transaction is the inbound and the initiation of the chained transaction is the outbound variable. When operating in series, bridges await verification of the completion of the initiating transaction (i.e., emission of the event IPayment.Complete) prior to initiating the chained transaction. When operating in parallel, outbound transactions initiate immediately after verification of initiation (i.e., emission of the event IPayment.Initiated) of an inbound transaction. For parallel operations, there is a delivery risk associated with the possibility that the inbound and all intermediate transactions are cancelled or rolled back. In one embodiment, a bridge operator only allows parallel operations if the inbound network does not allow cancellation or rollback. In one embodiment, the bridge operator requires collateral or charges a large fee to compensate for the delivery risk. For series operations, the initiator may experience slippage risk (i.e., a change in price for delivery from the initial terms presented on the initiation of the transaction). For example, downstream networks fees or exchange rates may have changed from the time the transaction is initiated. In one embodiment, the bridge operator provides a price guarantee, ensure that no slippage occurs. In one embodiment, the bridge operator builds in a fee to compensate for market changes or hedging strategies.

In addition to providing a path for transactions across dissimilar network, bridges have various logical functions as described herein. One example of a bridging function is a deposit function. It involves a Peg (i.e., a fixed ratio) linking deposited funds to an equivalent amount of tokens which are delivered to the user's internal account. In one embodiment, the tokens which are delivered to the internal account of the user are hypothecated assets. In one embodiment, the tokens which are delivered to the internal account of the user are IOUs (i.e., digital versions of a value amount). In one embodiment, the IOUs are transferred to other users or traded for assets via centralized or decentralized exchanges. These tokens are be redeemed for the value in the counterparty account by using the opposite flow (i.e., a withdrawal).

In one embodiment, the present invention includes a function to verify the counterparty account balances exactly match the total number of internal tokens in circulation. In one embodiment, both balances (the balance of the counterparty account and the total number of internal tokens in circulation) are published to users. One of ordinary skill in the art will appreciate that some networks support token creation and destruction, whereas others require movement in and out circulation via cold wallets. Thus, the present invention is advantageously operable to facilitate movement of value between systems by creating tokens, destroying tokens, moving tokens into circulation, and moving tokens out of circulation. This functionality is further depicted by FIG. 20.

FIG. 20 is a schematic diagram of a hypothecation transfer and associated bridge operations according to one embodiment of the present invention. At Step 1, value is sent from source wallet of an external provider to a custody wallet using an external provider (e.g., OOB, Cascade, PayPal, Ethereum). This is the inbound of the bridge, initiated by execution of the IPayment.Transfer function. At Step 2, an equivalent number of IOUs (i.e., a digital version of the deposited amount) are issued from the issuer wallet of an internal provider using an IIssuer.Create function. The IOUs are sent to the base wallet of an internal provider. At Step 3, the base wallet of the internal provider (i.e., the outbound of the bridge) enacts the IPayment.Transfer function to send value to the destination wallet of the internal provider. This pattern requires the Chained Transfer Handler module 2004 to have the means to detect and attribute transactions on the source ledger and execute transactions from the issuer wallet and base wallet. In one embodiment, access to this authority is granted at upon creation of the bridge. In one embodiment, the present invention facilitates direct transfer of value from the issuer wallet to the destination wallet.

FIG. 21 is a schematic diagram of a settlement transfer and associated bridge operations according to one embodiment of the present invention. Settlement is the reverse of a hypothecation transfer. When the framework receives an input to remove value from a ledger and return the value to its original form, a transfer is initiated that traverses a settlement bridge. At Step 1, value is sent from the source wallet of an internal provider to a base wallet using an external provider (e.g., OOB, Cascade, PayPal). This is the inbound received by the bridge. At Step 2, the custody wallet of the external provider enacts IGateway Payment function to send value to the destination wallet. This is the outbound generated by the bridge. At Step 3, in response to completion of the previous step, an equivalent number of IOUs are destroyed (i.e., transferred to the issuer wallet of the internal provider) from the base wallet by execution of the IIssuer.Destroy function. This pattern requires the Chained Transfer Handler module 2004 to have the means to detect and attribute transactions on the source ledger, execute transactions from the custody wallet of an external provider, and destroy tokens from the base wallet of an internal provider. In one embodiment, access to this authority is granted at upon creation of the bridge. In one embodiment, the present invention facilitates direct transfer from the source wallet to the issuer wallet, given the authority exists to reverse the destruction of the tokens if the transaction fails.

Markets are said to be illiquid if a request to exchange value for another form of value cannot be met in a short period of time without significantly changing the price ratio of one asset to the other asset. Transaction efficiency is one component used to determine illiquidity of an asset. In one embodiment, transaction efficiency of the technical platforms and data structures disclosed herein is determined by the change in price resulting from the transaction. In one embodiment, transaction efficiency of the technical platforms and data structures disclosed herein is determined by the length of time required to complete the transaction. In one embodiment, transaction efficiency of the technical platforms and data structures disclosed herein is determined by the total size of a transaction that is supported by the technical platforms and data structures. In one embodiment, transaction efficiency is displayed on a computer platform of the present invention. In one embodiment, transaction efficiency data is viewable in real.

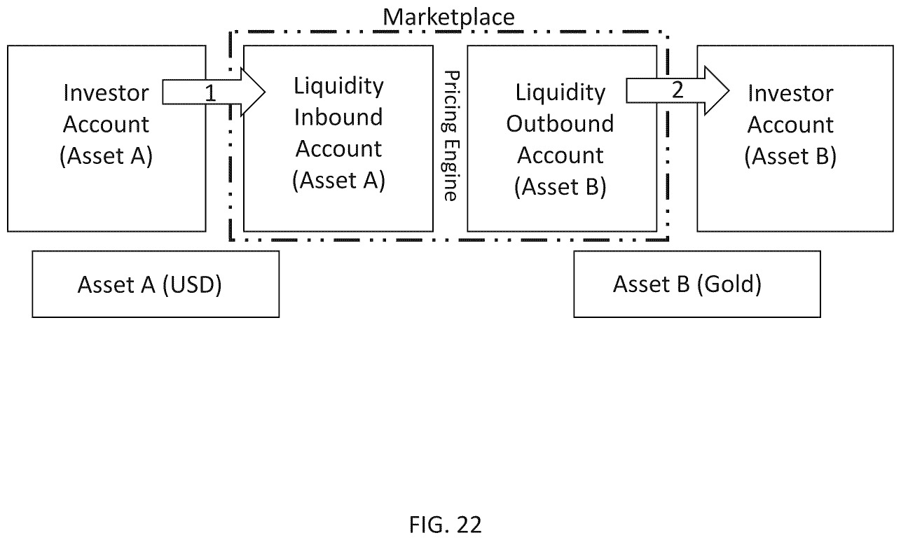

FIG. 22 is a schematic illustration of an asset exchange exemplifying liquidity within an asset pool according to one embodiment of the present invention. A party desires to purchase gold (Asset B) for USD (Asset A) from a marketplace, exchange, or pool token according to the present invention. The pool accepts USD in exchange for gold at a price set by a pricing engine. A steady inflow of gold purchases using this process results in the growth of available USD and a decrease in the pool of available gold. As the outbound account supply of available gold decreases, the liquidity of the outbound account (i.e., the ability to support a large order at any price) decreases. If demand for gold continues to increase and the price of the exchange does not change, the supply of gold in the destination pool will eventually run out, resulting in a total loss of liquidity. The OOB transfer model is operable to replenish the amount of Asset B in the pool, thereby rebalancing the asset pool in order to meet the demand presented by parties desiring asset conversion.

Several factors are required to sustain the liquidity of an asset in a marketplace: Availability of investors with Asset A with demand for Asset B; an adequate supply of Asset B in the marketplace to meet demand; effective pricing consistent with the intrinsic value of Asset B in order to match supply with demand; and effective and timely ownership transfer so that Asset B is available unencumbered for use. More directly, a liquid market will price efficiently to match supply/demand, and settle quickly to permit use of value.

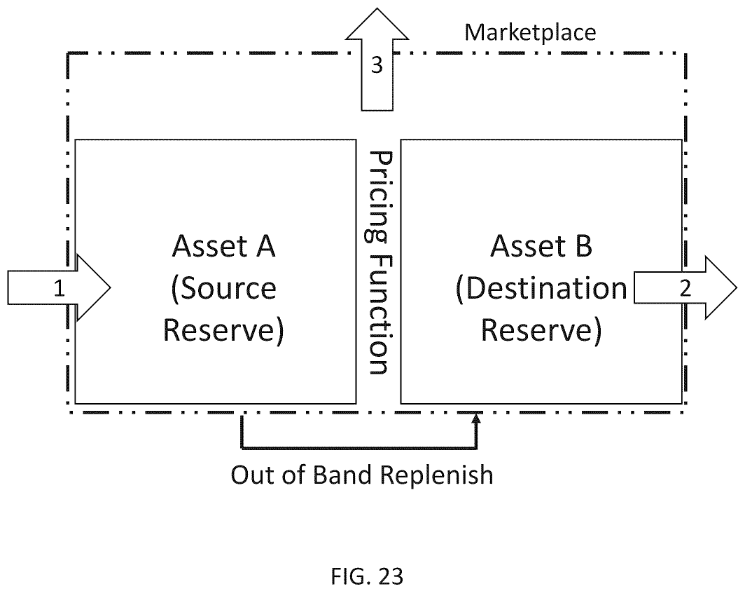

FIG. 23 is a schematic diagram of the basic elements of a system supporting liquidity between a pair of assets according to one embodiment of the present invention. The system supports a means to request an amount of Asset B in exchange for Asset A at a specified price (i.e., a ratio of units of Asset A/per unit of Asset B); includes the means to deliver Asset B on request (usually a pool of assets); and accepts delivery of Asset A in exchange for Asset B. In one embodiment, the system charges a fee for the service and requires a mechanism to replenish the available pool of Asset B using the accumulation of Asset A through use of the liquidity mechanism. The central benefit of the liquidity function is the translation of Asset A to Asset B. The liquidity function is the mechanism to transform or exchange the asset including the pricing function, fees, and delivery mechanism. The source and destination reserve are operable to be different currencies, counterparties, networks, asset types, jurisdictions, etc.

However, if asset value always flows in one direction and there is no balance between the flows, sustained operations will require an out-of-band replenishment model to sustain the flow. The security and cost of this out-of-band process will affect the profitability of the model. Balanced flows, that is value flows where the value moving from source to destination is matched with an equivalent flow in the opposite direction, are most desirable as they avoid the need for out-of-band replenishment. The system is in local equilibrium when the ration of the reserves for both assets match the desired target. Thus, there is a need for a function of the present system to dynamically price assets in order to maintain a market equilibrium and thereby retain liquidity in the assets.

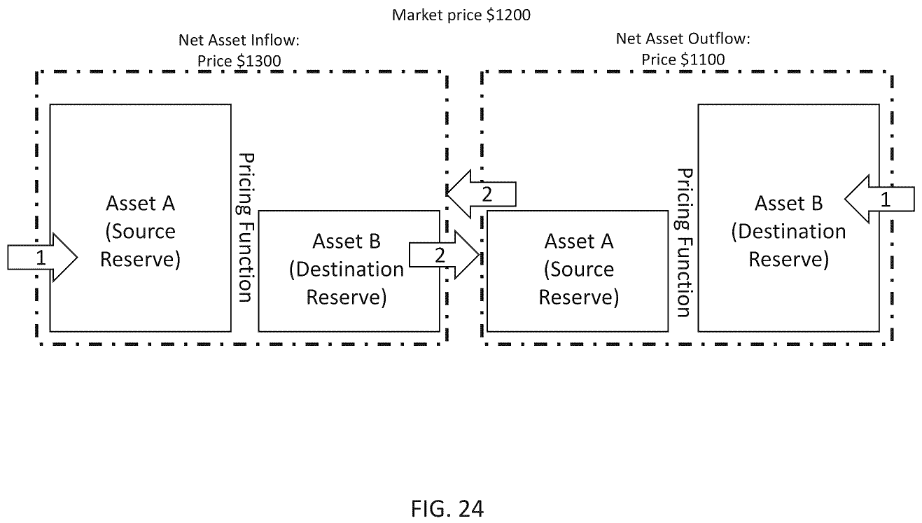

FIG. 24 illustrates a pricing function of a pricing engine according to one embodiment of the present invention. The disclosed pricing function incorporates a number of factors including but not limited to imbalance between source and destination reserve accounts, current market conditions and activity, external pricing, and asset par value. Pricing algorithms include protective measures against market manipulation (e.g., by widening the difference in exchange price for a flow from the reverse flow). In one embodiment, the pricing function manages price by placing orders into an exchange. In one embodiment, the pricing function manages price directly through an algorithm that sets price directly in response to a liquidity request.

With a dynamic pricing function which increases the price as resources draw down, the liquidity engine will increase the price of Asset B (in terms of Asset A) until market equilibrium is reached. In the example illustrated in FIG. 24, the demand for Asset B results in a decrease in Asset B reserve pool and an increased equilibrium price. A net demand of Asset A will drive the price of Asset B down. The extent to which equilibrium price deviates from the prevailing market price is the price of liquidity. The dynamic pricing function is designed to ensure reserve resources do not run out in the event of a sudden imbalance in value flow. In one embodiment, the dynamic pricing function is driven by a Proportional Integral Derivative (ND) controller to dynamically adjust price according to sustained liquidity demands.

For imbalanced flows, it may be necessary to move value OOB from one reserve to another. In one embodiment, OOB transfer involves manual movement of funds, the use of exchanges, or other transfer channels independent of main transfer channels as described herein. However, OOB transactions involve longer delivery times and increased cost in comparison to balanced flows. The time and expense of these transfers defines the parameters of a traditional logistics problem—deciding the amount of value to preposition based on the variability of demand and the time and expense to replenish.

Revenue from operating a liquidity reserve is generated by two sources: 1) the payment of fees required for the transaction; and 2) the difference in exchange price for a flow from the reverse flow (i.e., the spread). Fees may be adjusted to maximize revenue. For example, if the fees are too high, use of the channel will decrease, resulting in a loss of revenue. Similarly, if fees are too low, potential revenue generated by the fees will be lost. Similar logic applies to the market making function associated with the spread.

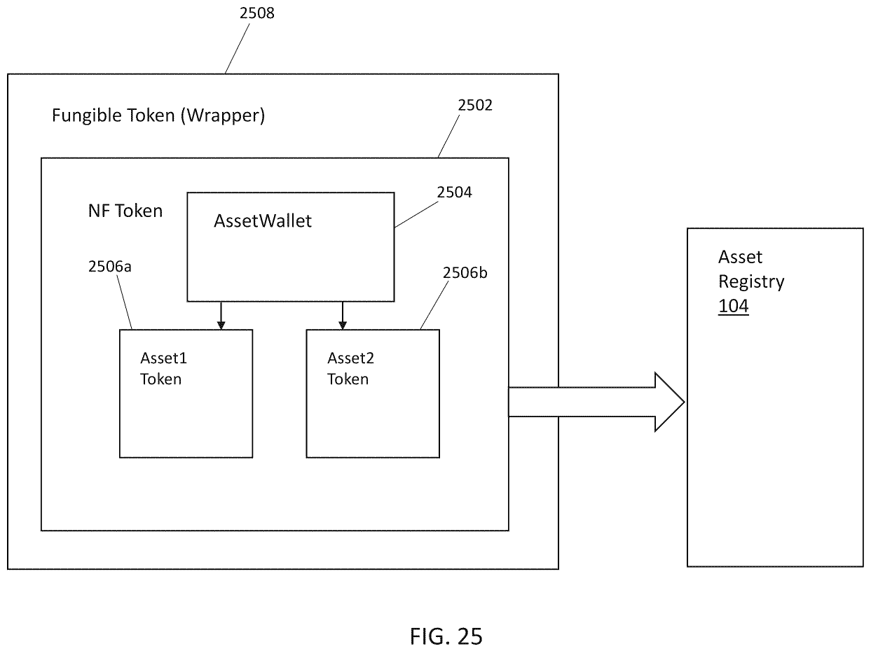

FIG. 25 is a schematic diagram of a data structure defining a liquidity token according to one embodiment of the present invention. A non-fungible asset token 2502 owns wallet 2504, which in turn holds tokens 2506a and 2506b representing assets on each side of the asset pair. Non-fungible token 2502 is “wrapped” in fungible token 2508 (e.g., the wrapper of IAssetFund interface described herein). Fungible token 2508 thus represents ownership of underlying non-fungible asset token 2502 and tokens 2506a and 2506b therein. The holder of the fungible token 2508 (i.e., the “parent token”) obtains a dividend reflecting revenue generated by providing liquidity between the pair of tokens 2506a and 2506b. Non-fungible token 2502 and asset tokens 2506a and 2506b are registered in Asset registry 104 (described herein with respect to FIG. 1). In one embodiment, the asset token depicted in FIG. 25 uses the token structure described herein with respect to FIGS. 1-8, where tokens own wallets, which in turn own tokens in a recursive manner. In one embodiment, the data structure utilizes DLT technology to tokenize a class of assets that comprises the asset pair (i.e., tokens 2506a and 2506b).

Tokens similar to non-fungible token 2502 are referred to as “Liquidity Tokens” herein. A liquidity token is a non-fungible token containing logic (e.g., smart contracts) and resources required to enable conversion of one asset to another where the token produces a yield for the owner of the token proportional to the demand for liquidity of the supported assets. One of ordinary skill in the art will appreciate that in order to execute the logic and resources required for conversion while maintaining the acknowledgement of the token owner (i.e., in order to ensure the owner of the token receives the resulting yield), account abstraction is used to separate the owner control logic from the conversion execution logic of the liquidity token.

A liquidity token of the present invention represents an investment in the demand for liquidity between Asset A and Asset B, not an investment in the assets themselves. This creates an investment opportunity in the need for liquidity itself, wherein investment return is proportional to liquidity demand. The investment in liquidity demand rather than the investment value of the assets motivates investors to supply the resources needed for liquidity. One of ordinary skill in the art will appreciate that if Asset A and Asset B are equally desirable (or if Asset A and Asset B are equally undesirable), liquidity for conversion between the assets may not be present, leading to inefficient markets. Inefficient, illiquid markets are a major problem in cryptocurrency and tokenized assets, as there is no incentivization for conversion and therefore no return on investment in the value of Asset A or Asset B. Thus, liquidity tokens provide a means to create efficient markets by isolating and tokenizing the need for conversion itself rather than in the value of Asset A or Asset B.

Tokens such as fungible token 2508 are referred to herein as “Wrapped Liquidity Tokens.” Wrapped Liquidity Tokens may be transferred in whole by selling the Wrapped Liquidity Token or in part by selling shares in the Wrapped Liquidity Token. The Wrapped Liquidity Tokens are sold via an exchange implemented on a networked computing platform as described herein. For example, Wrapped Liquidity Tokens are operable to be transacted on a networked trading platform in a manner similar to the techniques described above with respect to FIG. 1 and FIG. 12. That is, wrapped liquidity tokens are operable to be traded between dissimilar ledgers using the cross-ledger techniques disclosed herein and between the same or similar ledgers using the intra-ledger techniques disclosed herein.

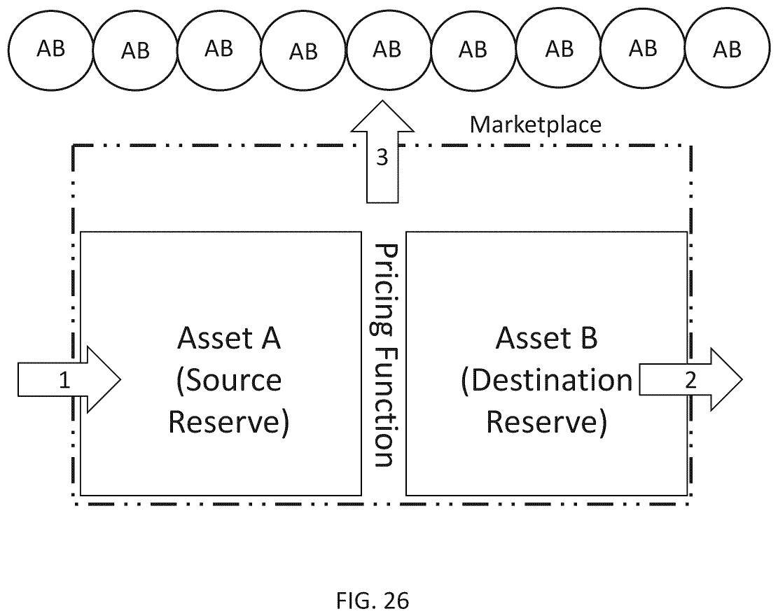

FIG. 26 is a schematic illustration of a set of functions for providing liquidity to a wrapped liquidity token according to one embodiment of the present invention. The price of a Wrapped Liquidity Token (indicated by AB) will depend on the value of the underlying assets (Asset A and Asset B) and the revenue produced by the underlying source reserve, i.e. the “liquidity pool.” Greater demand for liquidity between a pair will increase the dividends collected by the wallet containing the liquidity token of the asset pair. This in turn creates more demand for the Wrapped Liquidity Token.

An increase in demand for the liquidity token of the asset pair will result in a net inflow of capital to the ecosystem. This inflow of capital creates an imbalance between the cash and token reserves in the liquidity pool. Using the Elastic Securitization technique disclosed herein, inflow of capital is used to increase the underlying asset pool. Using a smart contract or other algorithm as a pricing function, the cash in the liquidity pool held in reserve is moved to the broader underlying pool when it hits a threshold (reflecting increased demand in the liquidity function). This is advantageous in order to meet redemption demands or to buy assets required for the liquidity pair. The resulting increase in cash in the source reserve increases the overall liquidity of the ecosystem.

In one embodiment, a liquidity pool is created for the Liquidity token, as depicted in FIG. 26. The liquidity pool for the Liquidity token utilizes an arrangement similar to the underlying liquidity pool and the pricing function of FIG. 23. In one embodiment, this liquidity pool is part of the portfolio and is used to manage liquidity. The liquidity pool helps govern the net inflow and outflow of capital to the system. As shown in FIG. 26, to configure a liquidity token, a non-fungible asset token (2502 in FIG. 25) is created with source and destination accounts (Source Reserve and Destination Reserve) as described herein, including the pricing function and fee structure for asset conversion from Asset A to Asset B. The asset token is wrapped in fungible token (2508 of FIG. 25) to permit investors to invest in a liquidity asset. Elastic securitization rules allow investment to flow to/from assets to meet demand.

In one embodiment, a self-balancing liquidity system is formed across an ecosystem of asset pairs wherein each pair requiring liquidity has its own liquidity token. As the need for liquidity decreases for one pair, its dividends will drop, decreasing investor demand for the liquidity token for that pair. This will result in a net outflow of capital from the liquidity pool of the liquidity token of that pair. The capital is then invested in other pairs whose fees outpace the market. In this way, capital flows to the greatest demand for liquidity (i.e., asset pairs whose fees outpace the market), resulting in a self-balancing system. In one embodiment, liquidity tokens are bundled into a parent fund token. In one embodiment, the bundled liquidity and parent tokens are then wrapped in a fungible token, as described above, to allow shares of the fund to be sold and the holder to own an interest in the value of the underlying wallets and revenue generated from fees.

In one embodiment, liquidity tokens are used in conjunction with dark pools (i.e., privately organized forums and exchanges) to facilitate and automate transfers of value between ecosystems. This is accomplished using bridges and a computer architecture for providing communications between dissimilar networks (e.g., the architecture of FIG. 12). Liquidity tokens used in conjunction with the chained transfer technology and associated bridges provide the means to fund transfers of value between ecosystems. Dark pools generate value through fees, market making, or both. In one embodiment, dark pools are owned by third parties or traded as a security token. Dark pools represent a just-in-time supply chain management solution to optimize transient flow against slower, internal replenish processes.

A liquidity pricing function manages liquidity between assets, ecosystems, and exchanges. The engine manages the cost of transfer needed to balance resources. It drives up the cost of sustained mismatch in the flow of assets by incenting users to “invest” in the mismatch and drive liquidity where it is needed. In one embodiment, the liquidity pricing function monitors the relative balance between the source and destination reserve balances and adjusts price and the rate of change of price based on recent pricing history, an anchor value based on external information, fees associated with replenishment, and/or the amount of value that is being moved. The liquidity pricing function also determines the spread (i.e., the difference between the minimum bid and the ask order price based on market conditions and volatility). The term “liquidity engine” as used herein refers to the specific algorithm that runs to set prices for the conversion of assets via the liquidity pool. This algorithm observes the relative flow of assets from A to B or from B to A, as well as other market conditions to set the price of conversion. In one embodiment, the liquidity function of the present invention utilizes the liquidity engine. In one embodiment, the liquidity function does not use the liquidity engine.

One of ordinary skill in the art will appreciate that the pricing engine of the present invention is not equivalent to the liquidity engine. The pricing engine is a tool used to determine the pricing of one asset in terms of another asset (e.g., an algorithm or set of algorithms used to determine the conversion rate). The liquidity engine is the architecture that facilitates the actual conversion of a first asset type to a second asset type. In one embodiment, the pricing engine is a necessary element in the liquidity engine, used to determine the conversion rate in order that the conversion takes place at the determined price.

The invention is operable to utilize a plurality of learning techniques including, but not limited to, machine learning (ML), artificial intelligence (AI), deep learning (DL), neural networks (NNs), artificial neural networks (ANNs), support vector machines (SVMs), Markov decision process (MDP), and/or natural language processing (NLP). The system is operable to use any of the aforementioned learning techniques alone or in combination.

Further, the invention is operable to utilize predictive analytics techniques including, but not limited to, machine learning (ML), artificial intelligence (AI), neural networks (NNs) (e.g., long short term memory (LSTM) neural networks), deep learning, historical data, and/or data mining to make future predictions and/or models. The invention is preferably operable to recommend and/or perform actions based on historical data, external data sources, ML, AI, NNs, and/or other learning techniques. The invention is operable to utilize predictive modeling and/or optimization algorithms including, but not limited to, heuristic algorithms, particle swarm optimization, genetic algorithms, technical analysis descriptors, combinatorial algorithms, quantum optimization algorithms, iterative methods, deep learning techniques, and/or feature selection techniques.

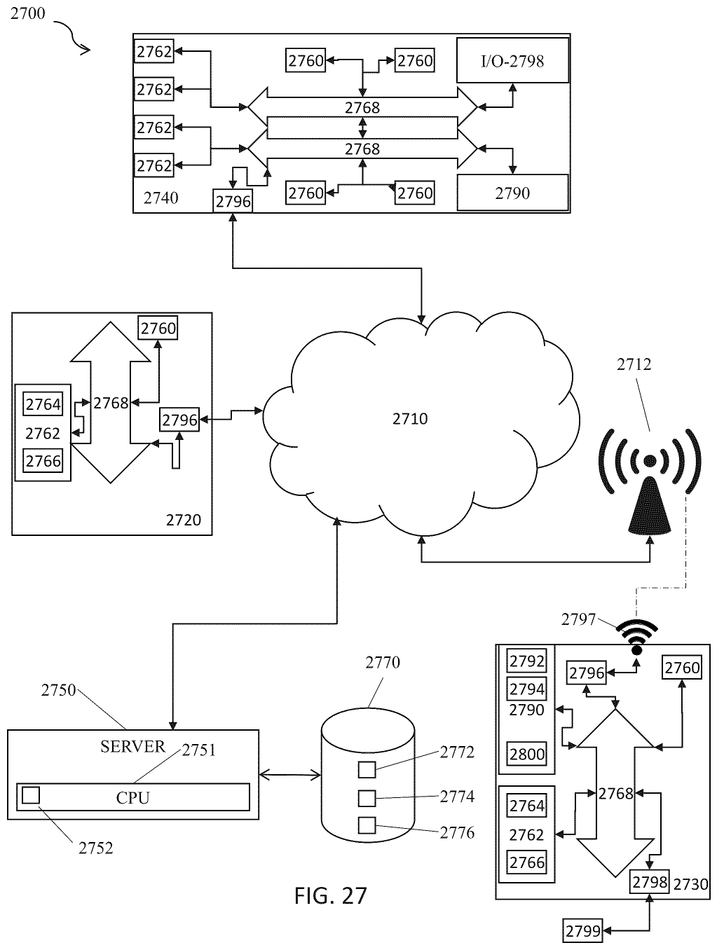

FIG. 27 is a schematic diagram of an embodiment of the invention illustrating a computer system, generally described as 800, having a network 810, a plurality of computing devices 820, 2730, 2740, a server 2750, and a database 2770.

The server 2750 is constructed, configured, and coupled to enable communication over a network 2710 with a plurality of computing devices 2720, 2730, 2740. The server 2750 includes a processing unit 2751 with an operating system 2752. The operating system 2752 enables the server 2750 to communicate through network 2710 with the remote, distributed user devices. Database 2770 is operable to house an operating system 2772, memory 2774, and programs 2776.

In one embodiment of the invention, the system 2700 includes a network 2710 for distributed communication via a wireless communication antenna 2712 and processing by at least one mobile communication computing device 2730. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 2700 is a virtualized computing system capable of executing any or all aspects of software and/or application components presented herein on the computing devices 2720, 2730, 2740. In certain aspects, the computer system 2700 is operable to be implemented using hardware or a combination of software and hardware, either in a dedicated computing device, or integrated into another entity, or distributed across multiple entities or computing devices.

By way of example, and not limitation, the computing devices 2720, 2730, 2740 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 2720 includes components such as a processor 2760, a system memory 2762 having a random access memory (RAM) 2764 and a read-only memory (ROM) 2766, and a system bus 2768 that couples the memory 2762 to the processor 2760. In another embodiment, the computing device 2730 is operable to additionally include components such as a storage device 2790 for storing the operating system 2792 and one or more application programs 2794, a network interface unit 2796, and/or an input/output controller 2798. Each of the components is operable to be coupled to each other through at least one bus 2768. The input/output controller 2798 is operable to receive and process input from, or provide output to, a number of other devices 2799, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 2760 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that perform calculations, process instructions for execution, and/or other manipulations of information.

In another implementation, shown as 2740 in FIG. 27, multiple processors 2760 and/or multiple buses 2768 are operable to be used, as appropriate, along with multiple memories 2762 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 2700 is operable to operate in a networked environment using logical connections to local and/or remote computing devices 2720, 2730, 2740 through a network 2710. A computing device 2730 is operable to connect to a network 2710 through a network interface unit 2796 connected to a bus 2768. Computing devices are operable to communicate communication media through wired networks, direct-wired connections or wirelessly, such as acoustic, RF, or infrared, through an antenna 2797 in communication with the network antenna 2712 and the network interface unit 2796, which are operable to include digital signal processing circuitry when necessary. The network interface unit 2796 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 2762, the processor 2760, and/or the storage media 2790 and is operable be a single medium or multiple media (e.g., a centralized or distributed computer system) that store the one or more sets of instructions 2800. Non-transitory computer readable media includes all computer readable media, with the sole exception being a transitory, propagating signal per se. The instructions 2800 are further operable to be transmitted or received over the network 2710 via the network interface unit 2796 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 2790 and memory 2762 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 2700.

In one embodiment, the computer system 2700 is within a cloud-based network. In one embodiment, the server 2750 is a designated physical server for distributed computing devices 2720, 2730, and 2740. In one embodiment, the server 2750 is a cloud-based server platform. In one embodiment, the cloud-based server platform hosts serverless functions for distributed computing devices 2720, 2730, and 2740.

In another embodiment, the computer system 2700 is within an edge computing network. The server 2750 is an edge server, and the database 2770 is an edge database. The edge server 2750 and the edge database 2770 are part of an edge computing platform. In one embodiment, the edge server 2750 and the edge database 2770 are designated to distributed computing devices 2720, 2730, and 2740. In one embodiment, the edge server 2750 and the edge database 2770 are not designated for distributed computing devices 2720, 2730, and 2740. The distributed computing devices 2720, 2730, and 2740 connect to an edge server in the edge computing network based on proximity, availability, latency, bandwidth, and/or other factors.

It is also contemplated that the computer system 2700 is operable to not include all of the components shown in FIG. 27, is operable to include other components that are not explicitly shown in FIG. 27, or is operable to utilize an architecture completely different than that shown in FIG. 27. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

### Data Stored on a Distributed Ledger

In a preferred embodiment, the platform is operable to store data on a distributed ledger, e.g., a blockchain. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties can verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

### Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

### Tokenization

In one embodiment, the platform is operable to tokenize assets. A token is a piece of data that is stored on the distributed digital ledger and that can be used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A method for creation and management of tokenized asset pairs providing tokenized liquidity, comprising:
a computer platform including a processor and a memory associating a first asset token and a second asset token with an asset wallet address, wherein an asset wallet associated with the asset wallet address contains the first asset token and the second asset token;
the computer platform issuing a liquidity token on a distributed ledger, wherein the liquidity token includes a unique token identifier and the asset wallet address for the asset wallet containing the first asset token and the second asset token;
the computer platform wrapping the liquidity token with a token wrapper to create a wrapped liquidity token, wherein the wrapped liquidity token enables fractionalization of the liquidity token into at least two shares;
the computer platform executing a pricing function, wherein the pricing function is a set of smart contracts configured to translate the value of the first asset token in terms of the value of the second asset token.

2. The method of claim 1, wherein at least one of the at least two shares is associated with an additional asset wallet.

3. The method of claim 2, further comprising issuing a composite token, wherein the composite token includes a second unique identifier and at least one of the at least two shares of the liquidity token.

4. The method of claim 1, further comprising adding an additional asset token to the asset wallet included in the liquidity token, wherein the additional asset token is added via an out-of-band transfer.

5. The method of claim 1, wherein the pricing function manages the translation of the first asset token in terms of the second asset token directly through an algorithm in response to a request received by the computer platform, wherein the pricing function dynamically adjusts price according to sustained liquidity demands.

6. The method of claim 1, further comprising a smart contract transferring rights represented in the liquidity token into rights associated with at least one other token type.

7. The method of claim 1, further comprising registering the first asset token as a unique record associated with a first asset and the second asset token as a unique record in association with a second asset, wherein the unique record associated with the first asset and the unique record associated with the second asset are stored in a memory of an asset registry of the computer platform.

8. The method of claim 1, further comprising the computer platform transferring the first asset token, the second asset token, and/or the liquidity token to an additional distributed ledger, wherein the distributed ledger and the additional distributed ledger are heterogeneous.

9. The method of claim 1, further comprising the computer platform executing a request to transmit a ratio of units of a first asset associated with the first asset token per unit of a second asset associated with the second asset token, deliver an amount of the second asset on request, and accept delivery of an amount of the first asset in exchange for the amount of the second asset.

10. The method of claim 1, further comprising an elastic securitization algorithm executing a set of smart contracts configured to allocate resources invested in the first asset token and the second asset token to meet an underlying liquidity need.

11. A system for creation and management of tokenized asset pairs providing tokenized liquidity, comprising:
a computer platform including a processor and a memory;
wherein the computer platform is implemented on a first distributed ledger;
wherein the computer platform includes a first set of smart contracts configured to manage tokenized assets stored on the first distributed ledger;
wherein the first set of smart contracts is configured to traverse one or more node graphs to determine a viable route between the first node of the first distributed ledger and a second node of a second distributed ledger;
wherein the computer platform is configured to generate a liquidity token containing a unique token identifier and a wallet containing a first asset token associated with a first asset, and a second asset token associated with a second asset;
wherein the liquidity token includes a liquidity function, wherein the liquidity function translates the value of the first asset in terms of the second asset;
wherein the computer platform receives an input to transfer the liquidity token from a source wallet on the first distributed ledger to a destination wallet on the second distributed ledger;
wherein the computer platform includes a second set of smart contracts configured to plan a route between a first node of the first distributed ledger and the second node of the second distributed ledger;
wherein the execution of the second set of smart contracts creates a bridge between the first distributed ledger and the second distributed ledger;
wherein the computer platform is configured to transfer the liquidity token from the source wallet of the first distributed ledger to the destination wallet of the second distributed ledger via the bridge.

12. The system of claim 11, wherein smart contracts and associated functions from the first distributed ledger are converted into smart contracts and associated functions that are recognized and executable by the second distributed ledger.

13. The system of claim 11, wherein transferring the liquidity token from the first distributed ledger to the second distributed ledger includes one or more save points, wherein modifications made to the liquidity token after the liquidity token is saved at one of the one or more save points are erased upon a cancellation or a failure of the transfer.

14. The system of claim 11, further comprising a smart contract configured to transfer the rights represented in the liquidity token into rights associated with at least one other token type.

15. The system of claim 11, further comprising a token wrapper, wherein wrapping the liquidity token with the token wrapper enables the fractionalization of the liquidity token into at least two shares.

16. The system of claim 11, wherein the computer platform is further configured to add an additional amount of the first asset and/or an additional amount of the second asset to the liquidity token, wherein the first asset and/or the additional amount of the second asset is added via an out-of-band transfer.

17. The system of claim 11, wherein a valuation of the liquidity token is conducted, wherein the valuation is available via the computer platform in real time.

18. A method of managing tokenized asset pairs providing tokenized liquidity, the method comprising:
a computer platform including a processor and a memory associating a first asset token and a second asset token with an asset wallet address, wherein the asset wallet address contains the first asset token and the second asset token;
the computer platform issuing a liquidity token on a distributed ledger, wherein the liquidity token includes a unique token identifier and the asset wallet address containing the first asset token and the second asset token;
the computer platform associating the liquidity token with a first wallet address on the distributed ledger;
the computer platform deploying an elastic securitization algorithm including a set of smart contracts configured to execute a fund management strategy associated with the liquidity token, wherein the elastic securitization algorithm includes a set of smart contracts configured to exchange capital generated by a liquidity function of the liquidity token to convert miscellaneous assets in an asset pool into a first asset type associated with the first asset token and/or a second asset type associated with the second asset token and issue additional asset tokens; and
the liquidity function executing a set of smart contracts configured to translate the value of the first asset type in terms of the second asset type and transfer the first asset token and/or the second asset token to a second wallet.

19. The method of claim 18, further comprising wrapping the liquidity token with a token wrapper, wherein wrapping the liquidity token enables the fractionalization of the liquidity token into at least two shares.

20. The method of claim 18, wherein the second wallet is located on a second distributed ledger, wherein transfer of the first asset token and/or the second asset token to the second wallet includes transmutation of the first asset token and/or the second asset token into a token compatible with the second distributed ledger.
